(19) United States
(12) Patent Application Publication
(10) Pub. No.: US 2025/0266786 A1
(43) Pub. Date: Aug. 21, 2025

(54) SYSTEMS AND METHODS FOR POST AND SOLAR MODULE ASSEMBLY

(71) Applicant: Planted Solar, Inc., Oakland, CA (US)

(72) Inventors: Richard ERB, Berkeley, CA (US); Gilad ALMOGY, Palo Alto, CA (US); Nathan BECKETT, Oakland, CA (US); Benjamin KLEIN, Oakland, CA (US); Liam MORA, San Francisco, CA (US); Kevin BAUER, San Francisco, CA (US); Colin SHEREDY, Redondo Beach, CA (US); Ross OLASON, Woodinville, CA (US)

(21) Appl. No.: 19/061,792

(22) Filed: Feb. 24, 2025

Related U.S. Application Data
(63) Continuation of application No. PCT/US2023/073205, filed on Aug. 30, 2023.
(60) Provisional application No. 63/374,211, filed on Aug. 31, 2022.

(51) Int. Cl. H02S 20/10

(52) U.S. Cl. CPC H02S 20/10

(57) ABSTRACT

In an aspect, the present disclosure describes systems and methods for autonomous and rapid post and solar module assembly.

### CROSS-REFERENCE

This application is a continuation of International PCT Application No. PCT/US2023/073205, filed Aug. 30, 2023, which claims the benefit of U.S. Provisional Application No. 63/374,211, filed Aug. 31, 2022, each of which is entirely incorporated herein by reference.

### BACKGROUND

With the recognition of the harmful effects of global warming, the generation of usable power from solar energy is gaining increased acceptance. Large areas of vacant land can offer an attractive location for the deployment of solar panels. However, such open area solar installations may be accompanied by significant effort in securing the solar panels to the ground in such a way that the solar panels are resistant to external loading forces such as wind. The creation of separate beam and post structures to accomplish this goal can also add significant costs to the installation of solar panels.

### SUMMARY

Recognized herein is a need for methods and systems for high throughput post installation and rapid assembly of solar modules onto posts without a need of high precision alignment. The present disclosure provides systems and methods for post and solar module assembly.

In some aspects, the present disclosure describes an apparatus comprising a conveyance unit and a dispensing unit. The conveyance unit may be configured to support and transport a plurality of posts. The dispensing unit may be configured to dispense one or more posts among the plurality of posts from the conveyance unit, for installation onto a terrain.

In some embodiments, the conveyance unit comprises a conveyor line. In some embodiments, the conveyance unit is configured to support the plurality of posts by hanging the plurality of posts on the conveyor line. In some embodiments, the dispensing unit comprises an actuator that is configured to dispense the one or more posts by separating or releasing the one or more posts from the conveyance unit. In some embodiments, the actuator is configured to separate or release the one or more posts from the conveyance unit by pushing, pulling and/or lifting the one or more posts off the conveyance unit. In some embodiments, the dispensing unit is configured to feed the one or more posts to a post installation machine. In some embodiments, the dispensing unit is configured to dispense the one or more posts to a carrier that is configured to feed the one or more posts to a post installation machine. In some embodiments, the dispensing unit comprises a supporting arm configured to extend through one or more first holes in the one or more posts to support the one or more posts, wherein the supporting arm is further configured to push, pull and/or lift the one or more posts off the conveyance unit. In some embodiments, the dispensing unit is further configured to feed the one or more bundles to a post installation machine. In some embodiments, the dispensing unit is configured to dispense the one or more bundles to a carrier that is configured to feed the one or more bundles to a post installation machine.

In some embodiments, the apparatus may further include a transfer arm that is configured to extend through one or more second holes in the one or more posts, to take over the one or more posts from the supporting arm. In some embodiments, the transfer arm is configured to transfer the one or more posts to a carrier that is configured to feed the one or more posts to a post installation machine. In some embodiments, the plurality of posts are provided as a plurality of bundles, with each bundle comprising two or more posts. In some embodiments, the two or more posts in each bundle are held together by a strap, chain or clip. In some embodiments, each bundle comprises about three to three hundred posts. In some embodiments, the dispensing unit is configured to dispense one or more bundles from the plurality of bundles. In some embodiments, the dispensing unit comprises an actuator that is configured to dispense the one or more bundles by separating or releasing the one or more bundles from the conveyance unit. In some embodiments, the actuator is configured to separate or release the one or more bundles from the conveyance unit by pushing, pulling and/or lifting the one or more bundles off the conveyance unit.

In some embodiments, the conveyance unit and the dispensing unit are operably coupled to each other. In some embodiments, the dispensing unit is located at a fixed position relative to the conveyance unit. In some embodiments, the dispensing unit is movable such that the dispensing unit is capable of being moved to one or more positions along or relative to the conveyance unit. In some embodiments, the conveyance unit, the dispensing unit and the plurality of posts are provided in a posts storage unit or at a posts storage location. In some embodiments, the conveyance unit comprises a plurality of carriages that are linked to one another. In some embodiments, a number and spacing of the plurality of carriages are adjustable to enable different turn radii of the conveyance unit during motion of the conveyance unit. In some embodiments, each carriage of the plurality of carriages comprises one or more hooks that are used for hanging the plurality of posts. In some embodiments, the conveyance unit is sloped or angled to facilitate the dispense of the one or more posts with aid of gravity.

In some aspects, the present disclosure describes a carrier comprising a rail and a follower. The rail may be configured to support a plurality of posts, wherein the rail comprises a gate located at a distal portion of the rail. The gate may be configured to prevent the plurality of posts from sliding off the rail. The follower may be configured to move or press the plurality of posts along the rail towards or against the gate. The gate and the follower may be configured to enable each post of the plurality of posts to be sequentially removable from the distal portion of the rail for installation onto a terrain.

In some embodiments, the follower comprises a spring. In some embodiments, each post is sequentially removable from the rail by lifting said each post above and over the gate. In some embodiments, the plurality of posts are indexed by a distance relative to each other along the rail using (a) one or more tabs on each post of the plurality of posts or (b) a plurality of spacers between the plurality of posts. In some embodiments, the carrier may further include a vibrating device operably coupled to the rail, wherein the vibrating device is configured to generate vibrations in the rail for facilitating movement of the plurality of posts towards the gate. In some embodiments, the rail is sloped or angled to facilitate movement of the plurality of posts towards the gate with aid of gravity. In some embodiments, the rail comprises a single rail. In some embodiments, the rail comprises two or more laterally spaced apart sub-rails. In some embodiments, the two or more laterally spaced apart sub-rails are configured to reduce swinging of the plurality of posts on the rail. In some embodiments, the carrier may further include one or more linear guides located beneath the rail, wherein the one or more linear guides are configured to constrain and reduce swinging of the plurality of posts on the rail. In some embodiments, the carrier is sloped or angled to facilitate removal of each post from the rail with aid of gravity.

In some aspects, the present disclosure describes a system comprising a post installation machine. The post installation machine may comprise an extraction device configured to remove the one or more posts from the carrier for installation onto the terrain.

In some embodiments, the extraction device is configured to remove the one or more posts from the carrier by lifting the one or more posts off the rail to clear the gate. In some embodiments, the post installation machine comprises a load driving mechanism, and the extraction device is configured to bring the one or more posts in proximity of the load driving mechanism. In some embodiments, the load driving mechanism is configured to drive the one or more posts onto the terrain.

In some aspects, the present disclosure describes a post installation machine comprising a load driving mechanism and a positioning device. The load driving mechanism may comprise a load head configured to drive one or more posts onto a terrain. The positioning device may be configured to control a location of the load head in three or more degrees of freedom relative to the one or more posts and an altitude of the terrain, prior to the one or more posts being driven onto the terrain.

In some embodiments, the positioning device comprises a plurality of linear actuators. In some embodiments, the positioning device comprises a Stewart platform or a hexapod. In some embodiments, the positioning device is configured to control the location of the load head in six degrees of freedom. In some embodiments, the load driving mechanism comprises an actuator configured to control a vertical position of the load head along a Z-axis. In some embodiments, the load driving mechanism comprises a chain/wire and sheave for adjusting or controlling a ratio of (a) a linear extension of the actuator relative to (b) a travel distance of the load head. In some embodiments, the ratio is 1:2. In some embodiments, the ratio is adjustable or controllable to reduce an upward reaction force when the load head is retracted after driving the one or more posts downwards onto the terrain.

In some embodiments, the machine further includes a vertical rail for constraining the one or more posts as the one or more posts are being driven onto the terrain. In some embodiments, the vertical rail is configured to permit the one or more posts to slide along the rail as the one or more posts are being driven onto the terrain. In some embodiments, the machine may further include a brace configured to retain the one or more posts in position relative to the load head. In some embodiments, the brace is movable to switch between an open state and a closed state. In some embodiments, the closed state causes the brace to retain the one or more posts in position relative to the load head. In some embodiments, the open state allows the one or more posts to be placed in position relative to the load head. In some embodiments, the brace is hinged to a holder that is configured to hold the one or more posts. In some embodiments, the brace comprises a C-shaped or a horse-shoe bracket.

In some aspects, the present disclosure describes an apparatus comprising a compliant mechanism. The compliant mechanism may be operably coupled to a distal portion of a movable arm. The compliant mechanism may be configured to (1) pick up one or more solar modules from a plurality of solar modules and (2) place the one or more solar modules onto a plurality of posts that have been installed onto a terrain. The compliant mechanism may be further configured to rotate and/or flex relative to the movable arm during placement of the one or more solar modules onto the plurality of posts.

In some embodiments, the compliant mechanism enables the one or more solar modules to be placed onto the plurality of posts, without requiring the one or more solar modules to be precisely positioned within a threshold tolerance relative to the plurality of posts during the placement. In some embodiments, the threshold tolerance is based at least on a horizontal accuracy and a vertical accuracy of a Global navigation satellite system (GNSS). In some embodiments, the threshold tolerance is based at least on a tilt of the plurality of the posts. In some embodiments, the tilt ranges from 0) degree to 25 degrees. In some embodiments, the compliant mechanism comprises a pair of laterally spaced apart plates and a plurality of springs extending radially from a center between the pair of laterally spaced apart plates. In some embodiments, the plurality of springs extend radially from the center equidistant from each other. In some embodiments, the plurality of springs comprises three springs that extend radially from the center at a 120 degree angle relative to each other. In some embodiments, the plurality of springs comprises four springs that extend radially from the center at a 90 degree angle relative to each other. In some embodiments, the plurality of springs comprises six springs that extend radially from the center at a 60 degree angle relative to each other. In some embodiments, the pair of laterally spaced apart plates comprises (1) a first plate that is operably coupled to the distal portion of the movable arm, and (2) a second plate that is configured to pick up the one or more solar modules from the plurality of solar modules.

In some embodiments, the compliant mechanism further comprises a spherical bearing located at a center between the pair of laterally spaced apart plates. In some embodiments, the pair of laterally spaced apart plates are operably coupled to each other via the spherical bearing and the plurality of springs. In some embodiments, the spherical bearing is configured to permit the pair of laterally spaced apart plates to rotate relative to each other. In some embodiments, the spherical bearing comprises an additional spring that is configured to allow lateral movement of the plates relative to each other. In some embodiments, the plurality of springs is configured to permit the pair of laterally spaced apart plates to flex relative to each other such that pair of plates are non-parallel to each other. In some embodiments, the plurality of springs is made of metal or rubber. In some embodiments, the plurality of springs is configured with having a torsional spring force such that the compliant mechanism returns to a default position after the placement of the one or more solar modules onto the plurality of posts. In some embodiments, the compliant mechanism comprises one or more bellows. In some embodiments, the one or more bellows are provided in a rubber casing. In some embodiments, the one or more bellows are inflatable or deflatable with a fluid for controlling a spring constant of the one or more bellows, wherein the fluid comprises a gas or a liquid.

In some embodiments, the apparatus may further include the movable arm. In some embodiments, the apparatus may further include one or more actuators operably coupled to the movable arm. In some embodiments, the one or more actuators are configured to control the movable arm to move in two or more degrees of freedom. In some embodiments, the two or more degrees of freedom comprise a translation along a vertical axis and a rotation about the vertical axis. In some embodiments, the two or more degrees of freedom further comprise a translation and/or rotation along a lateral axis. In some embodiments, the apparatus may further include a skid for supporting the plurality of solar modules in a stacked format. In some embodiments, the apparatus may further include one or more clinching tools operably coupled to the compliant mechanism, wherein the one or more clinching tools are configured to attach the one or more solar modules to the plurality of posts via a dimpling process.

In some embodiments, the present disclosure provides a method for constructing an array of solar modules, comprising: (a) autonomously positioning a plurality of posts over a terrain; and (b) autonomously assembling a plurality of solar modules with the plurality of posts over the terrain, thereby constructing the array of solar modules, wherein the plurality of posts comprises a row of posts wherein two adjacent posts in the row of posts are each tilted toward one another, wherein a third post adjacent to the two adjacent posts is tilted away.

In some embodiments, the array comprises a dual tilt array. In some embodiments, a solar module of the plurality of solar modules is coupled to a post of the plurality of posts via a post-module interface. In some embodiments, the post-module interface comprises a substantially non flat surface such that an angle between the module and the post is variable. In some embodiments, the post-module interface comprises a plurality of tabs. In some embodiments, the plurality of tabs are bendable or deformable. In some embodiments, the post-module interface comprises a non-flat pivot feature. In some embodiments, the method comprises tilting a solar module via the non-flat pivot feature. In some embodiments, the plurality of posts are installed at alternating angles. In some embodiments, the two adjacent posts are installed at a first angle and a second angle relative to a vertical axis, and the third post is installed at a third angle. In some embodiments, the first, the second, and the third angles are substantially same. In some embodiments, at least two of the first, the second, and the third angles are different.

In some embodiments, the present disclosure provides a method for constructing an array of solar modules, comprising: (a) autonomously positioning a plurality of posts over a terrain; and (b) autonomously assembling a plurality of solar modules with the plurality of posts over the terrain, thereby constructing the array of solar modules, wherein a solar module of the plurality of solar modules is supported by variable number of posts.

In some embodiments, a side of the solar module is supported by at least three posts. In some embodiments, a side of the solar module is supported by at least four posts. In some embodiments, the array comprises a dual tilt array. In some embodiments, the solar module of the plurality of solar modules is coupled to a post of the plurality of posts via a post-module interface. In some embodiments, the post-module interface comprises a substantially non flat surface such that an angle between the module and the post is variable. In some embodiments, the post-module interface comprises a plurality of tabs. In some embodiments, the plurality of tabs are bendable or deformable. In some embodiments, the post-module interface comprises a non-flat pivot feature. In some embodiments, the method comprises tilting a solar module via the non-flat pivot feature. In some embodiments, the plurality of posts are installed at alternating angles.

In some embodiments, the present disclosure provides a method for solar module assembly, comprising (a) providing an algorithm configured to identify a location for autonomous positioning and assembly of a plurality of posts and a plurality of solar modules; and (b) creating a set of executable software instructions for controlling one or more mobile platforms to autonomously position and assemble the plurality of posts and the plurality of solar modules over a terrain to construct an array of solar modules without requiring aid or involvement from a user.

In some embodiments, the method comprises using a digital surface model of the terrain to determine the location. In some embodiments, the method comprises determining a location of a post by the algorithm that uses the post-clip interface angles. In some embodiments, the method comprises using the algorithm to minimize a depth of a post. In some embodiments, the method comprises using a digital surface model of the terrain to minimize the depth of the post. In some embodiments, the algorithm uses soil properties. In some embodiments, the algorithm uses the array geometry and tolerances. In some embodiments, the method comprises exporting or displaying an output of the algorithm in a digital representation. In some embodiments, the method comprises using the digital representation to modify the location of the post or module based on a measurement of a nearby post or module. In some embodiments, the method comprises using the digital representation to predict an electrical power produced by the array. In some embodiments, the method comprises using the digital representation to predict the components required in the array. In some embodiments, the method comprises using the digital representation to create construction plan drawings. In some embodiments, the method comprises using the digital representation to generate an analysis for construction operations. In some embodiments, the method comprises comprising providing a graphic user interface (GUI) configured to display an output of the algorithm. In some embodiments, the method comprises displaying a digital representation of an output of the algorithm on the GUI. In some embodiments, the method comprises using a sensor to record data of the terrain, a post, and/or module. In some embodiments, the method comprises displaying the recorded data in a digital representation. In some embodiments, the method comprises modifying the algorithm and/or a digital surface model of the terrain based on the recorded data.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “Figure” and “FIG.” herein), of which:

FIG. 1 is a simplified force diagram of a system for ground mount of solar panels.

FIG. 2 shows a simplified view of an embodiment of a ground mount system.

FIG. 3 shows a simplified view of a conventional ground mount installation.

FIG. 4A shows a perspective view of a ground mount system according to an embodiment.

FIG. 4B is an end view of the ground mount system of FIG. 4B, showing loading forces.

FIG. 4C shows an enlarged view of a post according to an embodiment.

FIG. 5A shows a perspective view of a ground mount system according to an alternative embodiment.

FIG. 5B shows is a simplified end view of the embodiment of FIG. 5A showing loading forces.

FIG. 6A is a perspective of a solar module array resulting from a ground mount system according to an embodiment.

FIG. 6B is a perspective view of another solar module array resulting from a ground mount system according to an embodiment.

FIG. 6C shows a perspective view of an alternative embodiment with portrait-oriented solar modules with short ends aligned in the row direction.

FIG. 7A shows a perspective view of an end clip according to an embodiment.

FIG. 7B shows a perspective view of an end clip with two modules attached.

FIG. 8A shows a perspective view of a corner clip according to an embodiment.

FIG. 8B shows a perspective view of the corner clip embodiment connected to two modules and a post.

FIG. 8C shows a perspective view of a pair of corner clips and attached modules, connected to a post.

FIG. 9 illustrates forces to which a ground mount system may be subjected.

FIG. 10 shows main tolerances of concern for a ground mount installation.

FIG. 10A shows a perspective view of two clips clinched in place onto a post.

FIG. 10B is a side perspective view showing the impact of terrain upon installation.

FIG. 10C is an enlarged view showing the ability of a ground mount system according to embodiments, to handle relatively high tolerances.

FIG. 10D shows a perspective view of an alternative post embodiment.

FIG. 11 shows an enlarged perspective view of the spacing between modules.

FIG. 12 shows a simplified view of an alternative clip structure.

FIG. 13 is a simplified view showing a clip attached to the side of a module.

FIG. 14 is a simplified perspective view showing the clip/module assembly, adjacent to an alternative embodiment of a post.

FIG. 15 is a simplified view showing a clinching tool that can be used to clinch together the clip to a face of the post.

FIG. 15A shows a simplified view of a resulting clinching joint.

FIG. 15B shows a view of a post according to an alternative embodiment.

FIG. 15C shows fabricated posts maintained in a bandoliered structure after progressive stamping.

FIG. 16 is a simplified view showing a corner of four modules that join to one post.

FIG. 17 shows a progressive stamping manufacturing process that can be used to fabricate the clip.

FIG. 18 shows how the clip can maintain its connected orientation in an integrated bandolier configuration after formation.

FIG. 19 shows another embodiment of a ground mounting system.

FIG. 20 shows a typical layout of standard blocks of solar modules in this connected orientation.

FIG. 21 shows how four of the blocks of FIG. 20 connect to one central inverter.

FIG. 22 is a perspective view of a portion of a block.

FIG. 23 is a simplified flow diagram illustrating a supply chain that is made available according to embodiments.

FIG. 24 is a simplified overhead view showing progress of one embodiment of an installation machine over a site.

FIG. 25 is a simplified overhead view showing progress of an alternative embodiment of an installation machine 2500 over a site

FIG. 26 provides a formal coordinate system for describing a moving vehicle.

FIG. 27 shows a rear perspective view of one embodiment 2700 of the installation apparatus.

FIG. 28 shows a detail of the vertical conveyor element which can be used to lower modules one at a time.

FIG. 29 is a schematic view showing how standard packaging of a stack of solar modules, can be loaded on to vertical conveyors and lowered module-by-module onto sheet metal joints.

FIG. 30 shows a detail of a module lowered onto a joint.

FIG. 31 shows a side view of a stack of solar modules on a vertical conveyor.

FIG. 32 shows a front perspective view of an installation apparatus.

FIG. 33 shows a view of the load head frame connected to the actuator tip.

FIG. 34 shows approaches for controlling position of a moveable platform.

FIG. 35 shows a front perspective view of an installation apparatus according to an alternative embodiment.

FIG. 36 shows an enlarged side view of the apparatus of FIG. 35.

FIG. 37A shows a perspective view of an alternative embodiment.

FIG. 37B shows an enlarged view of a gantry.

FIG. 37C shows an enlarged view of a rotational gear.

FIG. 38A shows a perspective view of another alternative embodiment.

FIG. 38B shows movement in various directions of the embodiment of FIG. 38A.

FIG. 39 shows an overhead view of an alternative embodiment featuring a cleaning robot.

FIG. 40 shows an overhead view of an alternative embodiment featuring staggered module placement.

FIG. 41 shows an overhead view of an alternative embodiment featuring staggered module placement and post location.

FIG. 42 shows an overhead view of an autonomous system for positioning and assembling solar modules, in accordance with some embodiments. In some cases, modules may be unboxed, inspected, and/or processed with or without attachments before transporting around a site. In some cases, post installers may drive posts and continuously reload from factor bundled packs. In some cases, module installers may pull a solar module from a stack and attach them to posts. In some cases, posts may be installed by a custom machine on the back of a tractor or any other type of vehicle (e.g., any type of autonomous or semi-autonomous towing vehicle). In some cases, a module may be installed on a previously installed post by a machine on the back of a different tractor.

FIG. 43 shows an overhead view of an autonomous system for positioning and assembling solar modules, in accordance with some embodiments. In some cases, tractors may be fully electric. In some cases, a mobile power unit may be disposed at or near a site where tractors may charge. In some cases, the mobile power unit may be comprise solar panels and/or batteries. In some cases, a reloading unit may travel between stations. In some cases, a reloading unit may carry posts, solar modules, or any combination thereof. In some cases, a reloading unit may travel between a prep station and active installer units (e.g., tractors).

FIGS. 44A-44M show vehicles for positioning and assembling solar modules, in accordance with some embodiments. In some cases, a module installer may be a custom machine built on a tractor. In some cases, a module installer may take in a stack of solar modules. In some cases, the stack of solar modules may be placed on the module installer. In some cases, the stack of solar modules may be picked up by the module installer. In some cases, the module installer may carry the stack of modules. In some case, the module installer may separate one module from the stack of modules. In some cases, the module installer may position the one module over a plurality of installed posts, for example, two, three, or four installed posts. In some cases, the module installer may lower the module into a predetermined position over the plurality of installed posts. In some cases, the module installer may deform a metallic portion of a module to create a rigid connection between the module and the post. In some cases, the module installer may release the module. In some cases, the module installer may test a strength of connections formed between the module and the plurality of posts by lifting, pushing, twisting, or any sufficient force. In some cases, the module installer may drive to a next location to place a module. In some cases, a module installer may comprise 3, 4, 5, or 6 degrees of motion or more. In some cases, a module installer may comprise a robot arm that is configured to receive a module from a flipping machine. In some cases, a robot arm may be used to reach pick up a module from a stack. In some cases, a gantry may be used to tilt back and forth to pick up a module and position the module behind. In some cases, a double rotary motion manipulator comprise 1, 2, or more rotating joints may be used to position a module above one or more posts. In some cases, a trailer may comprise a gantry for picking up and positioning one or more modules above posts.

FIGS. 45A-45D show perspective views of a machine for installing posts, in accordance with some embodiments. In some cases, the machine may comprise 3, 4, 5, or 6 degrees of freedom or more. In some cases, the machine may autonomously position a post, install the post in the ground, and/or force-test the post by pulling on it laterally, vertically, or any other direction and record the force-test data. In some cases, the machine may be configured to carry one or more bundles of posts on a rack. In some cases, the machine may be configured to locate one or more posts in a bundle of posts and collect a new post on a driving bit.

FIGS. 46A-46B show a machine for installing posts, in accordance with some embodiments. In some cases, the machine may have 3 or more mounting interfaces to mount a tractor to, for example, using a 3 point hitch. In some cases, the machine may carry a hammer for pounding a post into the ground. In some cases, a hammer may be mounted on vertical rails and may be free to slide vertically or in any other sufficient direction such that sufficiently small or no vibration is transferred from the hammer to the remainder of the machine.

FIGS. 47A-47I show coupling mechanisms between a driving bit and a post, in accordance with some embodiments. In some cases, a driving bit may be connected to a hammer. In some cases, a driving bit may comprise a shear interface for engaging a post during the pounding. In some cases, a driving bit may comprise a retention feature which prevents a post from falling off of the bit while it is being positioned and driven. In some cases, a driving bit may be configured to allow a post to be pounded from the post's web, which may be disposed lower on the body of the post. In some cases, pounding from the web may allow the hammer to impact the post with greater force, as compared to impacting from the head, because pounding from the web may effectively lower the buckling length of the post during pounding. In some cases, a driving bit may enter a larger portion of a hole in a post. In some cases, a driving bit may slide down in a configuration and retain against a chisel bit. In some cases, a head of a chisel feature on a driving bit may overlap with at least a portion of a post when the driving bit is engaged with the post. In some cases, there may be 1, 2, 3, 4, or more shear features on a chisel bit. In some cases, a chisel bit may also be used as a retention feature. In some cases, a feature on a chisel bit may retain a post. In some cases, a feature on a chisel bit may be separate from a feature that is pounding the post. In some cases, a retention feature may be a clocking element that rotates to engage with a post. In some cases, a retention feature may be a clocking square that turns about 45 degrees such that the corners retain a post once engage. In some cases, a retention feature may overhang a hole in the post. In some cases, a shaft may not engage a bottom of a hole in the post. In some cases, a ping may engage with a post without overhanging.

FIGS. 48A-48B show a comparison of driving a post using different coupling mechanisms, in accordance with some embodiments.

FIGS. 49A-49C show posts, in accordance with some embodiments.

FIGS. 50A-50C show coupling mechanisms between posts and a rack, in accordance with some embodiments. In some cases, a post may comprise a Z shaped section or a Z shape. In some cases, a post may comprise a shape that is substantially stackable. In some cases, a post may comprise one or more oblique set of tabs at the top. In some cases, a tab may comprise a cutout feature. In some cases, a cutout feature may be configured to allow a post to be hung from a hanger or a rack. In some cases, one or more posts may be bundled and shipped in a container or be disposed on a machine.

FIG. 51 illustrates a method for coupling a solar module and brackets, in accordance with some embodiments. In some cases, a bracket may be installed by a process in a station where modules are unboxed, inspected, and/or then placed on a tooling jig. In some cases. 1, 2, 3, 4, or more rivet guns may install rivets to join a bracket to a solar module from below, side, top, or any sufficient direction. In some cases, a clinching tool or an impact driver (e.g., for torquing nuts) may be used instead of a rivet gun.

FIG. 52 illustrates a method for autonomously positioning and assembling solar modules, in accordance with some embodiments. In some case, a module installer may drive to a location. In some cases, a module installer may pick up a module. In some cases, a module installer may position the module over 1, 2, 3, 4, or more posts. In some cases, a clinch tool may be used to form a connection between the module and the one or more posts. In some cases, the clinch tool may fit between ears of a post and a clip. In some cases, the clinch tool may close to form a joint. In some cases, the module installer may release the clinch tool. In some cases, an end effector may be used to lift off a module. In some cases, a module installer may drive to the next set of one or more posts to install a next module.

FIG. 53 illustrates a plurality of brackets that can be coupled to one or more posts, in accordance with some embodiments. In some cases, a solar module may comprise a bracket. The bracket may be attached or coupled to the solar module. In some cases, the bracket may comprise a deformable metal. In some cases, a connection may be formed between the bracket and a post. In some cases, the connection may be formed by clinching the bracket and the post together. In some cases, the bracket may comprise a flat or an angled piece of metal that is configured to rivet onto a module, for example, through mounting holes. In some cases, the bracket may be connected to a module by clinching the bracket to the frame of a module.

FIGS. 54A-54C illustrates a method for determining a landscape topology for positioning and assembling solar modules, in accordance with some embodiments. In some cases, the method may comprise analyzing a terrain topology and/or GIS data of a given terrain. In some cases, the method may comprise processing a curvature of the terrain topology or GIS data. In some cases, the method may comprise simulating posts and modules installed on the given terrain. In some cases, the method may comprise uploading the posts and the modules geolocation position and construction data for one or more machines for installing the posts and the modules.

FIG. 55 illustrates a GUI for determining a landscape topology for positioning and assembling solar modules, in accordance with some embodiments.

FIG. 56 illustrates a module comprising a fixed tilt array, in accordance with some embodiments. In some cases, the module may be rigidly connected to two posts. In some cases, the module may comprise a small support bracket that is mounted directly to a post without requiring a spanning intermediate structure. In some cases, a module may be driven by a 90 degree linkage where each module may be driven to a required angle, for example, without requiring an entire tracker ‘table’ being driven together. In some cases, a module may spans two or more posts without need for an intermediate structure between posts. In some cases, modules may be connected with a continuous wire or chain. In some cases, the continuous wire or chain may be driven by a mechanism to track the solar modules about one or more pivots on the posts. In some cases, the modules may each comprise an individual drive or drive unit such that each module may independently track the sun.

FIG. 57 illustrates a solar tracker, in accordance with some embodiments.

FIG. 58 illustrates a tracking unit, in accordance with some embodiments. In some cases, a tracking unit may be autonomously deployed. In some cases, a tracking unit may be pre-assembled, distributed, and placed on a field. In some cases, a tracking unit may be wired autonomously using geolocation data and/or any machine disclosed herein. In some cases, the installed tracking unit may expand to a single module solar track for tracking the sun in 1, 2, or 3 axes.

FIG. 59 illustrates a light curtain, in accordance with some embodiments. In some cases, a machine may comprise one or more optical sensors configured to detect when a foreign object (e.g., a human or another agent) enters a workspace defined by a light curtain.

FIG. 60 illustrates solar module array configurations, in accordance with some embodiments. In some cases, a solar module array may comprise 4 posts for each corner of a module. In some cases, a solar module array may comprise 2 posts along a middle axis of a module.

FIG. 61 shows a computer system, in accordance with some embodiments.

FIG. 62 illustrates an alternative embodiment of an exemplary vehicle that can be used or configured to handle, transport, install, or deploy one or more solar modules.

FIG. 63 illustrates another alternative embodiment of an exemplary vehicle that can be used or configured to handle, transport, install, or deploy one or more solar modules.

FIG. 64 illustrates an end-effector with clinch tools positioned at the corners of the end-effector, in accordance with some embodiments.

FIG. 65 illustrates a bottom portion of the clinch tools which can be tapered to help the clinch tools locate or engage with a module.

FIGS. 66A and 66B illustrate an alternate embodiment of a clip, in accordance with some embodiments.

FIG. 67 illustrates an alternative embodiment of a module installer vehicle, in accordance with some embodiments.

FIG. 68 illustrates an exemplary configuration for a post, in accordance with some embodiments.

FIGS. 69A and 69B illustrate an alternative embodiment of the clips described herein, in accordance with some embodiments.

FIG. 70A illustrates an additional sheet metal feature that can be used to retain one or more lead wires or wire leads of a solar module and hold them fixed in a specific side of the module, for later handling or processing.

FIG. 70B illustrates an embodiment of a clip where the module wire lead is connected to the clip that is also connected to the module and that will be connected to the post.

FIG. 70C illustrates using an additional tool to autonomously take the solar module wire leads that are held in place by the clip and connect them to each other to form an electrical connection between the modules.

FIG. 71 illustrates an alternative embodiment of the tool and method in FIGS. 70A, 70B, and 70C, whereby the tool does not push two connectors together, and instead cuts, strips, and splices the wires together in place without the use of a connector.

FIG. 72 and FIG. 73 illustrate an exemplary configuration in which a plurality of modules are positioned at a 90 degree orientation relative to the ground.

FIG. 74 illustrates an example of a middle clip, in accordance with some embodiments.

FIG. 75 illustrates a removable access trough that can be placed on top of posts in the valley or peaks of a solar module array.

FIG. 76 and FIG. 77 illustrate a gantry on wheels that can drive on the ground in the gaps between the array in certain configurations.

FIGS. 78A-78C illustrate an example configuration of a conveyer apparatus for the post installation machine, in accordance with some embodiments.

FIG. 79 illustrates another example configuration of the conveyer apparatus, in accordance with some embodiments.

FIG. 80 illustrates an example feeding system for the post installation machine, in accordance with some embodiments.

FIGS. 81A-81C illustrate an example mechanical arrangement to transition posts, in accordance with some embodiments.

FIGS. 82A-82C illustrate an example of a magazine and rail system of the conveyer apparatus, in accordance with some embodiments.

FIGS. 83A and 83B illustrate example detail views of the conveyance unit shown in FIG. 79, in accordance with some embodiments.

FIGS. 84A and 84B illustrate another example mechanical arrangement to store and transport posts, in accordance with some embodiments.

FIG. 85 illustrates different example rail configurations for the rail system, in accordance with some embodiments.

FIGS. 86A-86C illustrate different example configurations of a hammer and actuator of the post installation machine, in accordance with some embodiments.

FIG. 87 illustrates an example configuration of a post installation machine with a loader, in accordance with some embodiments.

FIGS. 88A-88C illustrate example integrations of the post installation machine with a skid, in accordance with some embodiments.

FIG. 89 illustrates an example configuration of the post installation machine fitted with tracks or wheels at its base and a hydraulic or electric power source, in accordance with some embodiments.

FIGS. 90A and 90B illustrates different views of an example configuration of a hammer bit of the post installation machine, in accordance with some embodiments.

FIG. 91 illustrates different views of another example configuration of the hammer bit of the post installation machine, in accordance with some embodiments.

FIGS. 92A and 92B illustrate a range of motion of a module installation machine, in accordance with some embodiments.

FIGS. 93A-93D illustrate different example configurations of the module installation machine, in accordance with some embodiments.

FIGS. 94A and 94B illustrate an example configuration of a compliant mechanism on an end of a crane of the module installation machine, in accordance with some embodiments.

FIG. 95 illustrates another example configuration of the compliant mechanism on the end of the crane of the module installation machine, in accordance with some embodiments.

FIG. 96 illustrates an example configuration of an end effector of the crane of the module installation machine, in accordance with some embodiments.

FIG. 97A shows an exemplary arrangement of a row of posts, in accordance with some embodiments.

FIG. 97B shows an exemplary array of posts and solar panels/modules that are assembled with posts at alternating angles, in accordance with some embodiments.

FIG. 98A shows an exemplary assembly of post and solar module, in accordance with some embodiments.

FIG. 98B shows another exemplary assembly of post and solar module, in accordance with some embodiments.

FIG. 98C shows another exemplary assembly of post and solar module, in accordance with some embodiments.

FIG. 99A shows an exemplary post-module interface, e.g., a bracket for coupling a post and solar modules, in accordance with some embodiments.

FIG. 99B shows a top view of the bracket 9900 before the bolts and clamps are coupled to the bracket, in accordance with some embodiments.

FIG. 99C shows an exemplary configuration of a bracket, in accordance with some embodiments.

FIG. 99D shows another exemplary configuration of a bracket, in accordance with some embodiments.

FIG. 99E shows two adjacent solar modules 9916 and 9917 that are not on the same flat surface, in accordance with some embodiments.

FIG. 99F shows the coupled bracket 9900 with posts 9905, in accordance with some embodiments.

FIG. 99G shows an exemplary assembly of a post, a bracket, and solar modules.

FIG. 100A shows a non-flat pivot feature 10000 of a bracket, in accordance with some embodiments.

FIG. 100B shows a solar module with no tilt (10003), tilted with a positive angle (10004) and tilted with a negative angle (10005) when the solar module is coupled to the bracket with the non-flat pivot feature, in accordance with some embodiments.

FIG. 100C shows an enlarged view of a solar module 10001 tilted at a positive angle relative to a flat surface, in accordance with some embodiments.

FIG. 100D shows an enlarged view of a solar module 10002 tilted at a negative angle relative to a flat surface, in accordance with some embodiments.

FIG. 101 shows an exemplary bracket comprising plastic material and metallic material, in accordance with some embodiments.

FIG. 102 shows a post installer, in accordance with some embodiments.

FIGS. 103A and 103B show the apparatus for post loading from a post hopper and feeder, in accordance with some embodiments.

FIGS. 104A and 104B illustrate the loading operation of posts, in accordance with some embodiments.

FIG. 105 shows a shematic post hopper and feeder, in accordance with some embodiments.

FIG. 106 shows a post hopper and feeder machine, in accordance with some embodiments.

FIG. 107A shows an exemplary post pounder, in accordance with some embodiments.

FIG. 107B shows a post pounder configuration after a post is gripped and transported to a vertical position, in accordance with some embodiments.

FIG. 107C is a perspective view of a post pounder configuration after a post is gripped and transported to a vertical position, in accordance with some embodiments.

FIG. 108 shows an exemplary post installing machine (post installer), in accordance with some embodiments.

FIG. 109 shows an example of a digital representation of the post and solar module assembly, in accordance with some embodiments.

FIG. 110A shows an exemplary digital surface data, in accordance with some embodiments.

FIG. 110B shows a digital representation of the predicted and/or design array components at the terrain, in accordance with some embodiments.

FIG. 111 shows an exemplary digital representation of a design array, in accordance with some embodiments.

FIG. 112A shows a sensor to record array and terrain data during the installation.

FIG. 112B shows an updated digital model with data from the sensor, in accordance with some embodiments.

FIG. 113A shows example data of the calculation for power produced by the array, in accordance with some embodiments.

FIG. 113B shows an exemplary isometric view of a design array exported from the digital representation, in accordance with some embodiments.

FIG. 113C shows an exemplary instruction path plan for an installation/construction, in accordance with some embodiments.

FIG. 113D shows an exemplary plan view of a design array exported from the digital representation, in accordance with some embodiments.

### DETAILED DESCRIPTION

While various embodiments of the disclosure have been shown and described herein, it will be obvious to those skilled in the art that such embodiments are provided by way of example only. Numerous variations, changes, and substitutions may occur to those skilled in the art without departing from the disclosure. It should be understood that various alternatives to the embodiments of the disclosure described herein may be employed.

Whenever the term “at least,” “greater than,” or “greater than or equal to” precedes the first numerical value in a series of two or more numerical values, the term “at least.” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than.” “less than,” or “less than or equal to” applies to each of the numerical values in that series of numerical values. For example, less than or equal to 3, 2, or 1 is equivalent to less than or equal to 3, less than or equal to 2, or less than or equal to 1.

The term “real time” or “real-time,” as used interchangeably herein, generally refers to an event (e.g., an operation, a process, a method, a technique, a computation, a calculation, an analysis, a visualization, an optimization, etc.) that is performed using recently obtained (e.g., collected or received) data. In some cases, a real time event may be performed almost immediately or within a short enough time span, such as within at least 0.0001 millisecond (ms), 0.0005 ms, 0.001 ms, 0.005 ms, 0.01 ms, 0.05 ms, 0.1 ms, 0.5 ms, 1 ms, 5 ms, 0.01 seconds, 0.05 seconds, 0.1 seconds, 0.5 seconds, 1 second, or more. In some cases, a real time event may be performed almost immediately or within a short enough time span, such as within at most 1 second, 0.5 seconds, 0.1 seconds, 0.05 seconds, 0.01 seconds, 5 ms, 1 ms, 0.5 ms, 0.1 ms, 0.05 ms, 0.01 ms, 0.005 ms, 0.001 ms, 0.0005 ms, 0.0001 ms, or less.

In an aspect, the present disclosure provides systems and methods for handling and deploying energy modules. The energy modules may comprise a solar module or a plurality of solar modules. The solar modules may comprise a deployable device that is configured to generate energy using one or more resources. In some cases, the one or more resources may comprise solar energy, heat energy, radiation energy, or any other type of energy.

In an aspect, the present disclosure provides a method for handling or deploying a solar module. The method may comprise using at least one robot to fully autonomously position and assemble (i) at least one solar module and (ii) its supporting structure, e.g., at least one post, at a sensed geolocation, without aid from a user. In some cases, a plurality of robots may be used to autonomously position and deploy, install, or assemble a plurality of solar modules and/or one or more supporting structures for the plurality of solar modules.

In some cases, a robot may refer to any machine capable of performing one or more tasks. In some cases, the robot may perform the one or more tasks autonomously (e.g., without human intervention or without external intervention from another entity) or semi-autonomously (e.g., with minimal external supervision, instruction, or intervention).

In some cases, a task may comprise transporting various components to be used for deploying an energy module as disclosed herein, for example, an energy module or a post. In some cases, a task may comprise installing various components for building an energy module disclosed herein, for example, installing a post on the ground or connecting an energy module to a given post. In some cases, a task may comprise handling and deploying an energy module.

In some cases, the robot may comprise one or more movable members. In some cases, the movable members may comprise an arm or an end effector. The movable members may be configured to handle, move, or deploy the energy modules.

In some cases, the robot may comprise one or more energy storage devices (e.g., a battery). In some cases, the one or more energy storage devices may be chargeable by a renewable energy system. In some embodiments, one or more electric charging stations may be provided and distributed across a terrain for enabling charging of one or more robots. The one or more robots may comprise, for example, a mobile platform, a vehicle, or any other machine as described elsewhere herein. In some embodiments, the one or more electric charging stations can be mobile. In such cases, the electric charging stations may be configured to travel to a robot or vehicle that needs to be charged. In other embodiments, the one or more electric charging stations can be stationary. In such cases, one or more robots or vehicles may be configured to travel to the one or more electric charging stations for charging.

In some cases, the robot may comprise a vehicle. In some cases, the vehicle may comprise one or more wheels, one or more legs, or any other member configured to transport the robot on flat or non-flat terrain.

In some cases, the robot may comprise one or more vision sensors. In some cases, the robot may perform a task based at least in part on information provided through the one or more vision sensors.

In some cases, the robot may comprise one or more computers, processors, or logic circuits in operable communication with one or more computers, processors, or logic circuits of another robot, or one or more servers (e.g., a cloud server).

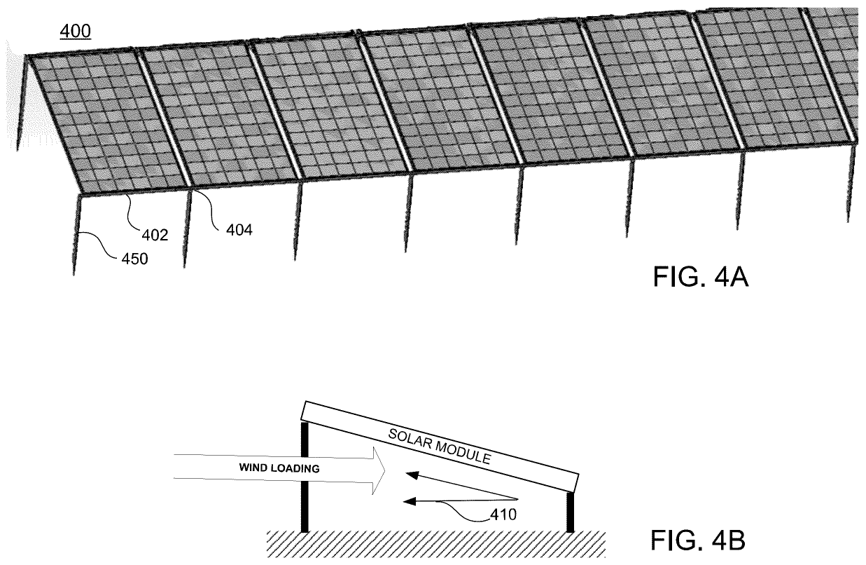

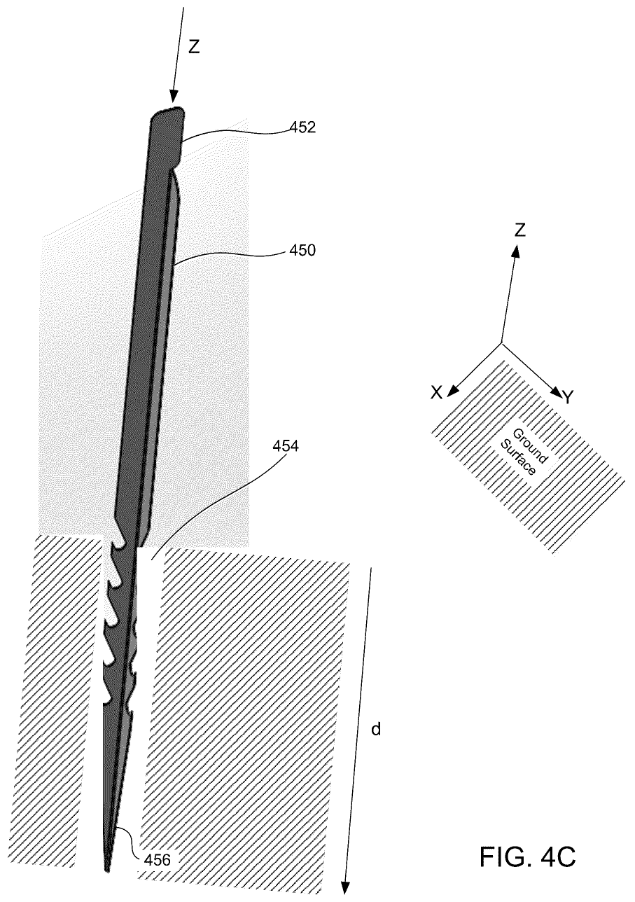

In some cases, a plurality of robots may be used to autonomously position and deploy supporting structures, e.g., a plurality of posts configured to support the plurality of solar modules. The solar modules may be affixed to one or more posts. FIG. 4C shows an enlarged view of a post 450) according to some embodiments. In some cases, the post may comprise a flat top interface 452 to offer a clinching surface for the clip. In some cases, the post may be fabricated from sheet metal (e.g., provided in a coil). In some cases, a lower portion of the post may include a sawtooth pattern 454 that is cut to impart resistance from being pulled out from the ground. In some non-limiting embodiments, the post may have a length ranging from about 1 foot (ft) or 0.30 meters (m) to about 10 ft (or 3.05 m). In some cases, an exemplary post may be about 3 ft (or 0.91 m) long, with 1 ft (or 0.30 m) exposed out of ground, and 2 ft (or 0.61 m) projecting into the ground. In some cases, an exemplary post may be about 10 ft (or 3.05 m) long, with about 3 ft (or 0.91 m) to 5 ft (or 1.52 m) exposed out of ground, and 5 ft (or 1.52 m) to 7 ft (or 2.13 m) projecting into the ground. In some cases, an exemplary post may be about 10 ft (or 3.05 m) long, with about 4 ft (or 1.22 m) exposed out of ground, and 6 ft (or 1.83 m) projecting into the ground.

In some embodiments, the post may comprise a pointed end 456 for efficient driving into the ground, e.g., by (hydraulic) pushing. In some cases, the degree of tapering of this end can be determined to accommodate the shape of a corresponding tip of a next post in the coil, thereby conserving sheet metal material and reducing cost.

In some cases, the presently disclosed embodiments may allow for vertical adjustment of the dimension of the post protruding above ground. In some cases, the vertical adjustment may be accomplished by pushing deeper or by adding an upper attachment to increase post height.

In some cases, a robot may install a first post at a first location and a second post at a second location. In some cases, the first location and the second location may be sufficiently close such that an energy module may be installed to be supported by both the first post and the second post. In some cases, two separate energy modules may be installed to be supported by each of the first post and the second post, respectively. In some cases, the first post may be installed first, and the second post may be installed second. In some cases, the first post and the second post may be installed substantially at about the same time. In some cases, a first robot may install a first post at a first location and a second robot may install a second post at a second location. Various number of posts may be installed by a given robot. One or more posts may be installed at various locations by a given robot.

In some cases, the plurality of robots may be configured to operate as a fleet or a swarm. The plurality of robots may communicate with one or more servers configured to control an operation or a movement of the plurality of robots within an area or location comprising the sensed geolocation. The server may provide different commands to different robots, or command different robots to collaboratively perform one or more tasks. It shall be understood that the coordination of one or more robots may be implemented in various configurations to achieve a similar effect, for example, by using various number of robots, various types of robots, various number of posts, and various rulesets or algorithms for coordinating the robots.

In some cases, the plurality of robots may be configured to operate in a coordinated manner such that a time taken to perform the one or more tasks is optimized. For instance, a first set of robot(s) may coordinate to install one or more posts at a first location and then immediately at a second location. A second set of robot(s) may coordinate with the first set of robot(s) to install a solar module at the first location immediately as the one or more posts are installed at the first location. In some cases, the first location may be a region near the robot. In some cases, the first location may be a region near where the solar module is stored. In some cases, the second location may be near the first location. In some cases, the second location may be a geo-sensed location (e.g., a location that is determined or identified using one or more positions sensors and/or geographical or topological data). In some cases, the second location may be an approximate location, and the approximate location may be adjusted in real-time to be a more precise location.

In some cases, the method may comprise using the at least one robot to fully autonomously position and assemble the at least one solar module and its supporting structure in two or more different directions. The two or more different directions may comprise a first direction and a second direction. The first direction and the second direction may be parallel to each other. Alternatively, the first direction and the second direction may be disposed at an angle relative to each other. The angle may range from ( ) degrees to 180 degrees.

In some cases, the at least one robot may use a movable member to handle the solar module or any components or supporting structures thereof. In some cases, the at least one robot may move the solar module or any components or supporting structures thereof by translating along one, two, or three Euclidean dimensions. In some cases, the at least one robot may move the solar module or any components or supporting structures thereof by rotating the solar module around one, two, or three axes of the solar module. In some cases, the at least one robot may translate and rotate the solar module simultaneously. In some cases, the at least one robot may translate the solar module and then rotate the solar module subsequently, or vice versa. In some cases, for a solar module that is substantially rectangular in shape, an axis of a solar module may be defined as the normal direction from the plane of the solar module having the largest area, the plane of the solar module having the second largest area, or the plane of the solar module having the third largest plane. The at least one robot may move the solar module in various ways, including changing a position and/or an orientation of the solar module or the components of the solar module.

In some cases, the solar module, supporting structures, and any components thereof may be repositioned and/or re-oriented to be more precise and/or ensure proper installation during deployment. In some cases, a given post may be repositioned and/or re-oriented to ensure a successful insertion of the post into the ground.

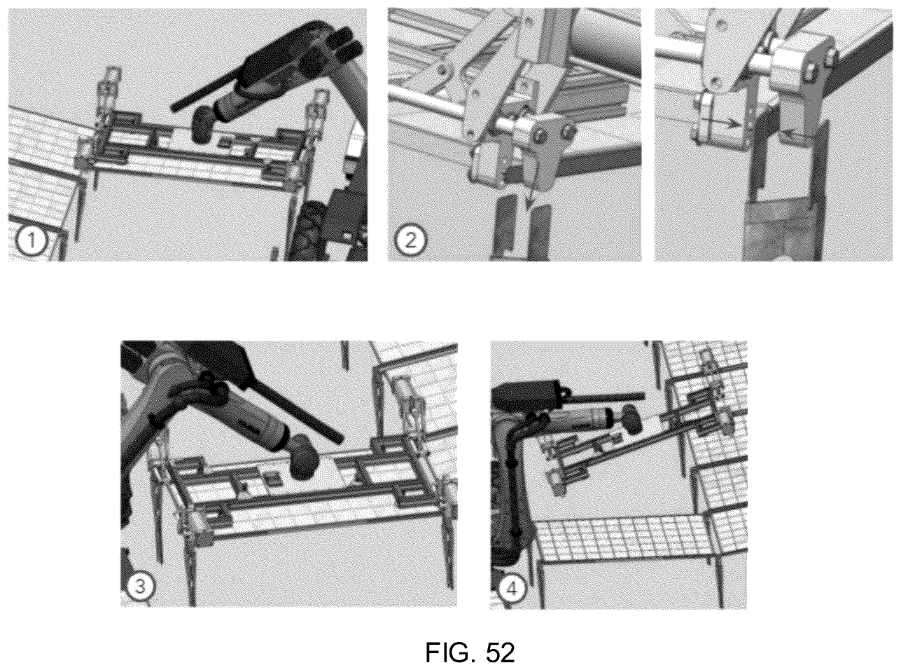

FIG. 52 illustrates an exemplary method for autonomously positioning and assembling solar modules, in accordance with some embodiments. In some cases, a module installer (e.g., a robot) may drive to a location. The location may be determined by a user or an operator of the robot, or based on sensor data. In some cases, a module installer may pick up an energy module (e.g., a solar module). In some cases, a module installer may position the module over 1, 2, 3, 4, or more posts. The posts may be installed autonomously by another robot.

In some cases, a clinch tool may be used to form a connection between the modules and the one or more posts, as described in greater detail below. In some cases, the clinch tool may fit between ears of a post and a clip. In some cases, the clinch tool may close to form a joint. In some cases, the module installer may release the clinch tool. In some cases, an end effector may be used to handle the tool and/or install the module. In some cases, a module installer may drive to another set of one or more posts to install another module.

In some embodiments, the method may comprise using the at least one robot to fully autonomously position and assemble a plurality of solar modules and associated supporting structures to construct a solar module array. In some cases, the plurality of solar modules and the associated supporting structures may comprise at least one solar module and a supporting structure for the at least one solar module.

In some cases, an array of modules, solar modules, energy modules, and the like may refer to an arrangement of a plurality of solar modules across an area or region. In some cases, the arrangement may be a lateral arrangement. In some cases, the arrangement may comprise a plurality of rows and/or columns. In some cases, the arrangement may comprise a circular pattern and/or a ring configuration. In some cases, the arrangement may comprise a hexagonal (e.g., honeycomb) pattern. In some cases, the arrangement may comprise a random configuration. In some cases, the arrangement may be based at least in part on the terrain or topology of the area or region in which the array is or will be deployed.

In some cases, the solar module arrays and/or various supporting structures (e.g., posts) can be constructed, deployed, or installed on a substantially flat terrain. In some cases, the solar module arrays can be constructed on a substantially non-flat terrain. The terrain on which the solar module arrays and/or the various supporting structures (e.g., posts) are constructed, deployed, or installed can comprise, for example, sand soil, rocks, water, ice, vegetation, grass, or any other manmade or natural surface. In some cases, the terrain may comprise a canyon, a desert, a forest, a glacier, a hill, a marsh, a mountain, a valley, an oasis, an ocean or other body of water, open terrain, a river terrain, a swamp terrain, or a tundra terrain.

In some cases, the terrain may comprise one or more flat portions and/or one or more inclined portions. In some embodiments, the inclined portions may have a slope ranging from about 1 degree to about 30 degrees or more.

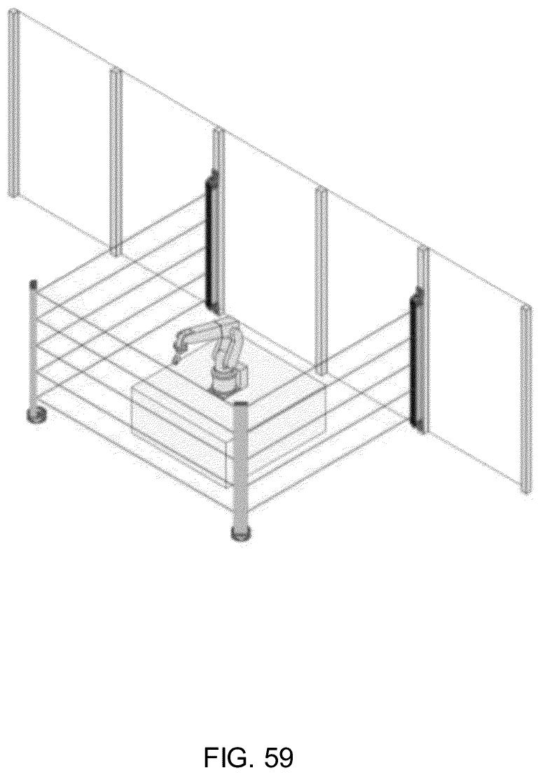

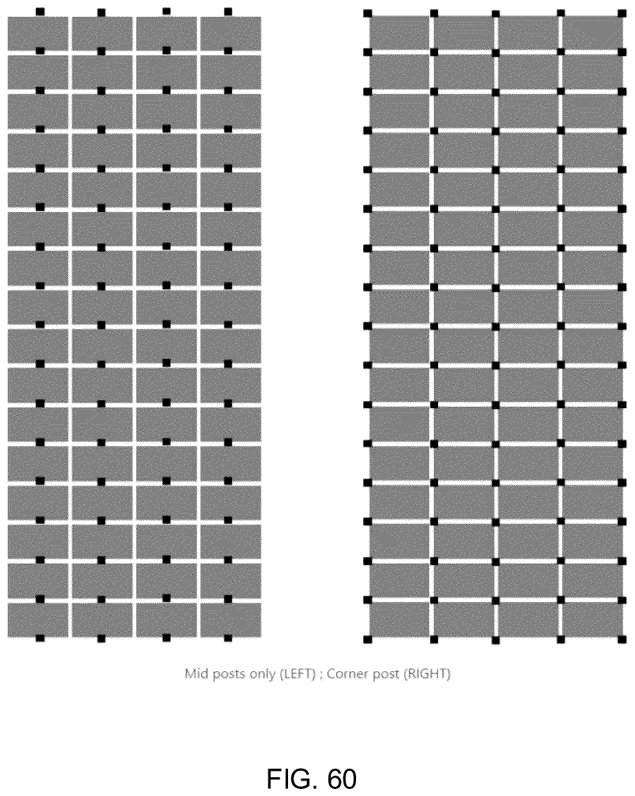

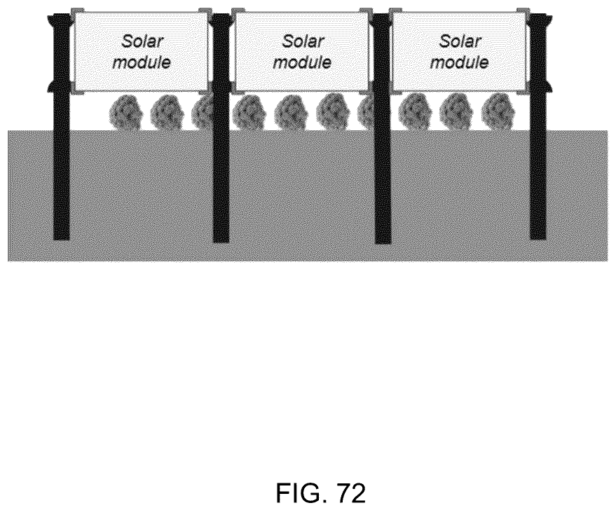

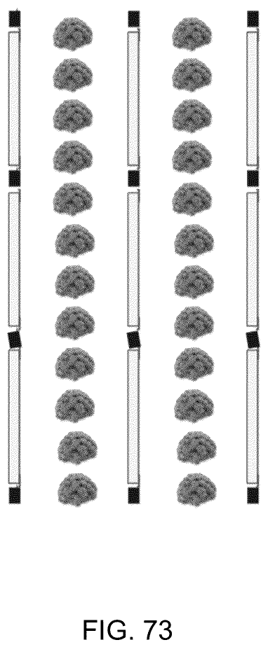

FIG. 60 illustrates various solar module array configurations, in accordance with some embodiments. In some cases, the solar module array may comprise 4 posts for each corner of a module. In some cases, the solar module array may comprise 2 posts along a middle axis of a module. In some cases, the solar module array may be a complete wired array. In some cases, the solar module array may be a dual-tilt array. In some cases, the solar module array may be a fixed tilt array. In some cases, one or more modules of the array may comprise a support bracket that is mounted directly to a post without requiring a spanning intermediate structure. In some cases, one or more modules may span two or more posts without the need for an intermediate structure between posts. FIG. 72 and FIG. 73 illustrate an exemplary configuration in which a plurality of modules are positioned at a 90 degree orientation relative to the ground. In some cases, the solar modules may be tilted to a full 90 degrees. In some cases, a plurality of posts may be affixed to one or more sides of the solar modules. In some cases, the arrangement and/or the configuration of the solar modules may permit access to the spaces between various rows in a solar module array. In some cases, the spaces between the various rows in the array may be used for growing crops. The posts, clips, and modules may be placed, installed, or deployed in accordance with any of the embodiments, methods, and/or system configurations shown and described herein.

In some cases, the modules may be configured to independently track the sun. Tracking the sun may comprise moving, repositioning, or reorienting the modules so that a working surface of the modules is able to receive one or more rays of light from the sun.

In some cases, the modules may track the sun based at least in part on a forecast, the location of the modules, or both. In some cases, the modules may track the sun based at least in part on a measured signal. e.g., amount of energy or power generated by the modules.

In some cases, the modules may each comprise an individual drive such that each module may independently track the sun. In some cases, the modules may be connected with a continuous wire or chain. The continuous wire or chain may be driven by a mechanism (e.g., one or more motors) to track the solar modules about one or more pivots on the posts. In some cases, the modules may be driven by a linkage (e.g., a 90 degree linkage) to a required angle, without requiring a tracking unit or a tracking table.

In some cases, one or more mechanisms may be disposed on one end of an array of solar modules. In some cases, one or more mechanisms may be disposed on two opposite ends of an array of solar modules. In some cases, one or more mechanisms may be disposed among the solar modules in the array. Any sufficient number of mechanisms may be disposed among the solar modules, and any sufficient arrangement of mechanisms may be disposed among the solar modules.

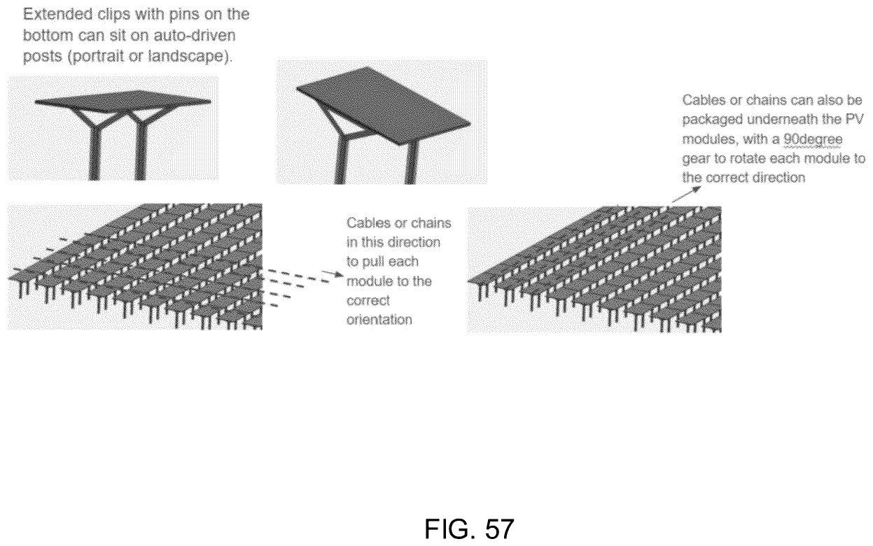

FIG. 57 illustrates a solar tracker, in accordance with some embodiments. The solar tracker may comprise a solar module sun tracking capabilities and/or a mechanism for moving one or more portions or components of a solar module to track the sun.

In some cases, an array of solar modules may comprise a plurality of solar modules disposed substantially linearly in at least one direction. In some cases, the linearly disposed plurality of solar modules may be coupled with one or more cables or chains along the linear direction. In some cases, the one or more cables or chains may be pulled along the linear direction, such that the plurality of solar modules are reoriented and/or repositioned.

In some cases, the plurality of solar modules may be disposed substantially linearly in at least two directions. In some cases, the plurality of solar modules may be coupled with at least two sets of one or more cables or chains along the at least two directions, respectively. In some cases, a first set of the one or more cables may be pulled along a first linear direction to reorient and/or reposition the plurality of solar modules in a first direction. In some cases, a second set of the one or more cables may be pulled along a second linear direction to reorient and/or reposition the plurality of solar modules in a second direction.

In some cases, the one or more cables or chains may be coupled above or below a given solar module. In some cases, the one or more cables or chains may be coupled to the side of a given solar module.

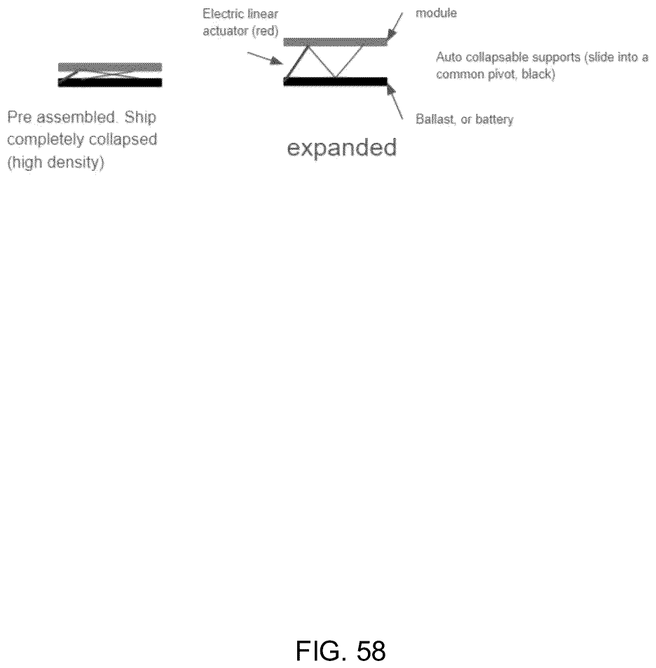

FIG. 58 illustrates a tracking unit, in accordance with some embodiments. The tracking unit may comprise a solar module with sun tracking capabilities and/or a mechanism for moving one or more portions or components of a solar module to track the sun.

In some cases, the tracking unit may be autonomously deployed. In some cases, the tracking unit may be pre-assembled, distributed, and placed on a field. In some cases, the tracking unit may be positioned, deployed, or wired autonomously using geolocation data and/or any machine or robot disclosed herein. In some cases, the tracking unit may be expandable to a single module solar track for tracking the sun in one, two, three, or more axes.

The methods disclosed herein may be implemented using a ground mount system for solar panels. The ground mount system may comprise a system, a structure, or a plurality of components configured to support or stabilize an energy module when the energy module is deployed.

FIG. 1 is a simplified force diagram of a system 100 for ground mounting solar panels, in accordance with some embodiments. Here, the active photovoltaic (PV) materials and any associated components (frames, beams, pillars, superstructure, junction boxes, wiring) represent a physical load G 102 that may be safely and reliably supported above the ground 104 against at least the force of gravity, as well as against possible external forces (e.g., wind, seismic).

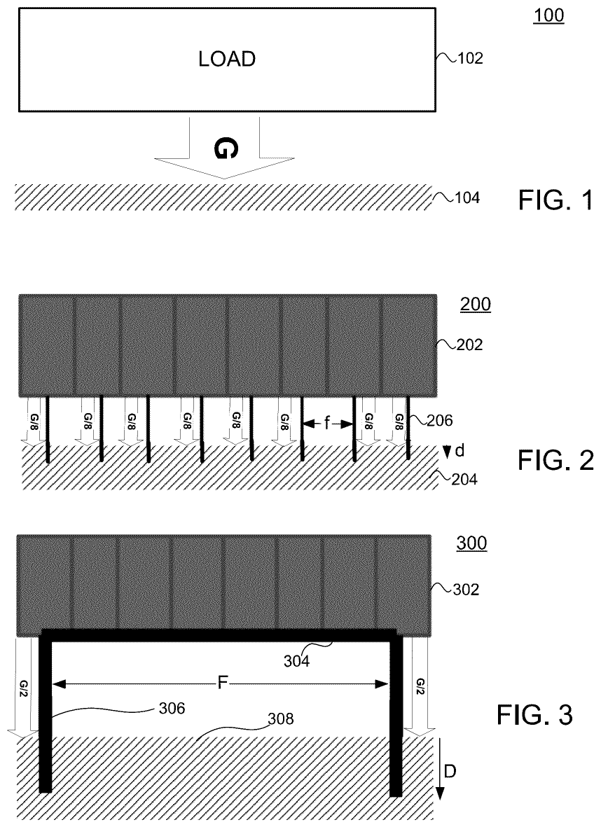

FIG. 2 shows a simplified view of an embodiment 200 of a ground mount system for solar modules, in accordance with some embodiments. Here, a plurality of solar modules 202 are reliably supported above the ground 204 by a plurality of posts 206. In some cases, no separate and distinct superstructure may be needed. In some cases, these posts may be relatively small in size, and can be installed with a high frequency f. In some cases, each post may bear a much smaller portion of the overall load. Moreover, for the embodiment of FIG. 2, installation efficiencies may not require large blocks of solar modules distributed over large land areas. As a result, loads may be dictated by expected local peaks that are smaller in size. As a result of the reduced load required to be borne by each post, posts may penetrate the ground to a shallower depth. In some cases, additional supporting material (e.g., concrete) may not be required to secure the post within the ground. In some cases, this installation structure may allow for simpler, less expensive, and less invasive installation techniques. e.g., by (hydraulic) pushing or threading as described herein.

FIG. 3 shows a conventional ground mount structure 300 for supporting solar modules 302, in accordance with some embodiments. This is a connected structure comprising a separate superstructure 304 and relatively massive pillars 306. These pillars occur at a relatively low frequency (F), and each bears a relatively large fraction of the entire load. In some cases, they are sunk to a substantial depth (D) within the earth 308—and may be secured therein with additional materials (not shown) such as concrete.

Instead of relying on separate, distinct, and massive superstructure components for structural stability, some embodiments of the present disclosure may utilize inter-connectedness between modules in order to provide stability. FIG. 4A shows a perspective view of a ground mount system 400, in accordance with some embodiments. In some cases, many posts 450) may support a row of solar modules 402. In some cases, rectangular solar modules comprising seventy-two cells are shown. Various embodiments may support solar modules of various types. At each corner, the solar modules may be secured by a clip 404 to a respective post.

FIG. 4B is an end view of the ground mount system of FIG. 4A, in accordance with some embodiments. FIG. 4B shows the tilt angle 410 provided by the ground mount, which orients the solar module to catch the sun's rays. FIG. 4B shows that wind can infiltrate the open side of the row, creating wind loading forces, in accordance with some embodiments.

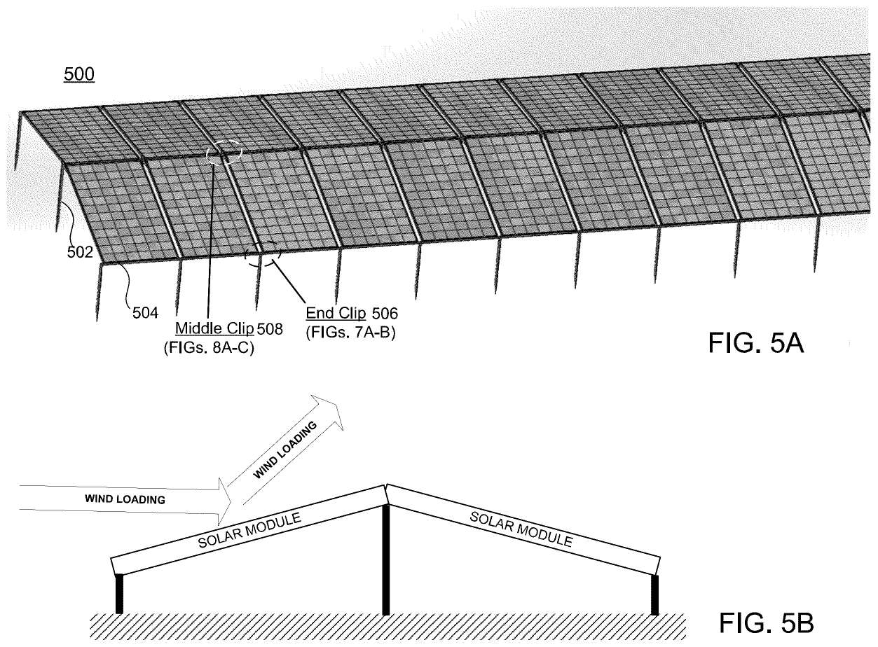

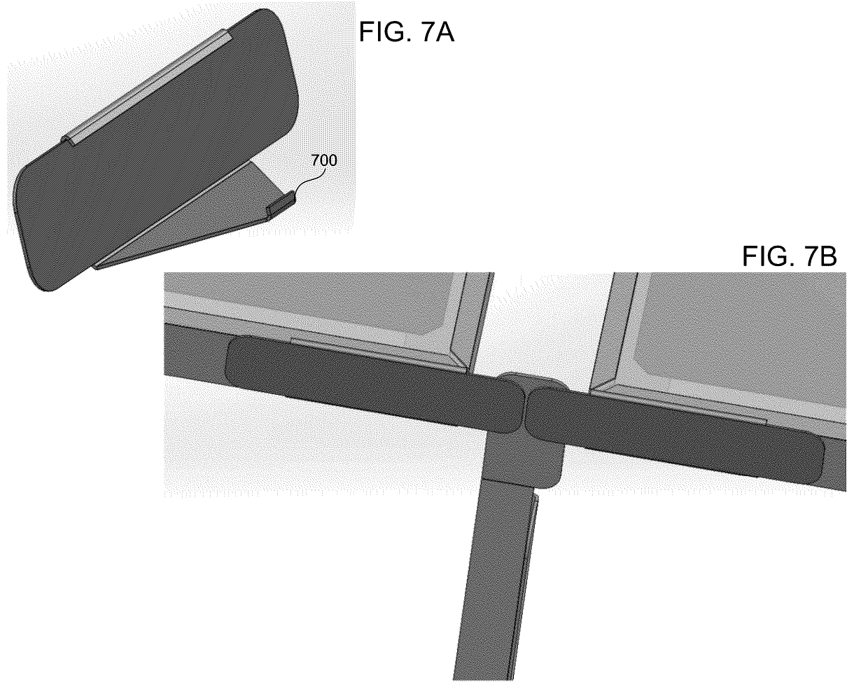

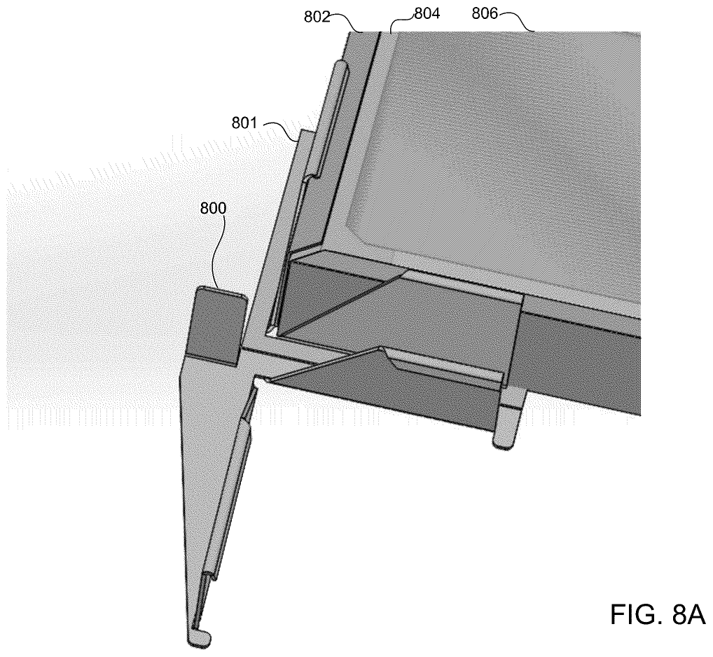

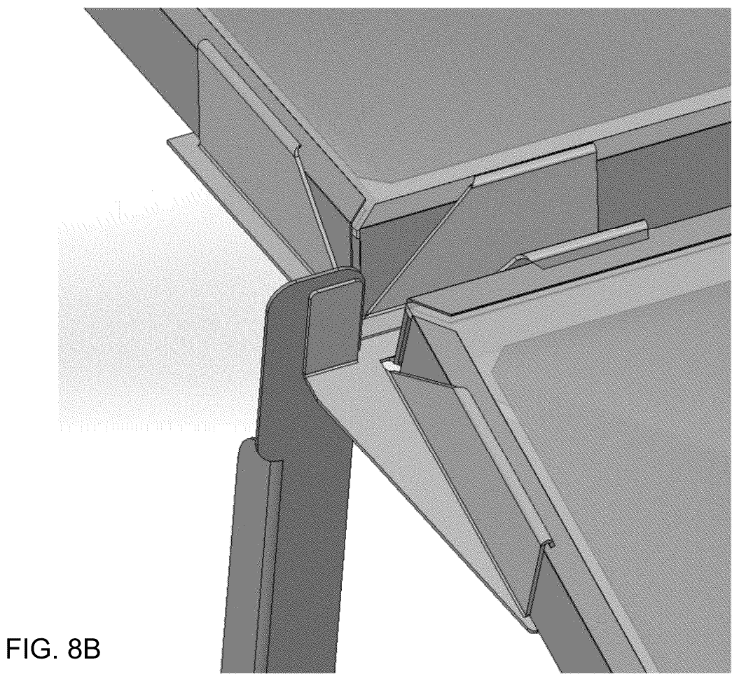

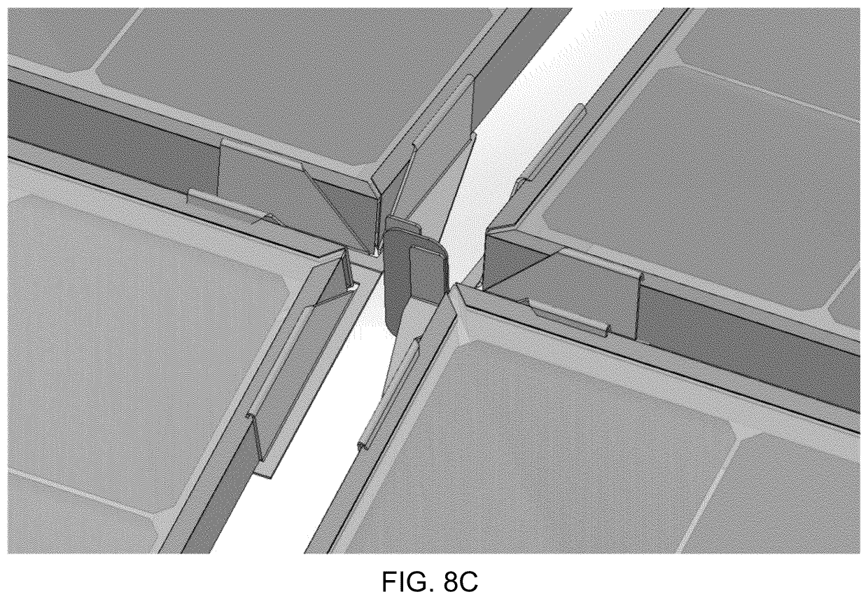

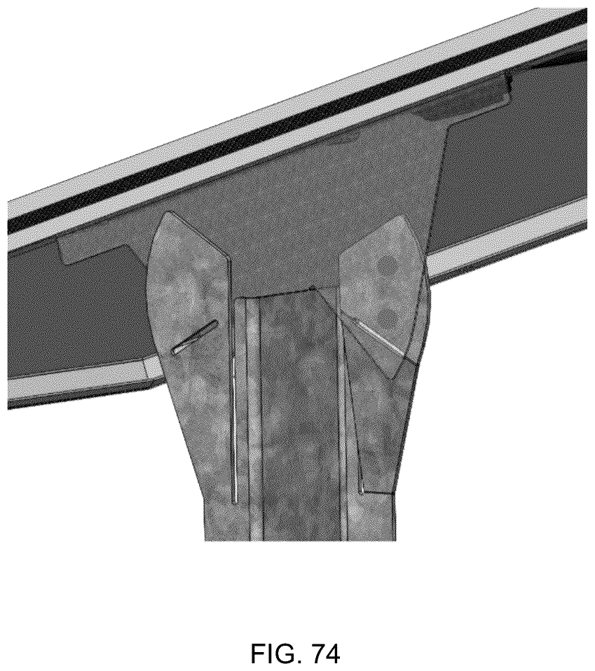

While the ground mount embodiments of FIGS. 4A and 4B show a single row of modules supported at a same tilt angle, alternative embodiments may feature rows with different tilt angle orientations. For instance. FIG. 5A shows a perspective view of a ground mount system 500, in accordance with some embodiments. In some cases, adjacent rows sharing common posts 502, may alternate in tilt angles to create a peaked structure. In some cases, solar modules 504 may be secured to posts by clips having different shapes. One type of clip may be an end clip 506 that is present on a side of a row having no adjacent row on one side. FIGS. 7A and 7B depict examples of end clips, in accordance with some embodiments. FIG. 7A shows a perspective view of an end clip according to an embodiment. As shown, the end clip is symmetric on both ends of module. The end clip captures bottom side of frame and top side of frame. FIG. 7B shows a perspective view of an end clip with two modules attached, in accordance with some embodiments. The center protrusion 700 may prevent the module sliding from laterally. According to an embodiment, the end clip may be fabricated from 1 mm sheet metal. Another type of clip may be a middle clip 508 that is present between adjacent rows. FIG. 74 illustrates an example of a middle clip. The middle clip may be used for solar modules that interface with a post in a middle region of the lateral sides of the module. In some cases, the clip may have an angular opening to accommodate multiple tilt angles, and to facilitate autonomous positioning or alignment of the clip and/or the module. In some cases, the post may have a flat face and a cutout such that the post flange can be bent in and clinched (dimpled) to the module clip in the locations corresponding to the green dots. The module clip may be mounted with a rivet or a bolt, or clinched to the module frame at its standard mounting points on the bottom flange. Another type of clip may be a corner clip. FIGS. 8A-8C depict examples of corner clips. FIG. 8A shows a perspective view of a corner clip 801 connected to a frame 802 of a solar module 804 that comprises photovoltaic material 806 (e.g., a plurality of solar cells). The clip may comprise a center tab 800. FIG. 8B shows a perspective view of the corner clip connected to two modules and a post, in accordance with some embodiments. The center tab 800 that mates (e.g., by clinching) with the face of the post tab, may be long enough to handle tolerances and imparts flexibility to accommodate tolerances in at least the row direction. FIG. 8C shows a perspective view of a pair of corner clips and attached modules, connected to a post, in accordance with some embodiments. In some cases, the clips may exhibit a single, mirrored design such that the tabs land on opposite sides of the post. The corner clips shown and described herein may not or need not require the use of a fastener to clip on to a module.

FIG. 5B shows is a simplified end view of the embodiment of FIG. 5A showing loading forces. In some cases, the inability of wind to flow underneath the raised side of the module rows, can substantially reduce wind loading forces to which the ground mount system is expected to be exposed.

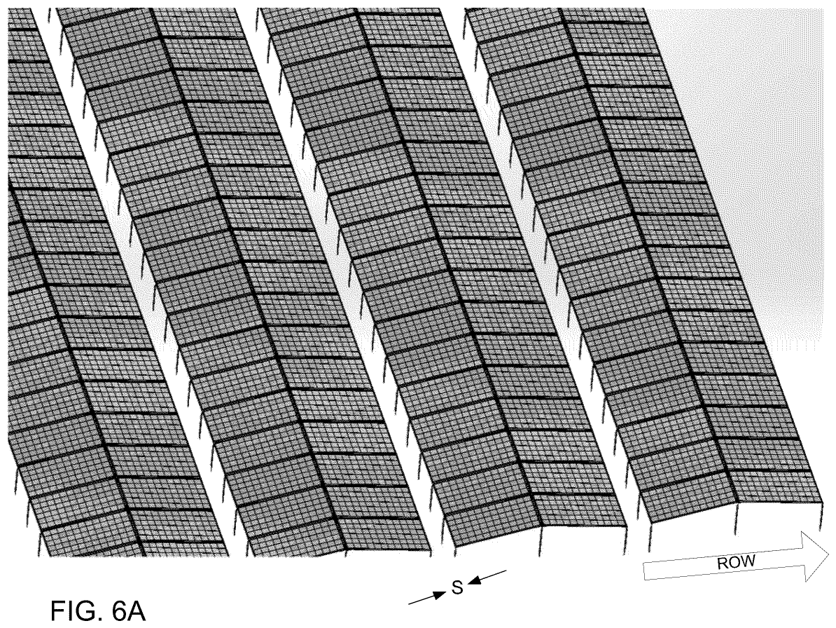

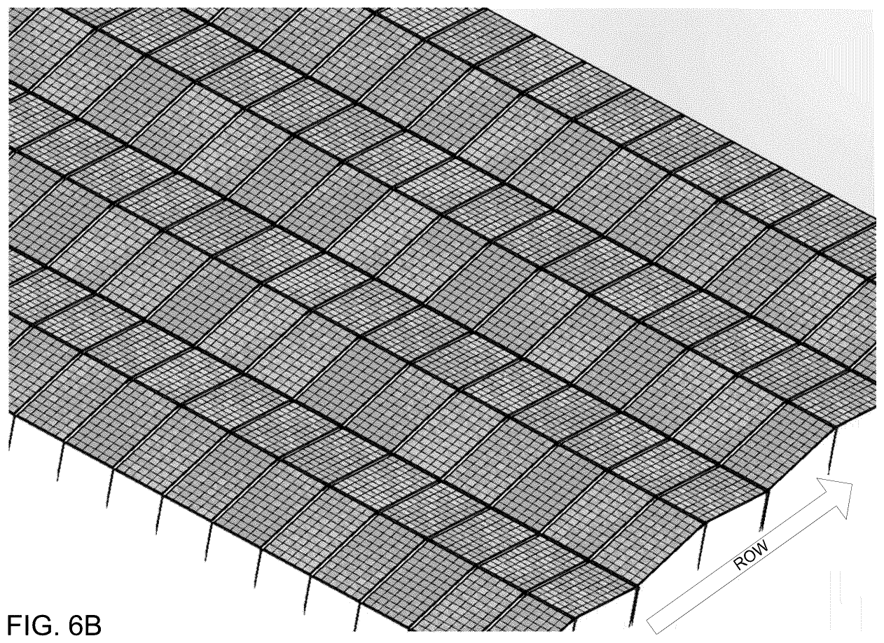

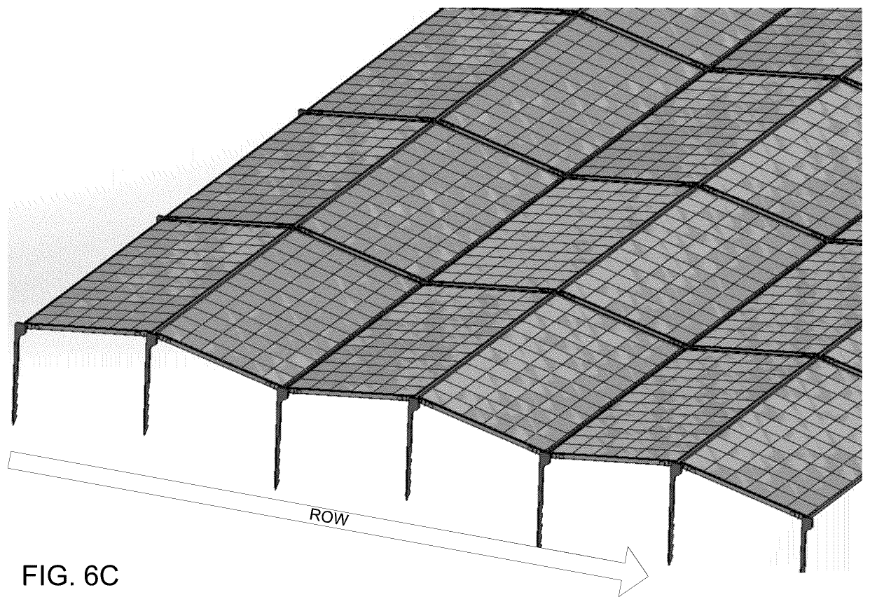

FIG. 6A is a perspective of a solar module array resulting from a ground mount system according to an embodiment. In some cases, the array may comprise a plurality of short (two module) rows, separated by a small spacing S. In some cases, many rows may be spaced closely together, conserving land area and increasing installation efficiency.

FIG. 6B is a perspective view of another solar module array resulting from a ground mount system according to an embodiment. In some cases, the array may comprise longer rows of modules. In some cases, the corners of each row may be adjacent to the corners of the next row; and supported by the same post.

While FIGS. 6A and 6B show solar arrays having rows of landscape-oriented solar modules with long ends aligned in the row direction, this is not required. FIG. 6C shows a perspective view of an alternative embodiment with portrait-oriented solar modules having their short ends aligned in the row direction.

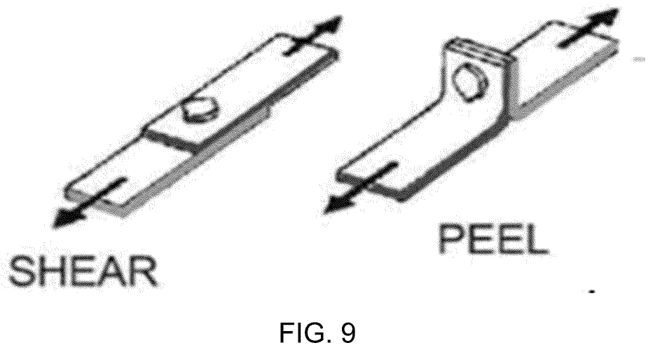

FIG. 9 illustrates peel and shear forces to which the ground mount system may be subjected. Particular embodiments may provide at least about 400 lbs shear strength, and/or at least about 200 lbs of peel strength.

In some embodiments, the posts can be installed substantially perpendicular to a flat surface. In some embodiments, the posts can be installed at an angle relative to a vertical axis that is perpendicular to a flat surface. In some embodiments, the angle can be from ( ) to 5°, from 0° to 10°, from 0° to 20°, from 0° to 30°, from 0° to 40°, from 5° to 10°, from 5° to 20°, from 5° to 30°, from 5° to 40°, from 10° to 20°, from 10° to 30°, from 10° to 40°, from 20°) to 30°, from 20° to 40°, or from 30° to 40°. In some embodiments, a first post can be installed at a first angle relative to a vertical axis that is perpendicular to a flat surface and a second post can be installed at a second angle relative to a vertical axis that is perpendicular to a flat surface. In some embodiments, the first angle and the second angle can be substantially same. In some embodiments, the first angle and the second angle can be different.

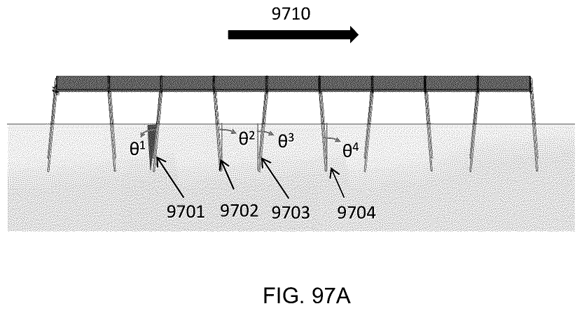

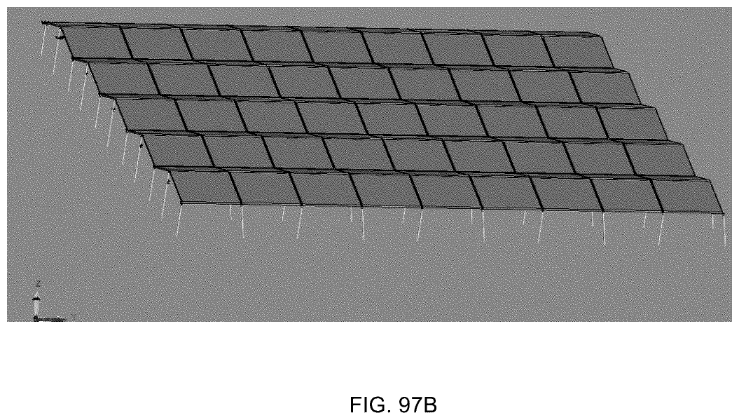

In some embodiments, the posts are not parallel. In some embodiments, the plurality of posts comprises a row of posts wherein two adjacent posts in the row of posts are each tilted toward one another, wherein a third post adjacent to the two adjacent posts is tilted away. In some embodiments, the posts can be installed at alternating angles. In some embodiments, the non-parallel configuration of the posts, e.g., installation at alternating angles, creates an interlocking structure of the posts with regards to forces on the posts. FIG. 97A shows an exemplary arrangement of a row of posts. Post 9701 is adjacent to post 9702, post 9702 is adjacent to posts 9701 and 9703, and post 9703 is adjacent to posts 9702 and 9704. Post 9701 can be tilted forward (in the direction of arrow 9710) at an angle θ1 relative to the vertical axis. Post 9702 can be tilted backward (opposing to the direction of arrow 9710) at an angle θ² relative to the vertical axis. Post 9703 can be tilted forward (in the direction of arrow 9710) at an angle θ³ relative to the vertical axis. Post 9704 can be tilted backward (opposing to the direction of arrow 9710) at an angle θ⁴ relative to the vertical axis. In some embodiments, the angles θ¹-θ⁴ can be substantially same. In some embodiments, the angles θ¹-θ₄ can be different. The interlocking structure can engage better with the soil. In some embodiments, the interlocking structure can resist much higher forces. In some embodiments, at least a row of posts can be installed at alternating angles. In some embodiments, at least a portion of a row of posts can be installed at alternating angles. In some embodiments, the installation of posts at alternative angles can be determined by the location of installation, the environment of the location, the quality of the soil (e.g., soft or hard/dense soil layer), and the terrain surface (e.g., flat or non-flat).

In some embodiments, the post-module interfaces span multiple posts.

In some embodiments, the angles of the posts are determined to allow a shallow embedment.

FIG. 97B shows an exemplary array of posts and solar panels/modules that are assembled with posts at alternating angles.

In some embodiments, the angles are determined prior to the installation and loaded to the autonomous assembly system disclosed herein. The autonomous assembly system can read from instructions with predefined post angles and install precisely the posts at these predefined angles.

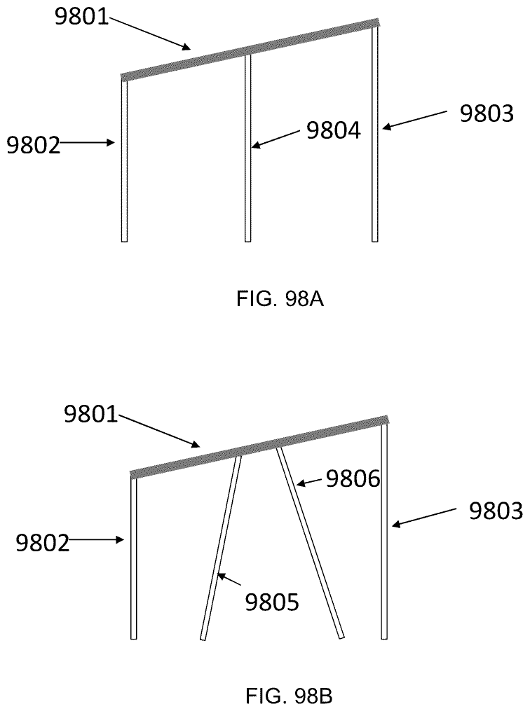

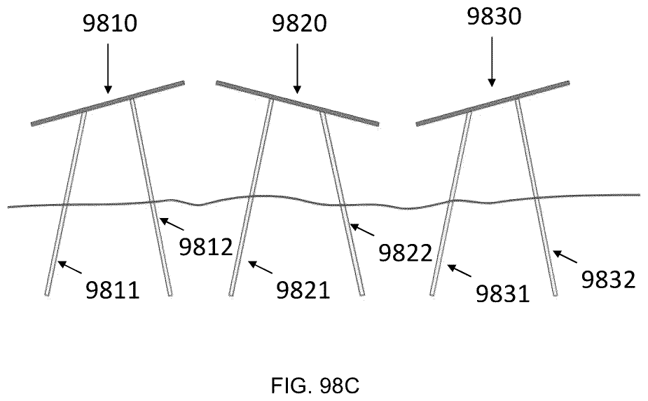

In some embodiments, in addition to the posts that support the solar modules at the corners of the solar modules, additional posts can be installed at the side of the solar module, to provide extra support. FIG. 98A shows an exemplary assembly of post and solar module. Solar module 9801 is supported by posts 9802 and 9803 at one side of the solar module. An additional post 9804 can be added at the one side of the solar module. In some embodiments, more than one posts can be installed at the one side of the solar module in between posts 9802 and 9803. FIG. 98B shows an exemplary assembly of post and solar module. In additional to the posts 9802 and 9803 which are at the corners of the solar module 9801, additional posts 9805 and 9806 are installed at the side of the solar module 9801. In some embodiments, the posts 9805 and 9806 can be installed at an angle relative to the vertical axis. In some embodiments, the posts 9805 and 9806 can be installed at alternating angles relative to the vertical axis, as disclosed above. FIG. 98C shows an exemplary assembly of post and solar module. In addition to the posts at the corners of solar modules (not shown in Figure) 9810, 9820, and 9830, extra posts 9811 and 9812, 9821 and 9822, and 9831 and 9832 are installed for the modules 9810, 9820, and 9830 respectively, to provide extra support, especially in the region or area with higher loads and/or higher terrain tolerance.

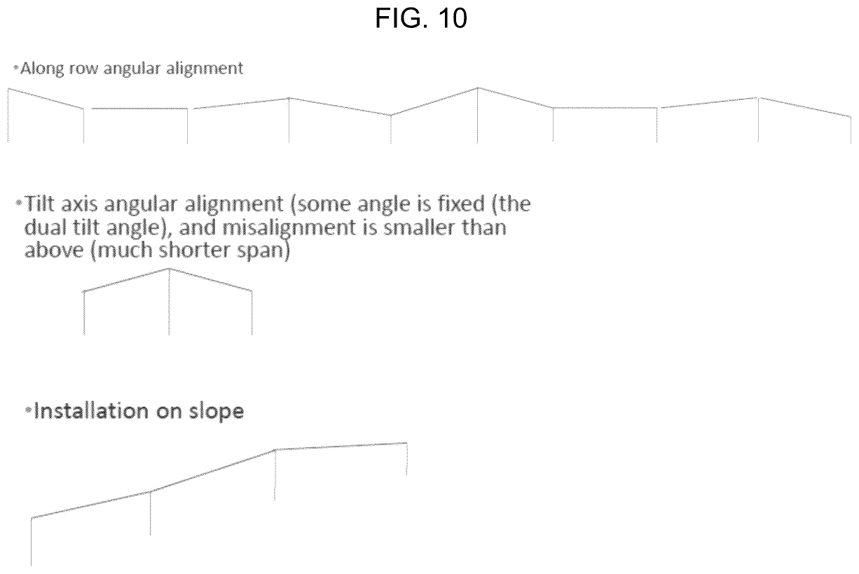

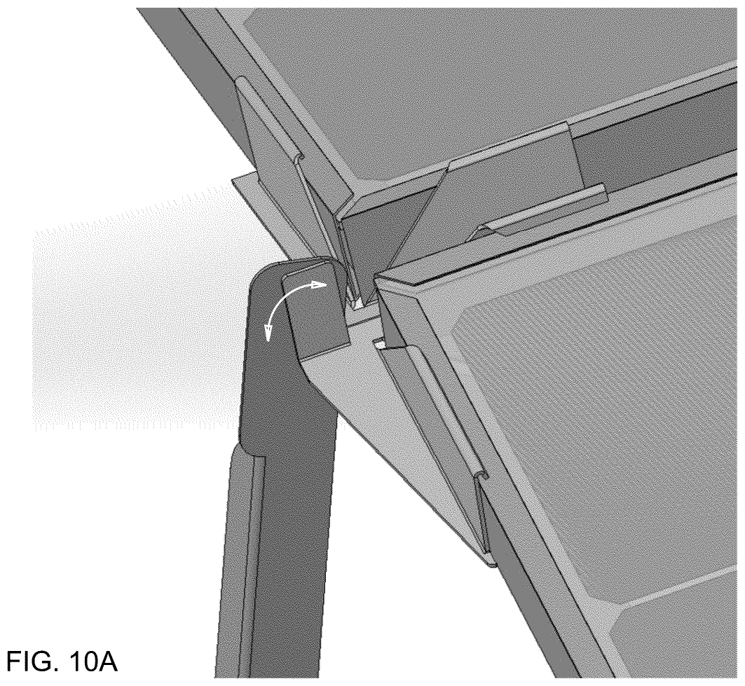

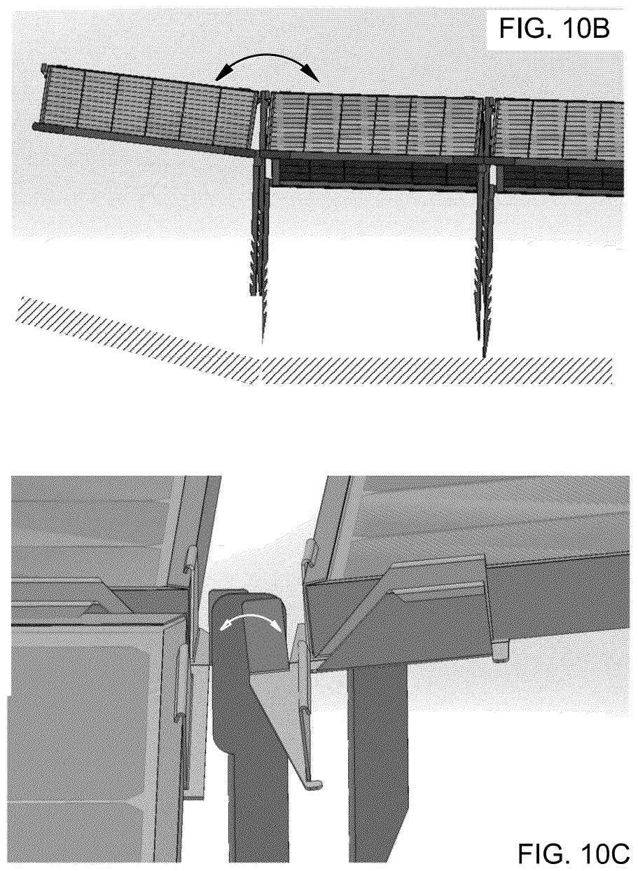

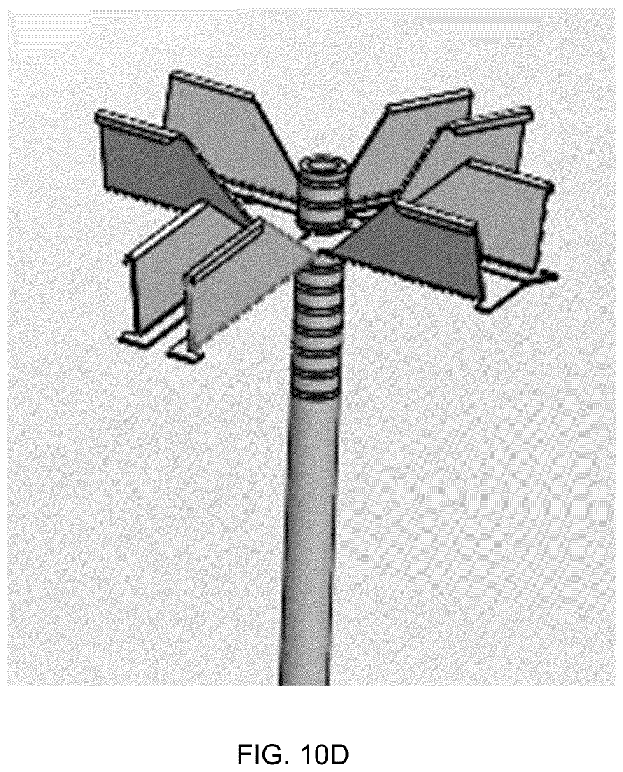

FIG. 10 shows main tolerances of concern for a solar array installation, in accordance with some embodiments. In some cases, spacing between posts and/or angles of solar modules may be adjusted along a row, such that the solar array can be positioned or aligned in a desired orientation. FIG. 10 also shows a tilt axis angular alignment, in accordance with some embodiments. In some cases, the angular orientation of the solar modules may be fixed or movable. In some cases, the solar modules may have a dual tilt angle. In some embodiments, the solar module array comprises a dual tilt array. FIG. 10 further shows ground mount installation on a slope, in accordance with some embodiments. In some cases, a tracker may adjust an angle of a solar module from at least about 1° to about 10° or more in addition to the angle of the slope.

FIG. 10B shows a side perspective view indicating the impact of uneven terrain upon installation, in accordance with some embodiments. FIG. 10C is an enlarged view showing the ability of the components of some embodiments disclosed herein, which may rotate relative to each other in order to accommodate tolerances.

While some embodiments have shown a post with the ground end having a sawtooth pattern, this is not required. Alternative embodiments may utilize posts in the form of ground screws. In some embodiments, the post may comprise two sections, with a screw portion going in first, and a top portion (allowing vertical adjustment) attached to the screw portion.

FIG. 10D shows a perspective view of an alternative embodiment featuring a ground screw: In some cases, a four way clip can be retained by standard retaining rings that snap into grooves on the post. In some cases, the vertical tolerances can be accommodated by having multiple grooves. In some cases, angular tolerances can be accommodated by oversizing the hole. In some cases, a component can withstand at least about 10 lbs. 20 lbs. 30 lbs. 40 lbs. 50 lbs. 100 lbs. 200 lbs. 300 lbs. 400 lbs. 500 lbs. or more of uplift at a corner area.

FIG. 10A shows a perspective view where a clip that has been clinched in place onto a post tab (e.g., using a tool of an installation machine), has rotated substantially to accommodate tolerances. In some cases, clinching may be performed in situ (e.g., when the module makes contact with the post tab), which may lock in the position of the solar module while accommodating for some additional flexibility. According to some embodiments, a clinching tool may perform at least 2 punches (e.g., 800 lbs shear/400 lbs peel) for the full joint.

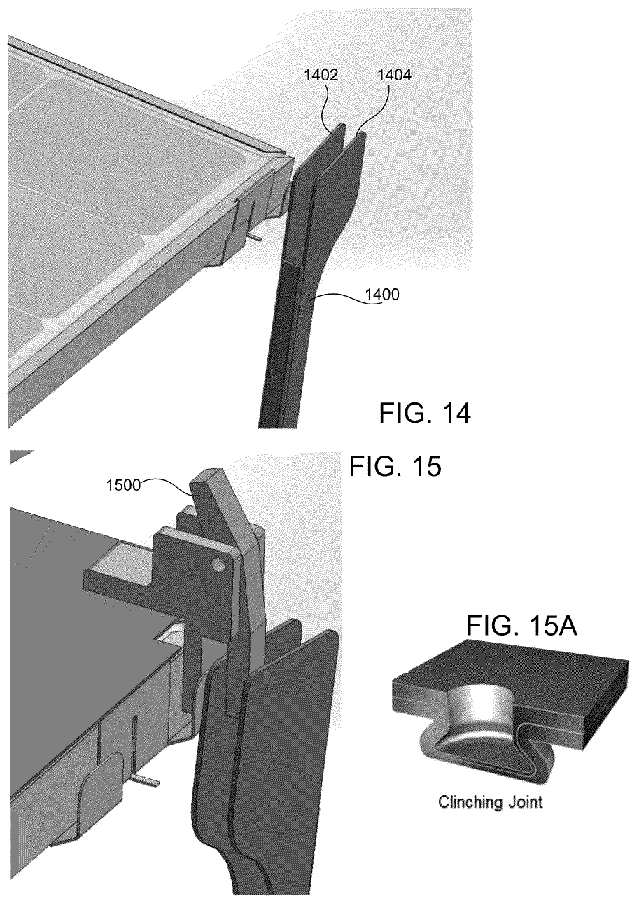

FIG. 14 is a simplified perspective view showing an embodiment of a clip/module assembly, adjacent to an alternative embodiment of a post. The post 1400 may comprise two opposing large tabs 1402 and 1404 at the top, which provide large faces for the clips to be clinched against. FIG. 15 is a simplified view showing a clinching tool 1500 that can be used to clinch together the clip to a face of the post, in accordance with some embodiments. FIG. 15A shows a simplified view of a resulting clinching joint, in accordance with some embodiments. FIG. 15B shows a view of a post according to an alternative embodiment. With two large tabs at the top, faces of large areas may be provided to clinch with the clips. FIG. 15C shows fabricated posts maintained in a bandoliered structure after progressive stamping, in accordance with some embodiments.

The clips and clinching operations disclosed herein may permit the forming of a joint from two or more plates that overlap at least partially. The plates may not or need not be parallel to each other, and in fact can be angled relative to each other (e.g., depending on the terrain or the spatial configuration of other components associated with the solar modules or the supporting structures for such modules). The plates may be provided in different positions or orientations relative to each other, and can be deformed uniquely to accommodate a wide range of angular or positional variations for the plates, the posts, the surrounding terrain, or the positioning of any solar modules relative to the plates or the posts. The presently disclosed systems and methods may permit wide tolerances in the way that a joint is shaped or formed, to simplify the installation process and provide additional flexibility in how various components or systems are assembled relative to each other, without comprising structural integrity. The wide tolerances may also permit the installation of posts and solar modules without the need to precisely fine tune the positions, the orientations, and/or the relative alignment of the posts or solar modules, especially when said posts or solar modules are installed on uneven terrain with changing contours.

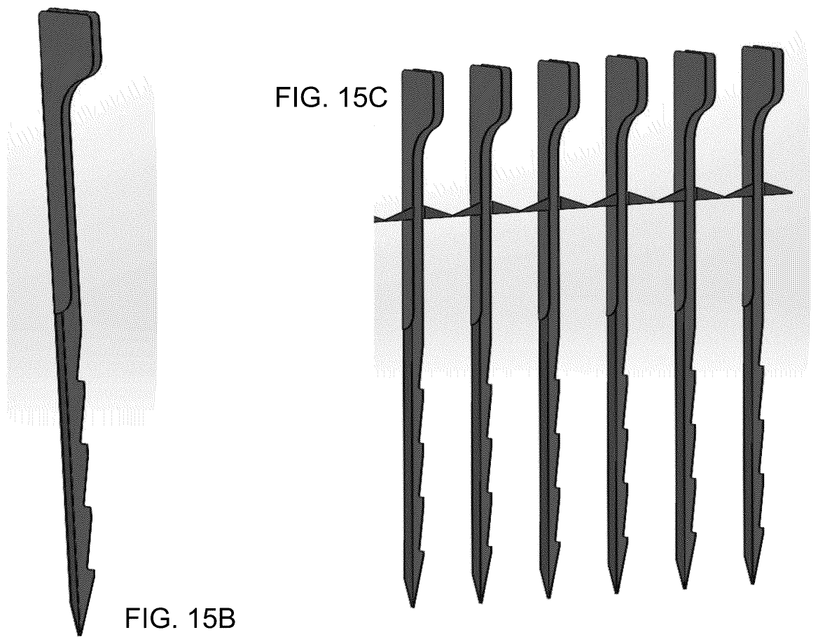

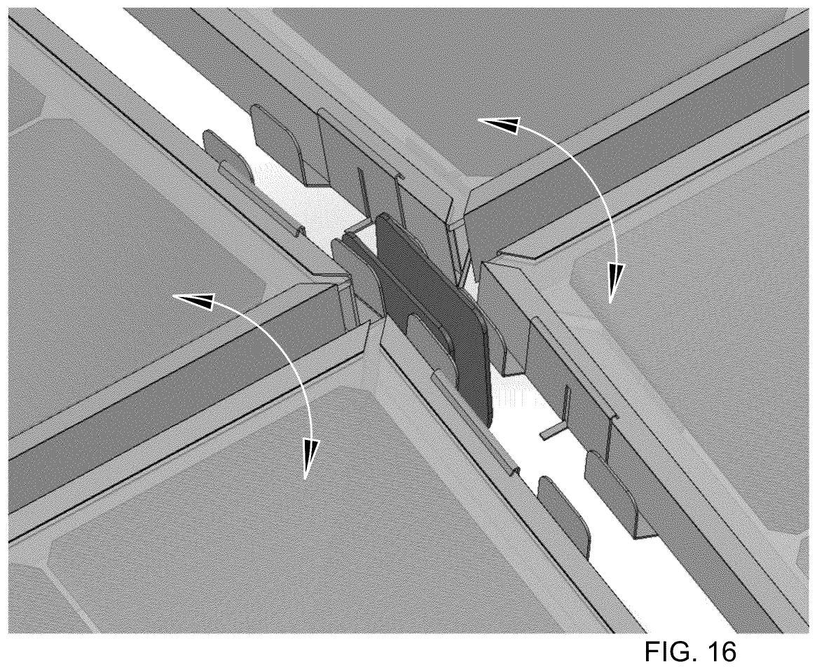

FIG. 16 is a simplified view showing a corner of four modules that join to one post, in accordance with some embodiments. This view illustrates the reversibility of the clips, and also demonstrates the angular tolerance of the clips relative to the post to accommodate tilt angle.

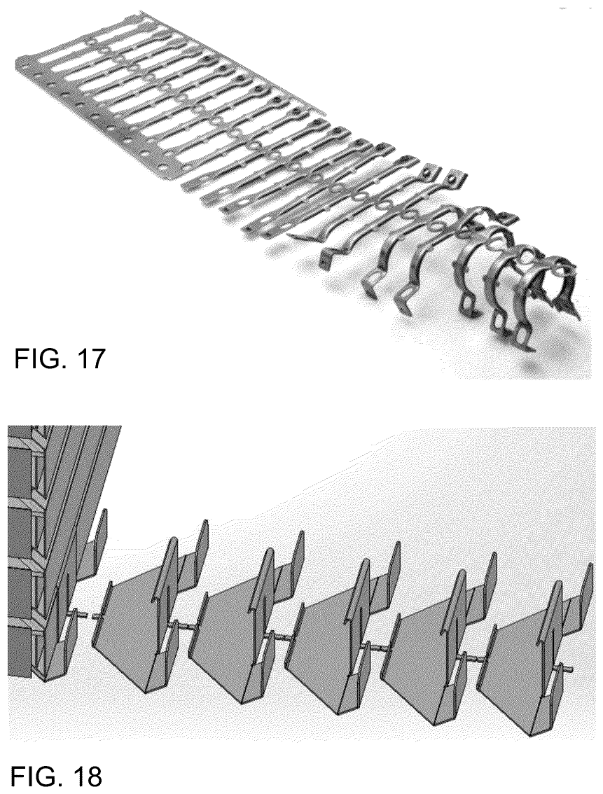

FIG. 17 shows a progressive stamping manufacturing process that can be used to fabricate the clip, in accordance with some embodiments. FIG. 18 shows how the clip can maintain its connected orientation in an integrated bandolier configuration after it is formed, in accordance with some embodiments.

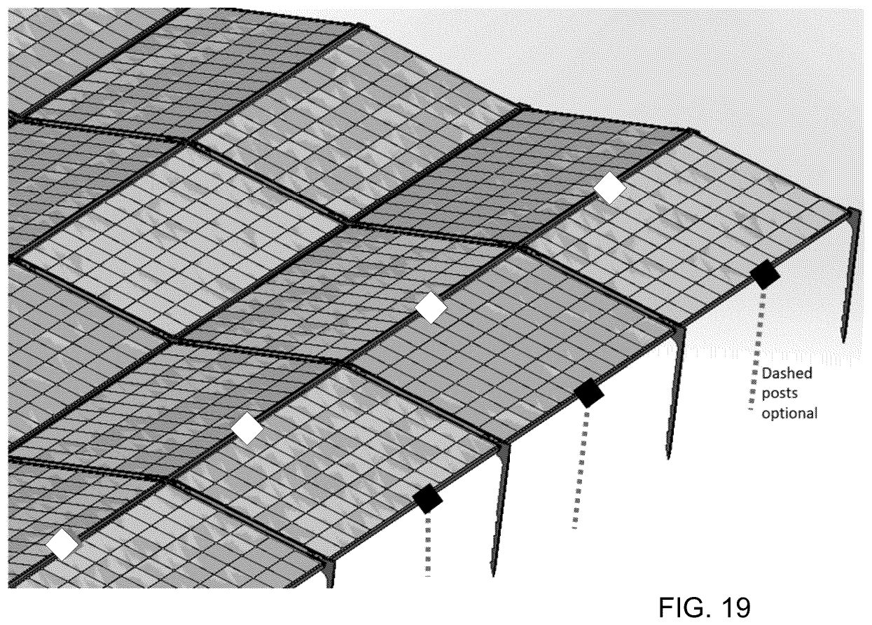

FIG. 19 shows another alternative embodiment of a ground mounting system for solar modules. In some cases, in the event of heavy loading additional clip(s) can be installed on the ridge of two modules (open square) and/or the lower confluence point of point of modules (solid square). These additional clips may connect two neighboring modules. Such additional-clip configurations may (but are not required to) also include a post (dashed) that can be pushed into the ground.

According to some embodiments, the clip may be pre-installed on a post in the factory. The retaining rings described herein may be installed in the factory ahead of time. This may leave enough vertical tolerance for penetration variability of the post. In some embodiments, this can permit around 1 inch of vertical play, thereby facilitating installation and adding flexibility under applied loads.

FIG. 11 shows an enlarged perspective view of the gaps between adjacent modules, in accordance with some embodiments. In some cases, the gaps may be sized according to tolerance availability and to allow tool access. Particular embodiments may feature gaps of around 2″ on one side of the module, with gaps on the orthogonal side of the module being smaller.

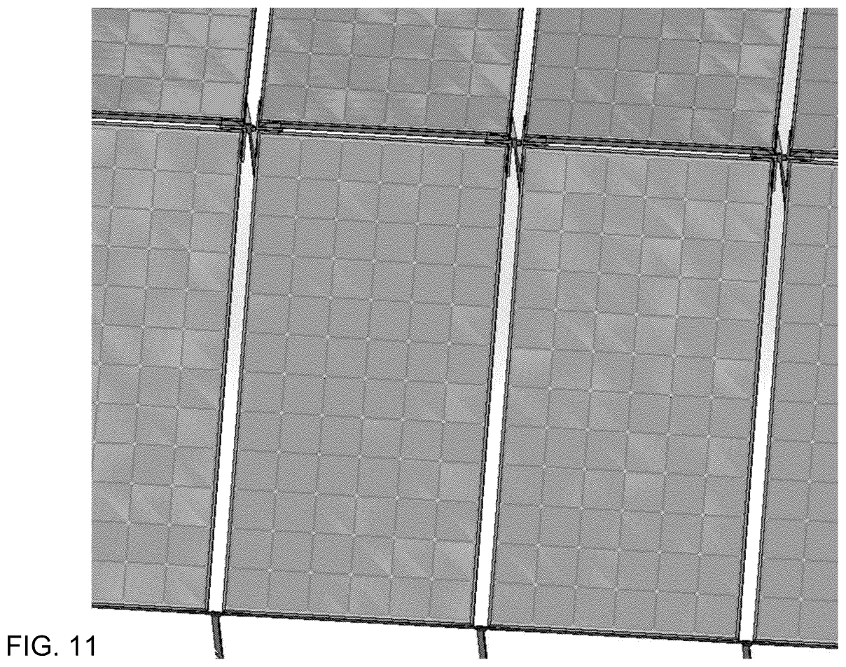

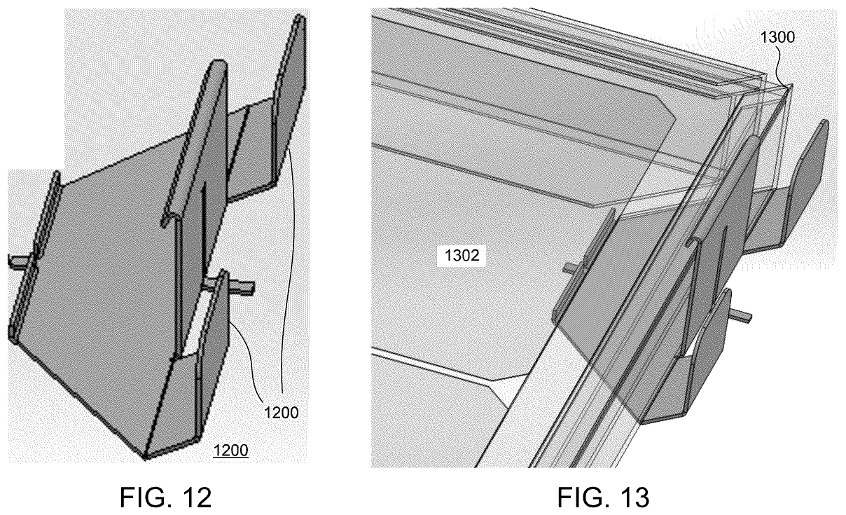

While the preceding figures have illustrated one particular embodiment of a ground mount system for solar panels, other embodiments are possible. For example, FIG. 12 shows a simplified view of an alternative clip structure 1200, in accordance with some embodiments. Here, the clip may comprise flexible tabs 1202, and may be reversible. FIG. 13 is a simplified view showing the clip embodiment of FIG. 12, attached to the side of a frame 1300 of a solar module 1302. In some cases, the clip may be configured to engage on both the top and bottom of the module via multiple tabs.

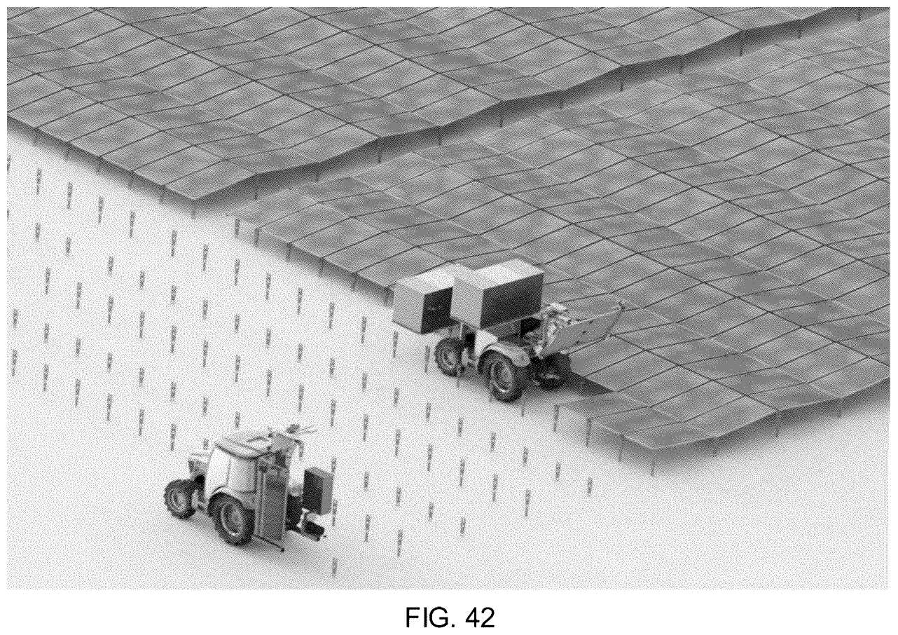

FIG. 42 shows an overhead view of an autonomous system for positioning and assembling solar modules, in accordance with some embodiments. In some cases, the system may be configured to unbox, inspect, and/or process the solar modules with or without attachments before transporting around a site.

In some cases, the system may comprise one or more post installers. The post installers may drive posts and continuously reload from factor bundled packs. In some cases, posts may be installed by a custom machine on the back of a vehicle (e.g., a tractor). The vehicle may comprise an autonomous or semi-autonomous vehicle.

In some cases, the system may comprise one or more module installers. The module installers may pull a solar module from a stack and attach them to one or more deployed posts. In some cases, a module may be installed on a previously installed post by a machine on the back of a different vehicle (e.g., a different tractor). The vehicle may comprise an autonomous or semi-autonomous vehicle.

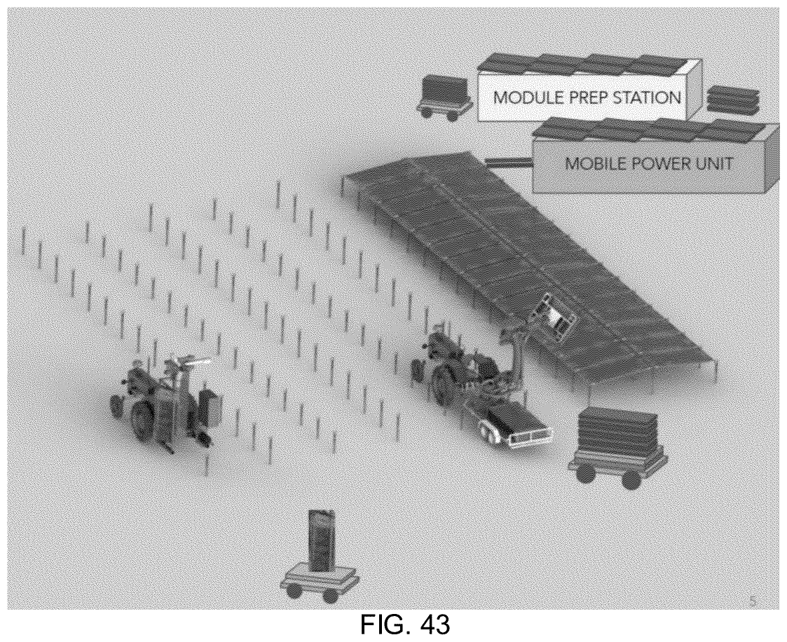

FIG. 43 shows an overhead view of an autonomous system for positioning and assembling solar modules, in accordance with some embodiments. In some cases, the vehicles for deploying posts or solar modules may be fully electric. In some cases, a mobile power unit may be disposed at or near a site where the vehicles may charge. In some cases, the mobile power unit may comprise one or more solar panels and/or batteries. In some cases, a reloading unit may travel between stations. In some cases, a reloading unit may carry posts, solar modules, or any combination thereof. In some cases, a reloading unit may travel between a prep station and active installer units (e.g., the autonomous vehicles or robots described elsewhere herein).

In another aspect, the present disclosure provides a method comprising providing one or more mobile platforms that are configured to carry a plurality of posts and a plurality of solar modules. The mobile platforms may comprise any of the robots, machines, or autonomous vehicles described herein.

In some embodiments, a plurality of posts may be positioned and installed by a first mobile platform at a predefined configuration onto the terrain. In some embodiments, a plurality of solar modules may be deployed onto a set of posts by a second mobile platform.

In some cases, the one or more mobile platforms can be equipped with one or more sensors. The one or more sensors may comprise, for example, a location sensor (e.g., a geolocation sensor), a vision sensor (e.g., image sensor or a camera), a GNSS unit, a GPS unit, an accelerometer, a motion sensor, a gyroscope, or any combination thereof. In some cases, the one or more sensors may comprise a stereo vision sensor, a depth sensor, a binocular vision sensor, or an infrared sensor. In some cases, the one or more sensors may comprise a radar unit, a LIDAR unit, an altitude sensor, a proximity sensor, an inertial measurement unit, a contact sensor, a pressure sensor, a piezoelectric sensor, or a force sensor.

In some embodiments, the method may further comprise using at least the one or more sensors to (i) autonomously move the one or more mobile platforms and (ii) autonomously position and assemble the plurality of posts and the plurality of solar modules over a terrain to construct an array of solar modules. In some embodiments, the method may further comprise using the one or more sensors to locate and move an installer load head on the one or more mobile platforms relative to the array of solar modules as the array is being constructed. The installer load head may comprise a movable element that can automatically position and/or deploy one or more posts into a target location.

In some embodiments, the one or more mobile platforms may comprise a first platform for positioning and installing the plurality of posts onto the terrain, and a second platform for positioning and assembling the plurality of solar modules onto the plurality of posts. In some embodiments, the first platform can be separate from the second platform. In some embodiments, the first platform and the second platform may be integrated into a single platform. In some embodiments, the one or more mobile platforms may comprise one or more electric vehicles.

In some embodiments, the plurality of solar modules may be pre-stacked on the second platform, and the second platform may comprise a mechanism for extracting a select solar module from the stack and assembling the select solar module onto a select set of posts that have been installed on the terrain.

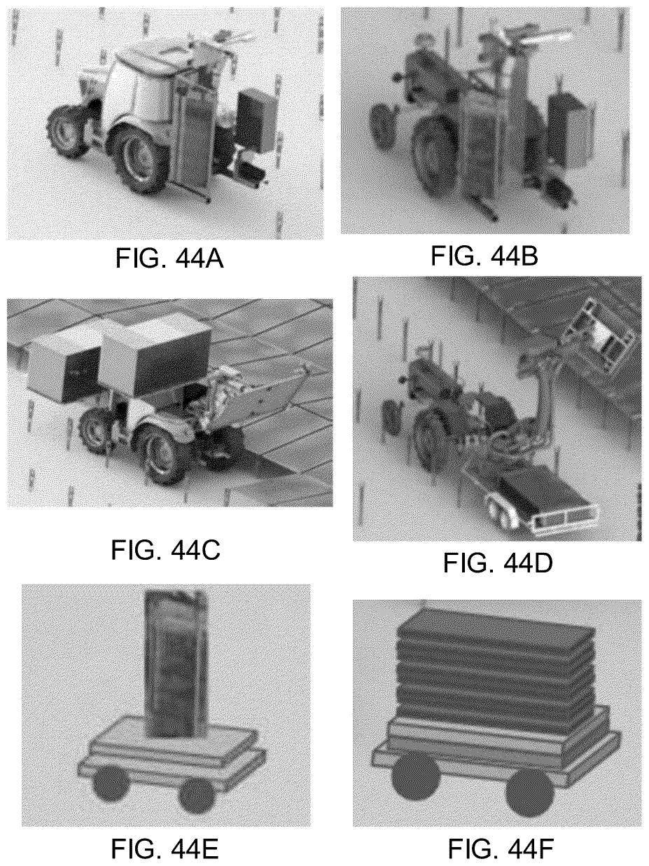

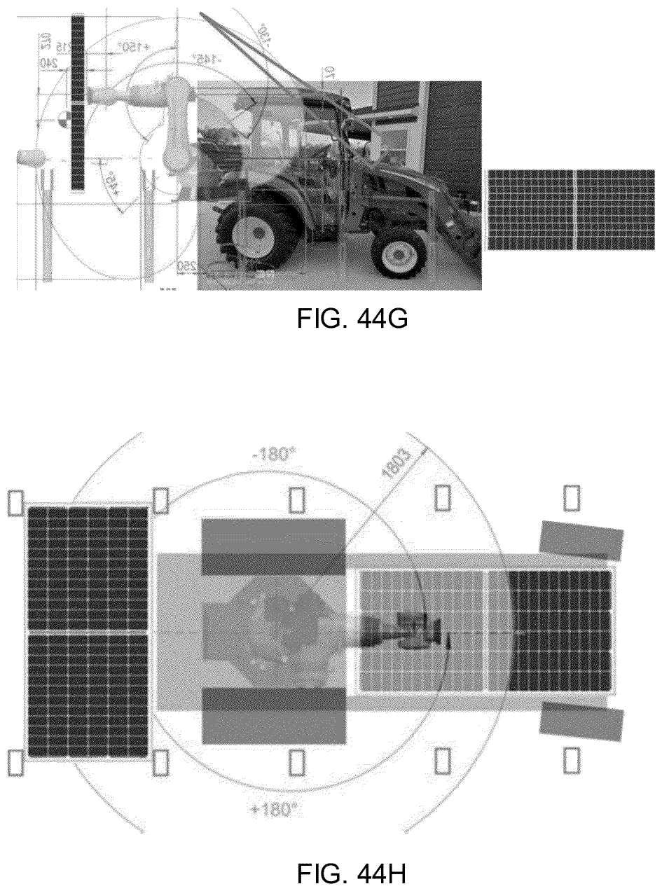

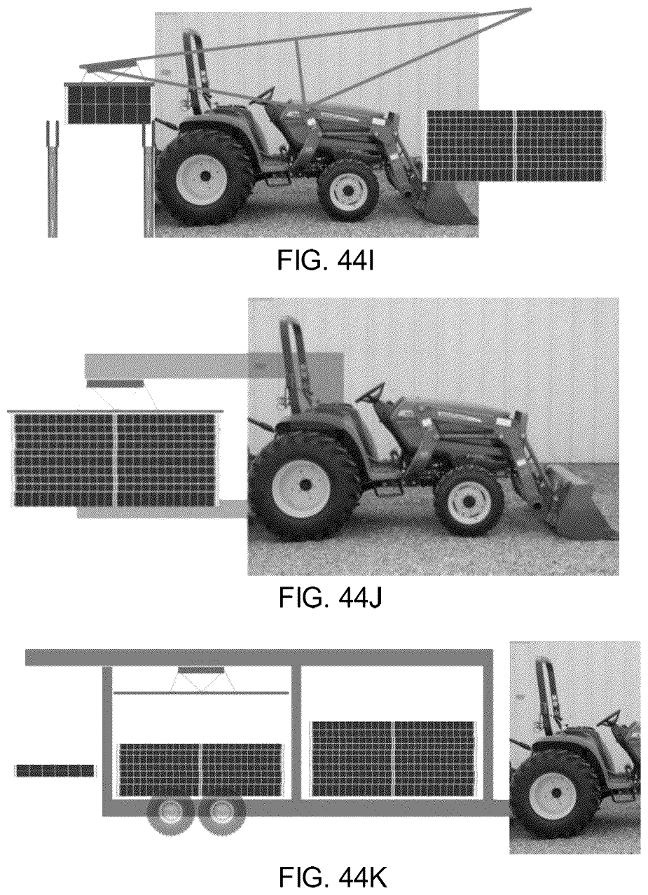

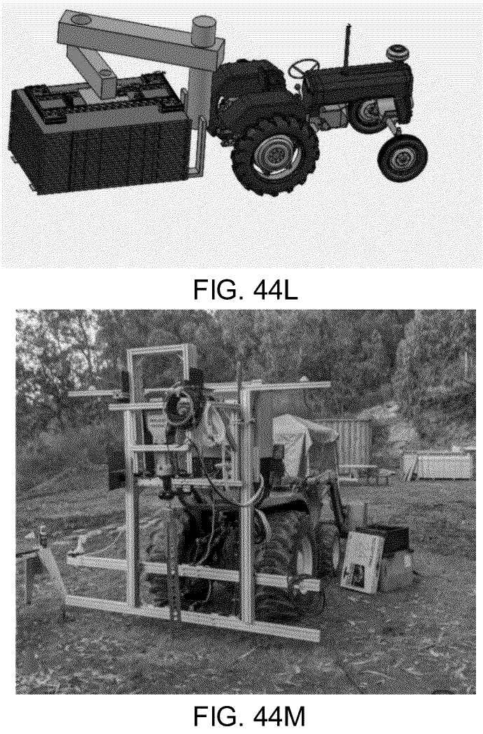

FIGS. 44A-44M show vehicles for positioning and assembling solar modules, in accordance with some embodiments. In some cases, a module installer may be a custom machine built on a vehicle. In some cases, a module installer may take in a stack of solar modules. In some cases, the stack of solar modules may be placed on the module installer. In some cases, the stack of solar modules may be picked up by the module installer. In some cases, the module installer may carry the stack of modules. In some case, the module installer may separate one module from the stack of modules. In some cases, the module installer may position the one module over a plurality of installed posts, for example, two, three, or four installed posts. In some cases, the module installer may lower the module into a predetermined position over the plurality of installed posts.

In some cases, the module installer may deform a metallic portion of a module to create a rigid connection between the module and the post. In some cases, the module installer may release the module. In some cases, the module installer may test a strength of connections formed between the module and the plurality of posts by lifting, pushing, twisting, or any sufficient force.

In some cases, the module installer may drive to a next location to place a module. In some cases, a module installer may comprise 3, 4, 5, or 6 degrees of motion or more. In some cases, a module installer may comprise a robot arm that is configured to receive a module from a flipping machine. In some cases, a robot arm may be used to reach for and pick up a module from a stack. In some cases, a gantry may be used to tilt back and forth to pick up a module and position the module behind. In some cases, a double rotary motion manipulator comprising one or more rotating joints may be used to position a module above one or more posts. In some cases, a gantry may be used to pick up and position one or more modules onto one or more installed posts.

In some embodiments, an integrated clinching tool may be provided on an installer load head to create a plurality of post-clip interfaces between a plurality of clips and the plurality of posts. In some cases, the plurality of clips may be pre-attached to the plurality of solar modules.

In some embodiments, the post-clip interfaces include a substantially non flat surface such that the angle between the module and the post can be variable.

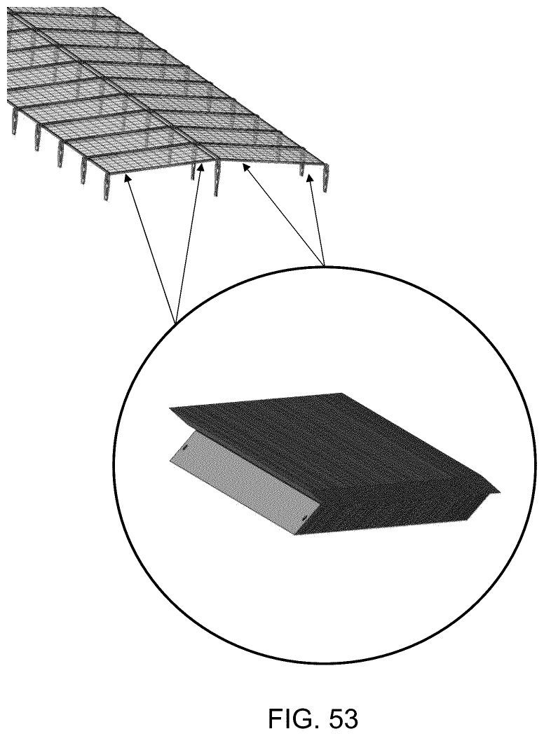

FIG. 53 illustrates a plurality of brackets that can be coupled to a post, in accordance with some embodiments. In some cases, a solar module may comprise a bracket. The bracket may be attached or coupled to the solar module. In some cases, the bracket may comprise a deformable metal. The deformable metal may comprise, for example, aluminum, copper, iron, steel, brass, or any metallic alloys. In some cases, a connection may be formed between the bracket and a post. In some cases, the connection may be formed by clinching the bracket and the post together. In some cases, the bracket may comprise a flat or an angled piece of metal that is configured to rivet onto a module, for example, through mounting holes. In some cases, the bracket may be connected to a module by clinching the bracket to the frame of a module. In one alternative embodiment, the module clip can be clinched or dimpled to the solar module frame directly instead of being riveted or bolted through mounting holes.

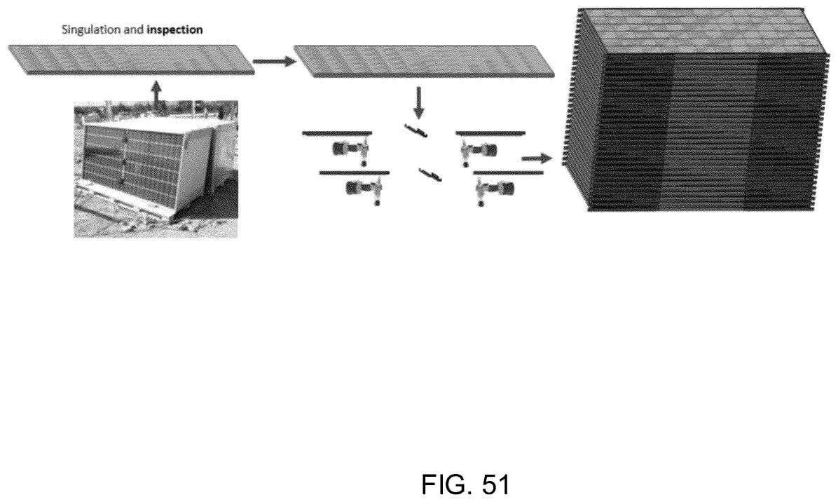

FIG. 51 illustrates a method for coupling a solar module and brackets, in accordance with some embodiments. In some cases, a bracket may be installed by a process in a station where modules are unboxed, inspected, and/or then placed on a tooling jig. In some cases, 1, 2, 3, 4, or more rivet guns may install rivets to join a bracket to a solar module from below; side, top, or any sufficient direction. The use of rivets may obviate the need for preformed holes with accurate tolerances. In some cases, a clinching tool or an impact driver (e.g., for torquing nuts) may be used instead of a rivet gun.

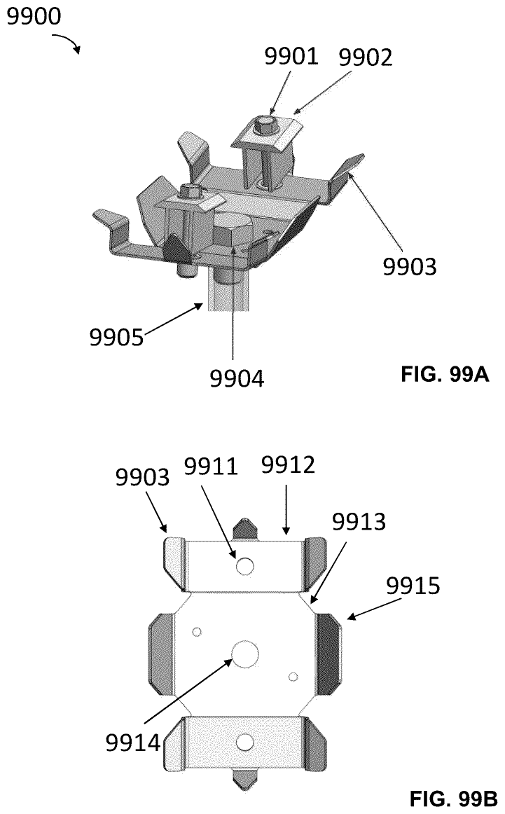

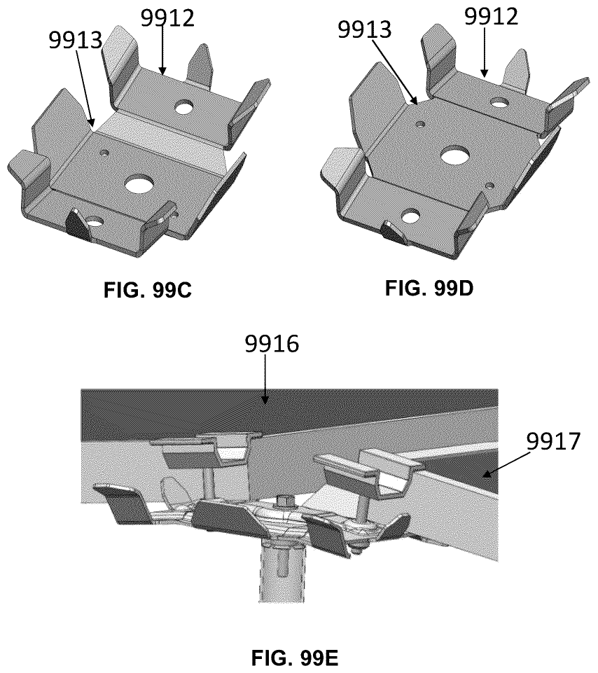

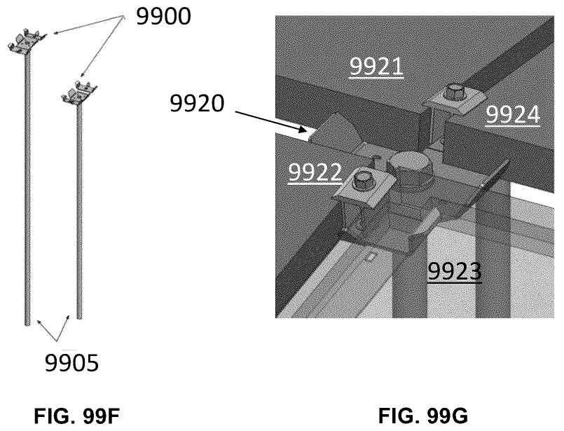

FIG. 99A shows an exemplary post-module interface, e.g., a bracket for coupling a post and solar modules. The bracket 9900 comprises a bolt 9904 to secure/connect the bracket 9900 to the post 9905. In some embodiments, the bolt can self tap into a cavity of the post without the need for cutting threads on the post. In some embodiments, the post-module interface, e.g., the bracket is pressed on the post without the use of a fastener. In some embodiments, the post can comprise threads for the coupling of bracket to the post. In some embodiments, the threads are pre-installed onto the post.

The bracket 9900 can comprise one or two clamps 9902 and one or two bolts 9901 to affix a solar module or a plurality of solar module to the bracket. The bracket 9900 can comprise a plurality of tabs 9903 to engage with and align the solar module(s). The bracket 9900 can have different configurations to be used as a corner backet, an edge bracket, or a non-corner, non-edge bracket, to hold one solar module, two solar modules, or four solar modules, respectively. For example, for a post which is configured to hold one solar module. e.g., a post at a corner of the array, the bracket can comprise one bolt 9901, one clamp 9902, and one tab 9903. For a post which is configured to hold four solar modules, the bracket can comprise two bolts, two clamps, and four tabs to hold the four solar modules. In some embodiments, a clamp is not required. In some embodiments, a bracket can comprise a fasternerless clip to secure a solar module. In some embodiments, the solar modules are clipped onto the bracket without the need for a fastener.

FIG. 99B shows a top view of the bracket 9900 before the bolts and clamps are coupled to the bracket. The bracket 9900 comprises a base plate 9913. The base plate 9913 comprises a hole 9914 for the bolt 9904 (see FIG. 99A) to secure the bracket to the post. The base plate 9913 can comprise a pair of flanges 9915 configured to prevent the sliding or moving of the solar module upon installation. The bracket 9900 comprises a side plate 9912. The side plate 9912 comprises a hole 9911 for the bolt 9901 (see FIG. 99A) to secure the clamp 9902 and solar module. The side plate 9912 further comprises tabs 9903 to engage with and align solar module(s). In some embodiments, the base plate and the side plate of the bracket are substantially on the same surface. In some embodiments, the plate surface of the bracket is not flat. In some embodiments, the base plate and the side plate of the bracket are arranged in an angle. In some embodiments, the angle can be from ( ) to 30°. In some embodiments, the base plate can be in a valley configuration relative to the side plate (FIG. 99C). In some embodiments, the base plate can be in a ridge configuration relative to the side plate (FIG. 99D). The angled arrangement of the base plate and side plate provides capability for the solar modules to be installed in tilted arrangement. FIG. 99E shows two adjacent solar modules 9916 and 9917 that are not on the same flat surface.

In some embodiments, the solar modules are clamped to the non flat plate surface of the bracket. In some embodiments, the clamp is bolted to the non flat plate surface of the bracket.

In some embodiments, the post-module interface is formed by an autonomous machine. In some embodiments, the module can be positioned on the plate by an autonomous machine.

In some embodiments, the bracket has a protrusion to provide electrical grounding.

FIG. 99F shows the coupled bracket 9900 with posts 9905.

FIG. 99G shows an exemplary assembly of a post, a bracket, and solar modules. A bracket 9920 is bolted to a post and four solar modules 9921-9924 are secured to the bracket 9920.

In some embodiments, the bracket allows for installation of solar modules at angular misalignments. In some embodiments, the tabs on the bracket are bendable. In some embodiments, the tabs on the bracket are deformable. When the solar module is installed, the tabs can be bent or deformed to accommodate the rotation or tilt of the solar module between two adjacent posts.

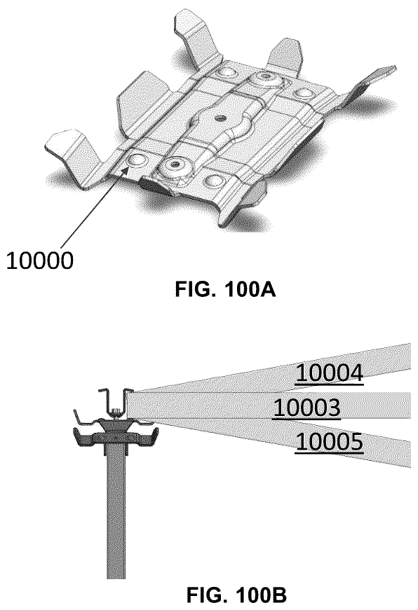

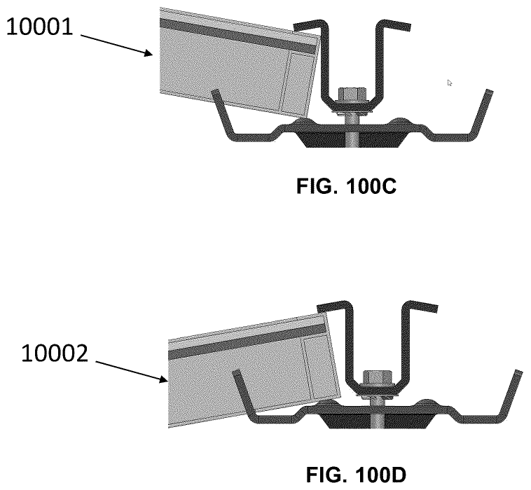

In some embodiments, the bracket comprises a non-flat pivot feature that allows the solar module to articulate at angles while being connected and held in place on the bracket. FIG. 100A shows a non-flat pivot feature 10000 of a bracket. FIG. 100B shows a solar module with no tilt (10003), tilted with a positive angle (10004) and tilted with a negative angle (10005) when the solar module is coupled to the bracket with the non-flat pivot feature. FIG. 100C shows an enlarged view of a solar module 10001 tilted at a positive angle relative to a flat surface. FIG. 100D shows an enlarged view of a solar module 10002 tilted at a negative angle relative to a flat surface. In some embodiments, the angle can be from ( ) to 30°. In some embodiments, the angle can be 11.5°.

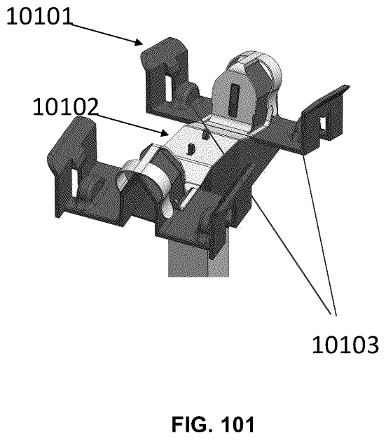

In some embodiments, the bracket may comprise a deformable metal. The deformable metal may comprise, for example, aluminum, copper, iron, steel, brass, or any metallic alloys. In some embodiments, the bracket can comprise plastic material or enforced plastics. The plastic material can comprise high density polyethylene, polyphenylene sulfide, nylon, polyetheretherketone, polyetherimide, or polyamideimide. In some embodiments, at least a part of the bracket comprises a plastic material while the remaining parts are made of metallic material, e.g., for electric grounding and spring. FIG. 101 shows an exemplary bracket comprising plastic material and metallic material. The base plate 10102 is made of metallic material while the tabs 10101 are made of plastic material. The bracket further comprises non-flat pivot feature 10103 to accommodate the tilting of solar module(s).

In some embodiments, the method may further comprise assessing a structural integrity of the post-clip interfaces using at least one of a measured force or a deflection during and/or after installation of the solar modules onto the posts. In some cases, the structural integrity of the post-clip interfaces may be assessed by testing separation force, resistance to shear forces due to translational or rotational motions, and/or resistance to pull forces.

In some embodiments, the method may further comprise obtaining images of the plurality of post-clip interfaces during or after the interfaces have been formed. In some embodiments, the method may further comprise determining a structural integrity of each of the plurality of post-clip interfaces based at least on one or more of the images.

In some embodiments, the method may further comprise using a testing tool located on the one or more mobile platforms to perform pull strength and assembly tests on one or more of the plurality of installed posts. In some cases, the testing tool may be used to apply pushing, pulling, twisting, vibration, or any appropriate force to an installed post and/or an installed solar module to test the mechanical strength, stability, and/or rigidity of an installation.

In some cases, the method may further comprise using a testing tool located on the one or more mobile platforms to perform electrical testing on one or more solar modules. In some cases, the electrical testing may comprise testing a voltage, current, connectivity, and any appropriate electrical measurements to ensure proper installation of the solar modules.

In another aspect, the present disclosure provides a method for constructing an array of solar modules. The method may comprise providing a plurality of posts and a plurality of solar modules. In some cases, the plurality of solar modules may comprise a plurality of clips pre-attached thereon. In some embodiments, the method may comprise using one or more mobile platforms to autonomously position and assemble the plurality of posts and the plurality of solar modules over the terrain to construct the array of solar modules.

In some embodiments, the method may comprise forming a plurality of post-clip interfaces between a plurality of clips and the plurality of posts to construct an array of solar modules over a terrain without requiring one or more premade holes/features for one or more fasteners. In some embodiments, the plurality of post-clip interfaces may have tolerances that enable the array to contour to the terrain, thereby eliminating a need for grading of the terrain. In some embodiments, the plurality of post-clip interfaces may comprise a plurality of clinched joints. In some embodiments, the plurality of clinched joints can be formed by a dimpling process. In some embodiments, each of the plurality of posts may comprise one or more tabs. In some cases, the dimpling process may comprise joining the one or more tabs to a corresponding clip to form the plurality of clinched joints. In some embodiments, the method may further comprise adding the one or more fasteners to the post-clip interfaces after or during the dimpling process.

In some cases, the plurality of post-clip interfaces can be formed at one or more corners of the plurality of solar modules. In some cases, the plurality of post-clip interfaces can be formed at all corners of the plurality of solar modules. In some cases, the plurality of post-clip interfaces can be formed at opposite corners of the plurality of solar modules. In some cases, the plurality of post-clip interfaces can be formed at one or more lateral sides of the plurality of solar modules. In some cases, the plurality of post-clip interfaces can be formed at all lateral sides of the plurality of solar modules. In some cases, the plurality of post-clip interfaces can be formed at opposite lateral sides of the plurality of solar modules.

In some cases, the plurality of post-clip interfaces can be formed by using a clinching tool that is located on a post installer load head. In some cases, the post installer load head may be located on one or more mobile platforms that are configured to carry the plurality of posts and the plurality of solar modules.

In some embodiments, the plurality of post-clip interfaces can be formed without requiring the one or more fasteners. In some embodiments, the plurality of post-clip interfaces can be formed by locating the one or more fasteners in position relative to each clip and a corresponding tab on each post, and piercing the one or more fasteners through the tab to fasten the tab onto the clip, or piercing the one or more fasteners through the clip to fasten the clip onto the tab.

In some embodiments, the presently disclosed methods may comprise using a movable tool to form a plurality of holes in-situ on at least the clips on the solar modules and/or tabs on the posts. In some embodiments, the presently disclosed method may comprise using the movable tool or another tool to install the one or more fasteners through the plurality of holes formed in-situ on the clips and/or tabs.

In another aspect, the present disclosure provides an algorithm for facilitating the deployment of a solar module. In some embodiments, the method may comprise using an algorithm to identify a location suitable for autonomous positioning and assembly of at least one solar module, without requiring aid or involvement from a user in the autonomous positioning and assembly of the at least one solar module.

In some embodiments, the algorithm comprises a machine learning (ML) algorithm. In some cases, the machine learning algorithm may comprise a neural network. Examples of neural networks can include, for instance, a deep neural network (DNN), a convolutional neural network (CNN), a recurrent neural network (RNN), and/or a generative adversarial network (GAN).

In some embodiments, the machine learning algorithm may comprise a deep neural network (DNN). In other embodiments, the deep neural network may comprise a convolutional neural network (CNN). The CNN may be, for example, U-Net, ImageNet, LeNet-5, AlexNet, ZFNet, GoogleNet, VGGNet, ResNet18, or ResNet, etc. In some cases, the neural network may comprise or utilize, for example, a deep feed forward neural network, a recurrent neural network (RNN), LSTM (Long Short Term Memory), GRUs (Gated Recurrent Units), autoencoders (e.g., variational autoencoders, adversarial autoencoders, denoising autoencoders, or sparse autoencoders), a Boltzmann machine (BM), a RBM (Restricted BM), a deep belief network, a generative adversarial network (GAN), a deep residual network, a capsule network, or one or more attention/transformer networks. In some embodiments, the neural network may comprise a plurality of neural network layers. In some cases, the neural network may have at least about 2 to 1000 or more neural network layers.

In some cases, the machine learning algorithm may comprise a support vector machine (SVM), a classification algorithm, a regression analysis algorithm, or any other type of supervised, semi-supervised, or unsupervised machine learning algorithm. In some embodiments, the supervised learning algorithm may comprise or utilize, for example, support vector machine algorithms, linear regression algorithms, logistic regression algorithms, linear discriminant analysis algorithms, k-nearest neighbor algorithms, similarity learning, or any combination thereof. In some embodiments, the unsupervised learning algorithm may comprise, for example, clustering algorithms, hierarchical clustering algorithms, k-means clustering algorithms, mixture models, anomaly detection, local outlier factor algorithms, autoencoders, deep belief networks. Hebbian learning, self-organizing maps, expectation-maximization algorithms (EM), principal component analysis algorithms, independent component analysis algorithms, non-negative matrix factorization, singular value decomposition, or any combination thereof. In some cases, the machine learning algorithm may comprise or utilize a random forest, a decision tree (e.g., a boosted decision tree), a classification tree, a regression tree, a bagging tree, or a rotation forest.

In some embodiments, the algorithm may be configured to identify the location for deploying one or more solar modules and/or posts based at least on an analysis of terrain data. In some embodiments, the terrain data is obtained using at least one of aerial imaging or Global navigation satellite systems (GNSS).

In some embodiments, the method may further comprise creating a set of executable instructions in a digital medium for an autonomous system to autonomously position, deploy, install, and/or assemble the at least one solar module to construct a solar module array. In some embodiments, the autonomous system comprises a plurality of field machines that are in operative communication via a network. In some embodiments, the plurality of field machines comprises one or more robots. In some embodiments, the method may further comprise creating a set of executable instructions in a digital medium for an autonomous system to autonomously position, deploy, install, and/or assemble one or more posts or other supporting structures for one or more modules of a solar module array.

In some embodiments, the present disclosure provides a method for determining a location suitable for using an algorithm to identify the location suitable for autonomous positioning and assembly a post and a solar module. In some embodiments, the method further comprises creating a set of executable software instructions for controlling one or more mobile platforms to autonomously position and assemble a plurality of posts and a plurality of solar modules over a terrain to construct an array of solar modules without requiring aid or involvement from a user.

In some embodiments, the present disclosure provides a method for constructing an array of solar modules, comprising: (a) autonomously positioning a plurality of posts over a terrain; and (b) autonomously assembling a plurality of solar modules with the plurality of posts over the terrain, thereby constructing the array of solar modules, wherein the plurality of posts comprises a row of posts wherein two adjacent posts in the row of posts are each tilted toward one another, wherein a third post adjacent to the two adjacent posts is tilted away.

In some embodiments, the algorithm uses a digital representation of the design of the array. In some embodiments, the algorithm and the executable software instruction comprise a digital surface model of the terrain that can be used to determine the location.

In some embodiments, the method comprises determining the location of posts by an algorithm that uses the post-clip interface angles. In some embodiments, the method can determine the location of the posts over flat terrain, and/or substantially non flat terrain.

In some embodiments, the method comprises using a sensor to record the location of the posts or module in the digital representation.

In some embodiments, the method comprises using the algorithm to minimize a depth of the post. In some embodiments, the method comprises using the algorithm and the digital surface model to minimize the depth of the post.

In some embodiments, the algorithm can use soil properties. Soil properties can comprise the composition of the soil, the softness or hardness of the soil, the density of the soil, a moisture content of the soil, etc.

In some embodiments, the algorithm can use the array geometry and/or tolerances.

In some embodiments, the digital surface model of the terrain is updated with the measurements.

In some embodiments, a sensor can be used to modify the location of the post or module based on the measurement of a nearby post or module. In some embodiments, the sensor can comprise an optical sensor. In some embodiments, the sensor can comprise a geolocation sensor.

In some embodiments, a sensor can collect various data of the terrain. The data can be saved, transmitted, and/or displayed in a digital representation. The digital representation of the data can be used by the algorithm for simulating or modeling a design array. In some embodiments, the design array comprises design features of the posts, solar modules, interaction between the posts and the solar modules, and relationships between the posts or the solar modules and any other components of the array.

In some embodiments, a digital representation of the output of the algorithm can be exported or displayed. In some embodiments, the method further comprises providing a graphic user interface (GUI) to display an output of the algorithm. In some embodiments, the method further comprises displaying a digital representation of an output of the algorithm on the GUI.

FIG. 109 shows an example of a digital representation of the post and solar module assembly. The digital representation can be used for design, evaluation, construction, operations, and maintenance of the post and solar module system. The digital presentation can comprise a GUI interface for the display parameters, for example, number of modules, number of posts, number of inverters, total module DC, total inverter AC, and Average DC:AC ratio. The GUI interface can also comprise input information, for example, the project name, the power plant name, revision name, and revision status.

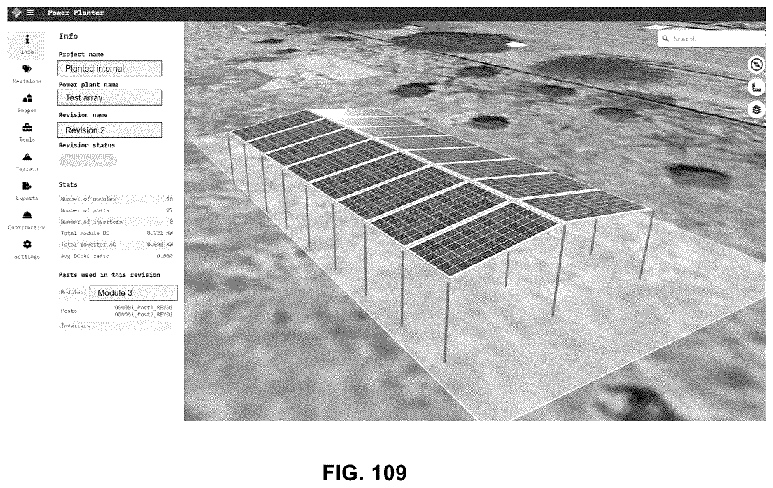

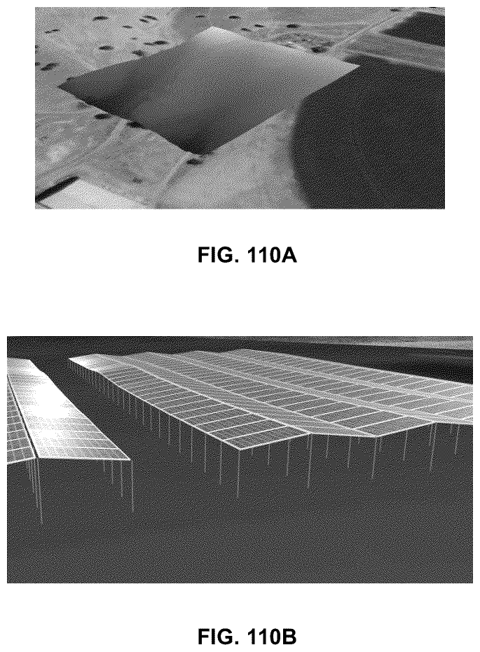

FIG. 110A shows an exemplary digital surface data. The digital surface data can be obtained based on the terrain data, for example, the surface flatness, the conditions, the soil properties, and the angles at different locations. The digital surface data can be used to evaluate precise locations of array components, e.g., the post, the solar module, and/or the racking/assembly components. FIG. 110B shows a digital representation of the predicted and/or design array components at the terrain.

FIG. 111 shows an exemplary digital representation of a design array. An algorithm can use the digital representation and the terrain surface model to calculate relationships between different array components. e.g., the module (e.g., 11104), the post (e.g., 11103), the post-module interface, and the ground. The digital representation can also show regions that are in desired specification (e.g., regions 11102) and regions that are out of desired specification (e.g., regions 11101) of the design array. In some embodiments, the digital representation can provide guidance and direction to adjust the position, orientation, configuration, and/or angle of the array components to optimize the design of the array. In some embodiments, the algorithm can be used to optimize the relative angle between the post and the ground to optimize strength. In some embodiments, the algorithm can use the location of the ground and the design of the array to determine an optimal length of the post that is embedded in the soil to maximize or minimize a parameter of interest, for example, height of post out of the ground, length of post under the ground, error tolerance to the ground, and/or post-module angle interface. In some embodiments, the algorithm can use properties of the soil that come from a soil model or from a test of the soil to determine the soil strength.

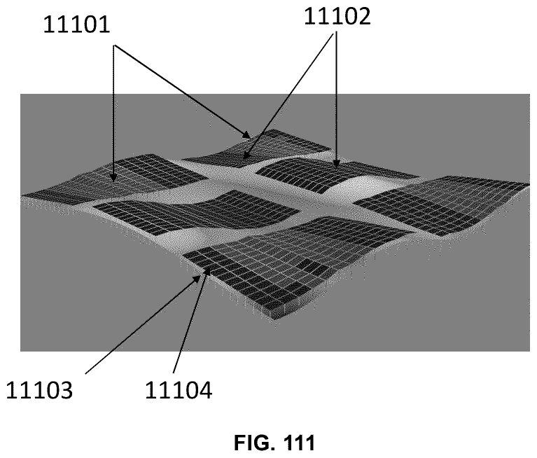

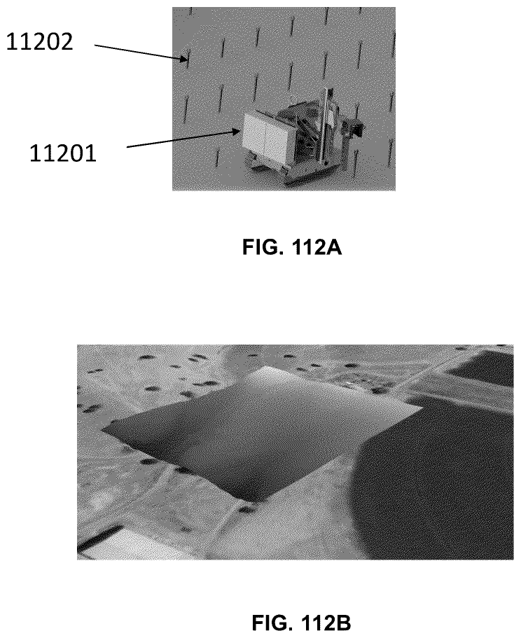

In some embodiments, during the installation of the post and/or solar module, a sensor, e.g., a geolocation sensor can be used to record data, e.g., the location of the ground, the location of the posts, the number of posts installed, the height of the post above the ground, the angles of the posts, the distance between the posts, etc. In some embodiments, the recorded data can be fed into the algorithm to update or modify the digital model, which can be further used for analysis, design, and construction of the posts and solar modules. FIG. 112A shows a sensor to record array and terrain data during the installation. A vehicle 11201 is moving over a terrain to install a plurality of posts. The vehicle 11201 may comprise a sensor to obtain data of the terrain and/or the installed posts. FIG. 112B shows an updated digital model with data from the sensor.

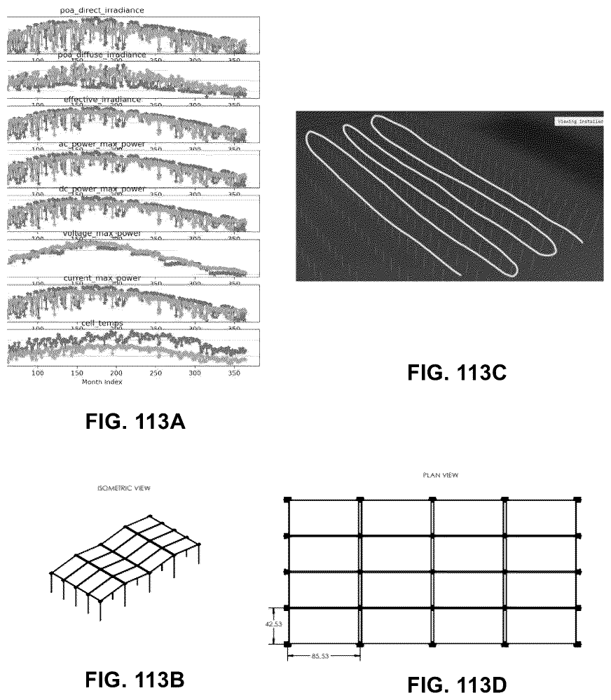

In some embodiments, the digital representation can be used to predict the electric (or electrical) power produced by the array. FIG. 113A shows example data of the calculation for electric power produced by the array. In some embodiments, the digital representation of the design array can be used to predict the cost of the array. In some embodiments, the digital representation can be used to predict the cost of the energy produced by the array.

In some embodiments, the digital representation can be used to calculate the number of the required components of the array. In some embodiments, the digital representation of the design array is used to create construction plan drawings. In some embodiments, 2D drawings can be exported from the digital representation to guide or direct the construction. FIG. 113B shows an exemplary isometric view of a design array exported from the digital representation. FIG. 113D shows an exemplary plan view of a design array exported from the digital representation. The spacing or distance of the posts, the height of the post above the ground, and/or the angle of the post-module interface can be displayed on the 2D drawings.

In some embodiments, the digital representation can be used to generate a plan and/or analysis for construction operations of the array. FIG. 113C shows an exemplary instruction path plan for an installation/construction. The lines in FIG. 113C indicates the optimized construction path plan.

In another aspect, the present disclosure provides an apparatus that is configured to: carry a plurality of posts over a terrain: autonomously position a select post from the plurality of posts at a predetermined location on the terrain; and autonomously install the select post at the predetermined location. In some cases, the select post and the plurality of posts can be useable to support a plurality of solar modules.

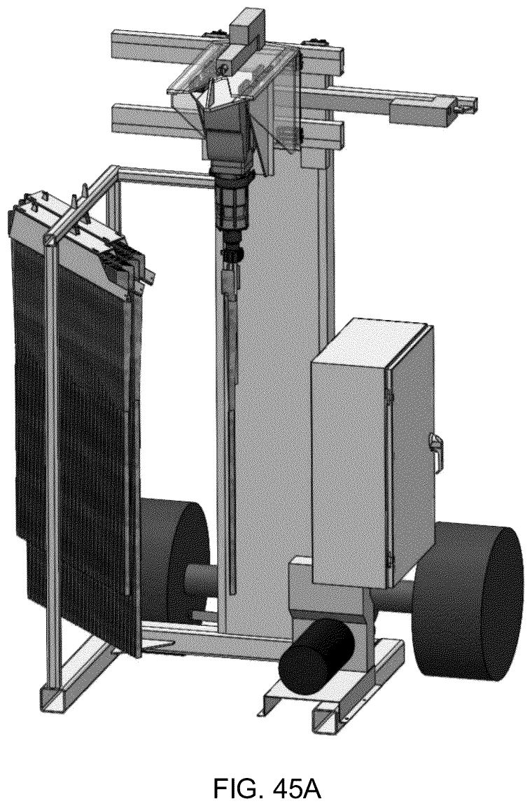

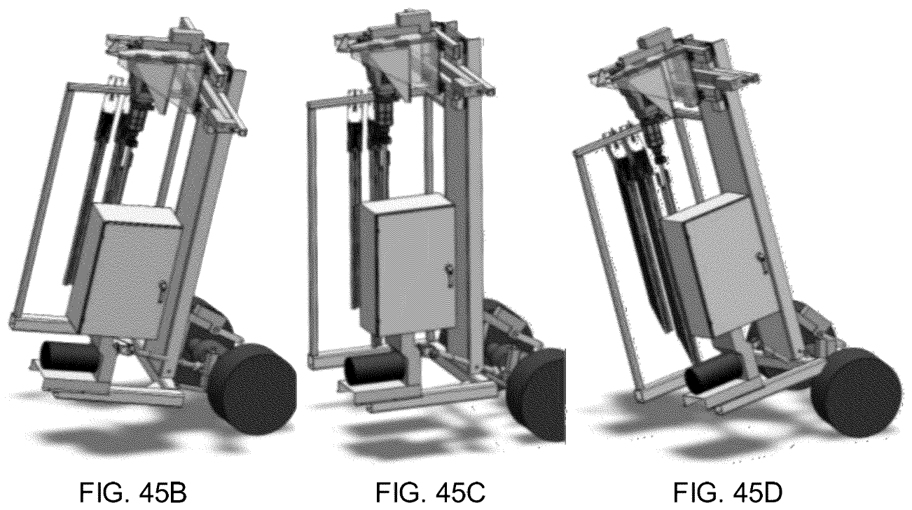

FIGS. 45A-45D show perspective views of a machine for installing posts, in accordance with some embodiments. In some cases, the machine may comprise 3, 4, 5, or 6 degrees of freedom or more. In some cases, the machine may autonomously position a post, install the post in the ground, and/or force-test the post by pulling on it laterally, vertically, or any other direction and record the force-test data. In some cases, the machine may be configured to carry one or more bundles of posts on a rack. In some cases, the machine may be configured to locate one or more posts in a bundle of posts and collect a new post on a driving bit.

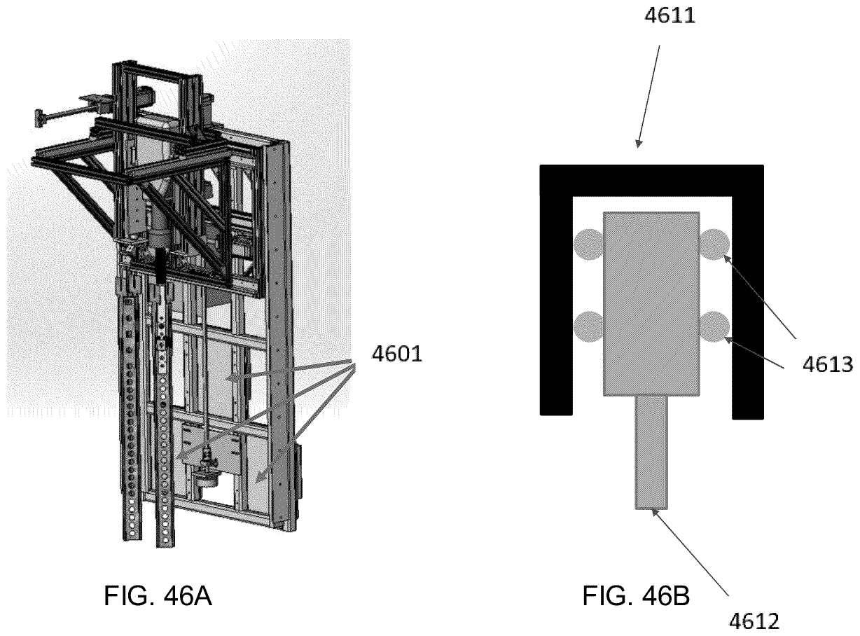

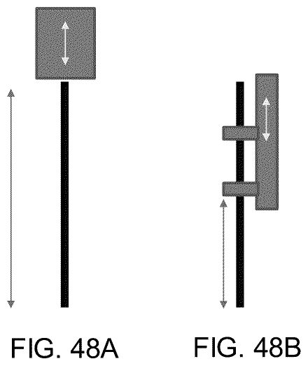

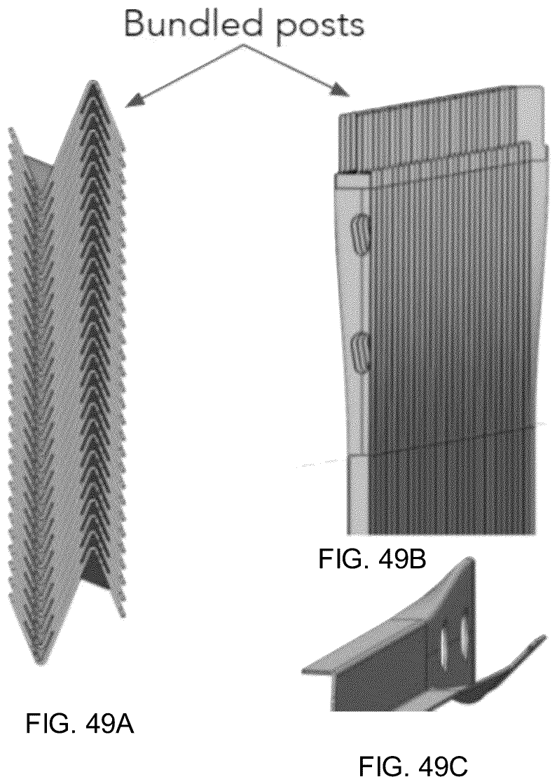

FIGS. 46A-46B show a machine for installing posts, such as those illustrated in FIGS. 49A-49C. In some cases, the machine may have 3 or more mounting interfaces to mount a tractor to, for example, using a 3 point hitch 4601. In some cases, the machine may carry a hammer 4611 for pounding a post 4612 into the ground. In some cases, the hammer may be mounted on vertical rails 4613 and may be free to slide vertically or in any other sufficient direction such that sufficiently small or no vibration is transferred from the hammer to the remainder of the machine.

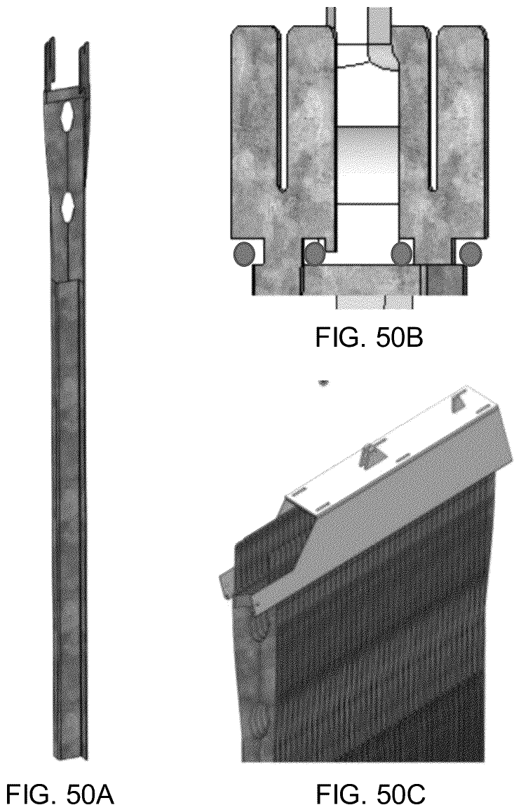

FIGS. 50A-50C show coupling mechanisms between posts and a rack, in accordance with some embodiments. In some cases, a post may comprise a Z shaped section or a Z shape. In some cases, a post may comprise a shape that is substantially stackable. In some cases, a post may comprise one or more oblique set of tabs at the top. In some cases, a tab may comprise a cutout feature. In some cases, a cutout feature may be configured to allow a post to be hung from a hanger or a rack. In some cases, one or more posts may be bundled and shipped in a container or provided to a machine.

In some embodiments, the apparatus may be further configured to perform a force test after the select post has been installed at the predetermined location. In some embodiments, the force test may comprise applying a pull force on the select post in at least one of a lateral direction or a vertical direction.

In some embodiments, the select post may be installed at a predetermined location using a load driving mechanism configured to drive the select post into the ground at the predetermined location. In some cases, the load driving mechanism comprises or is coupled to a hammer. In some cases, the load driving mechanism is mounted to and movable along a plurality of rails in a vertical direction. In some cases, the load driving mechanism is configured to slide along the plurality of rails via bearings.

In some cases, the load driving mechanism comprises a retention mechanism that prevents the select post from displacing or decoupling from the load driving mechanism as the select post is being installed into the ground. In some cases, the retention mechanism comprises one or more shear features.

In some cases, the load driving mechanism comprises a driving bit having one or more shear features. In some cases, the one or more shear features may be configured to dually function as retention features. In some cases, the load driving mechanism is configured to have a driving force length that is less than a full longitudinal length of the select post.

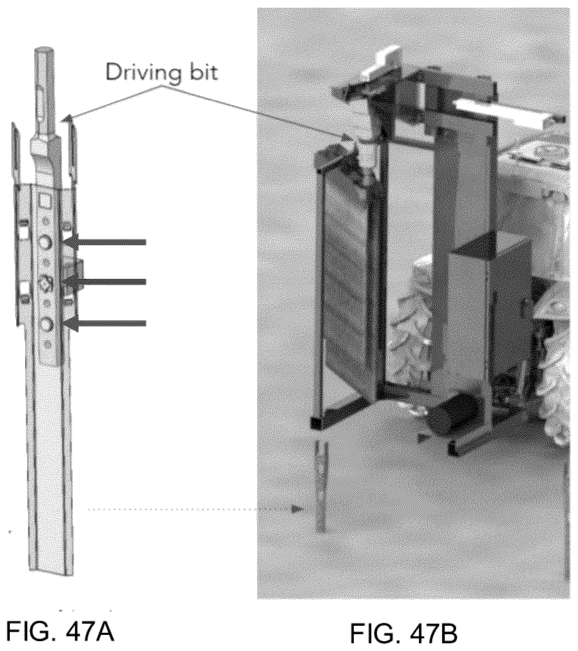

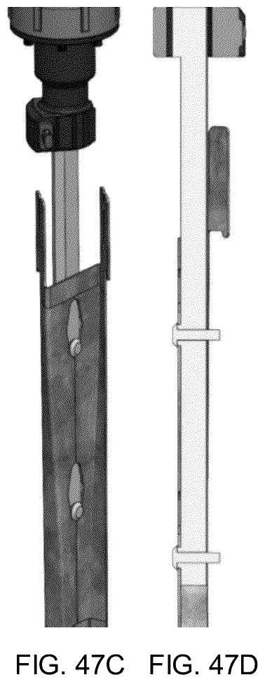

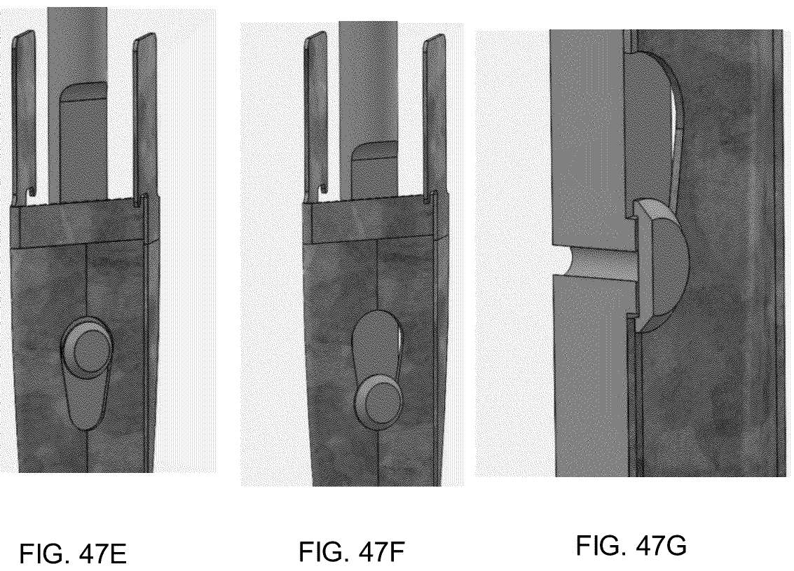

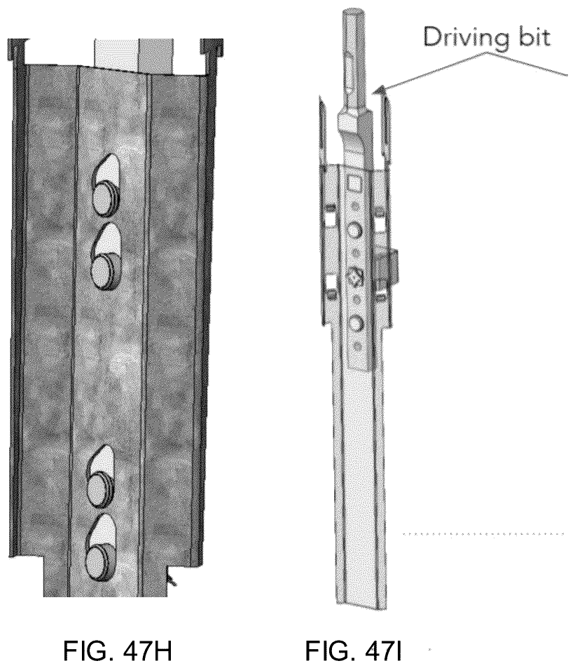

FIGS. 47A-47I show coupling mechanisms between a driving bit and a post, in accordance with some embodiments. In some cases, a driving bit may be connected to a hammer. In some cases, a driving bit may comprise a shear interface for engaging a post during the pounding. In some cases, a driving bit may comprise a retention feature which prevents a post from falling off of the bit while it is being positioned and driven. In some cases, a driving bit may be configured to allow a post to be pounded from the post's web, which may be disposed lower on the body of the post. In some cases, pounding from the web may allow the hammer to impact the post with greater force, as compared to impacting from the head, because pounding from the web may effectively lower the buckling length of the post during pounding. In some cases, a driving bit may enter a larger portion of a hole in a post. In some cases, a driving bit may slide down in a configuration and retain against a chisel bit. In some cases, a head of a chisel feature on a driving bit may overlap with at least a portion of a post when the driving bit is engaged with the post. In some cases, there may be 1, 2, 3, 4, or more shear features on a chisel bit. In some cases, a chisel bit may also be used as a retention feature. In some cases, a feature on a chisel bit may retain a post. In some cases, a feature on a chisel bit may be separate from a feature that is pounding the post. In some cases, a retention feature may be a clocking element that rotates to engage with a post. In some cases, a retention feature may be a clocking square that turns about 45 degrees such that the corners retain a post once engage. In some cases, a retention feature may overhang a hole in the post. In some cases, a shaft may not engage a bottom of a hole in the post. In some cases, a pin may engage with a post without overhanging. FIGS. 48A-48B show a comparison of driving a post using different coupling mechanisms, in accordance with some embodiments.

In some embodiments, the post may be driven into a terrain using a component that is positioned, oriented, and/or moved to impact a feature that is positioned along a length of the post. The component may comprise a hammer, a pin, or any other rigid structural member. In some cases, the movement of the component may be guided using a sleeve or a rail. The impact between the component and the feature may provide a driving force to push a post into a desired location. The point of impact may be closer to a center of gravity or a center of mass of the post, which can help to minimize buckling forces and to ensure that the post is installed in a desired orientation (e.g., perpendicular to the terrain or at any other desired angle relative to the terrain).

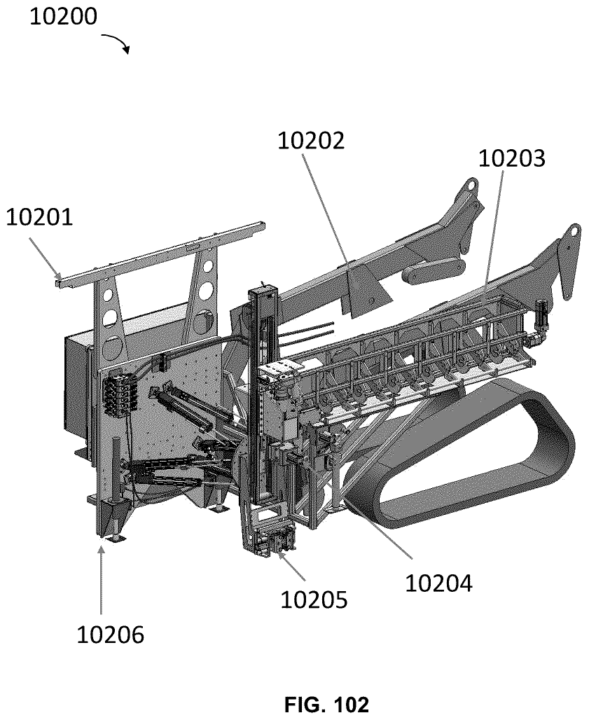

FIG. 102 shows a post installer. The post installer 10200 comprises a sensor 10201. e.g., a geolocation sensor, a vehicle 10202 to hold the posts and the other components, a post hopper and feeder 10203, a post retention and pounder 10204, a post retention mechanism 10205, and a plurality of outriggers 10206.

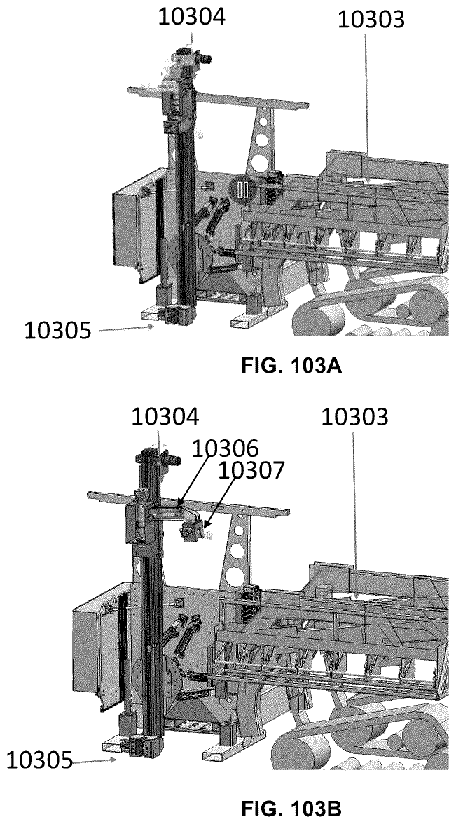

FIGS. 103A and 103B show the apparatus for post loading from a post hopper and feeder. The apparatus comprises a post pounder. e.g., a hammer 10303. The post pounder 10303 comprises an arm that can rotate about 90° from a vertical position to a horizontal position. At the distal end of the arm, the post pounder comprises a grabber. In the process of picking up a post, the post pounder 10305 travels up along a support. e.g., a rail to a predetermined position, the arm 10306 rotates/opens to a horizontal position, and the grabber 10307 opens. The apparatus can travel to a lateral position of a post hopper and feeder. Alternatively, the apparatus can travel to the post hopper and feeder before the pounder opens. When the apparatus is at the lateral position of the post hopper and feeder, the post pounder can move to the side of the post hopper and feeder, or any appropriate position, to grab a post from the post hopper and feeder 10303. Following the grabbing, the post pounder can travel up along the support. e.g., the rail to a position that permits enough vertical space/length to accommodate the post. The apparatus can then drive to the post install location and the arm can rotate to a vertical position and be lowered to insert the post into a post retention mechanism for the subsequent installation.

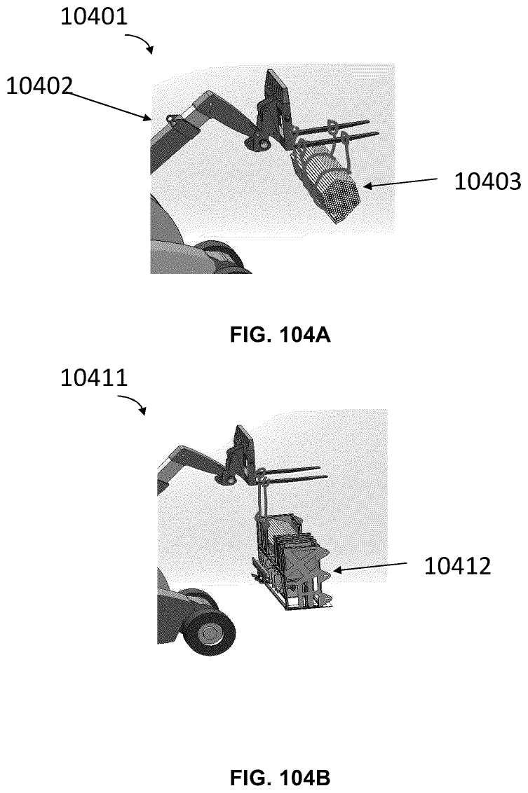

FIGS. 104A and 104B illustrate the loading operation of posts. At operation 10401 (FIG. 104A), a vehicle 10402 grabs a bundle of posts 10403. At operation 10411 (FIG. 104B), the vehicle 10402 loads the bundle of posts 10403 to a post hopper and feeder 10412.

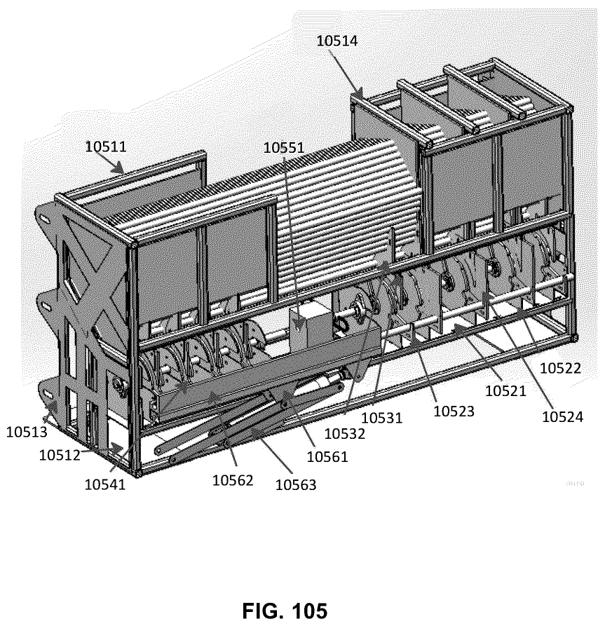

FIG. 105 shows a schematic post hopper and feeder. The post hopper and feeder can singulate one post at a time out of a bundle of posts for installation. The post hopper and feeder can comprise a hopper 10511, a lower tray 10521, an upper tray 10531, a singulator fin 10541, a motor mount tray 10551, and a kicker arm 10561. The hopper 10511 comprises a chassis base mount 10512, a chassis vertical mount 10513, and post adjustment walls 10514. The lower tray 10521 comprises a plurality of lower backer fins 10522, a plurality of lower chute fins 10523, and a plurality of length adjustment fins 10524. The upper tray 10531 comprises a plurality of upper backer plates and upper chute fins 10532. The singulator fin 10541 comprises a plurality of keyed shafts, a shaft collar, and spacers. The motor mount tray 10551 comprises a motor, a gearbox, a shaft coupler, and/or a motor shaft. The kicker arm 10561 comprises a 4 bar linkage 10563 and a post support arm 10562. The kicker arm 10561 can further comprise a plurality of hydraulic swivel clamps, hydraulic cylinders, bearings, bushings, proximity sensors, and/or a post holder.

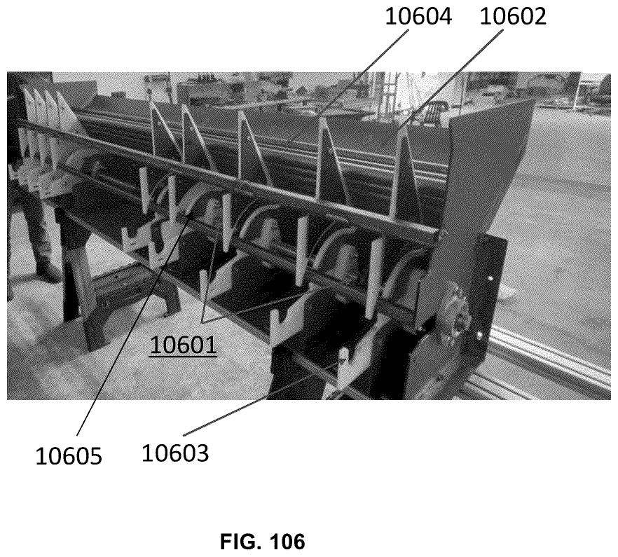

FIG. 106 shows a post hopper and feeder machine. The machine comprises rotating shafts 10601 that rotate to separate one post from the bulk unsorted posts 10604 from the hopper 10602. The rotating shafts can connect to a plurality of fins 10605 that have an opening or a pathway that only one post can drop to or enter the fin. The one post can subsequently enter the chute fins 10603.

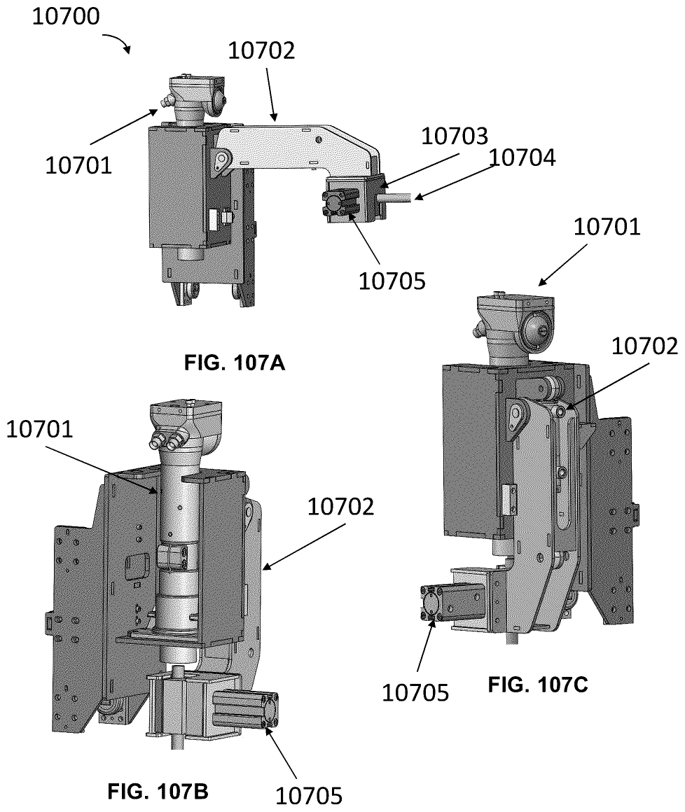

FIG. 107A shows an exemplary post pounder. The post pounder 10700 comprises a hammer 10701, an arm 10702, and a grabber 10703. The arm 10702 can rotate from a vertical position to a horizontal position to grab or grip the post and transfer it to a post retention mechanism. In some embodiments, the arm 10702 may be extendible. The grabber is coupled to an actuator 10705 which actuators a grabbing mechanism to grip a post 10704 (only part of the post is shown). FIG. 107B shows a post pounder configuration after a post is gripped and transported to a vertical position. FIG. 107C is a perspective view of a post pounder configuration after a post is gripped and transported to a vertical position.

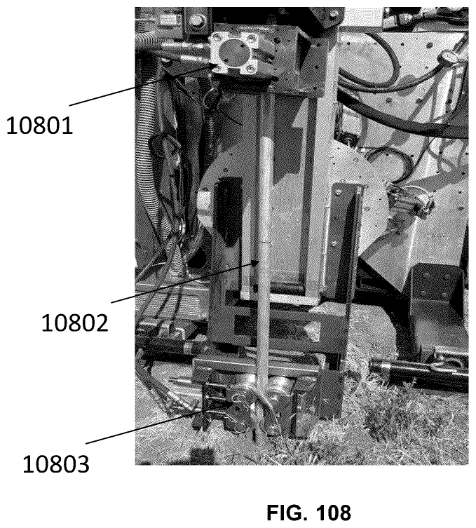

FIG. 108 shows an exemplary post installing apparatus/machine (post installer). The post installer comprises an actuator 10801 to enable the gripping of the post by the grabber (see FIGS. 107A-107C). The post is inserted to a post retention mechanism 10803. The post retention mechanism 10803 comprises a plurality of rollers and an actuator. The rollers actuate to retain the post close to the ground for high accuracy. The rollers can open for ease of movement retraction. In some embodiments, the post can be retained perpendicular to a flat surface. In some embodiments, the post can be retained at a desired angle relative to the vertical axis.

In another aspect, the present disclosure provides an apparatus that is configured to carry a plurality of solar modules over a terrain: autonomously position a select solar module from the plurality of solar modules over a set of posts installed on the terrain; and autonomously assemble the select solar module to the set of posts without requiring or using fasteners.

In some cases, the apparatus may be configured to autonomously assemble the select solar module to the set of posts by forming a plurality of post-clip interfaces. In some cases, the plurality of post-clip interfaces comprise a plurality of clinched joints.

In some cases, the select solar module can be pre-attached with a clip at one or more corners or sides of the select solar module, and each post in the set of posts may comprise a plurality of tabs. In some cases, the apparatus may be configured to autonomously position the select solar module over the set of posts by aligning the clip to a corresponding tab at each post. In some cases, the apparatus may be configured to autonomously assemble the select solar module to the set of posts by clinching the corresponding tab to the clip at each post.

FIG. 59 illustrates a light curtain, in accordance with some embodiments. In some cases, a machine may comprise one or more optical sensors configured to detect when a foreign object (e.g., a human or another agent) enters a workspace defined by a light curtain. When a foreign object enters the workspace, at least a portion of the light curtain may be interrupted or disrupted, which can trigger one or more safety procedures or protocols (e.g., shutting down a machine or limiting an operation of the machine until the foreign object exits the workspace).

The following examples are provided to further illustrate some embodiments of the present disclosure, but are not intended to limit the scope of the disclosure: it will be understood by their exemplary nature that other procedures, methodologies, or techniques known to those skilled in the art may alternatively be used.

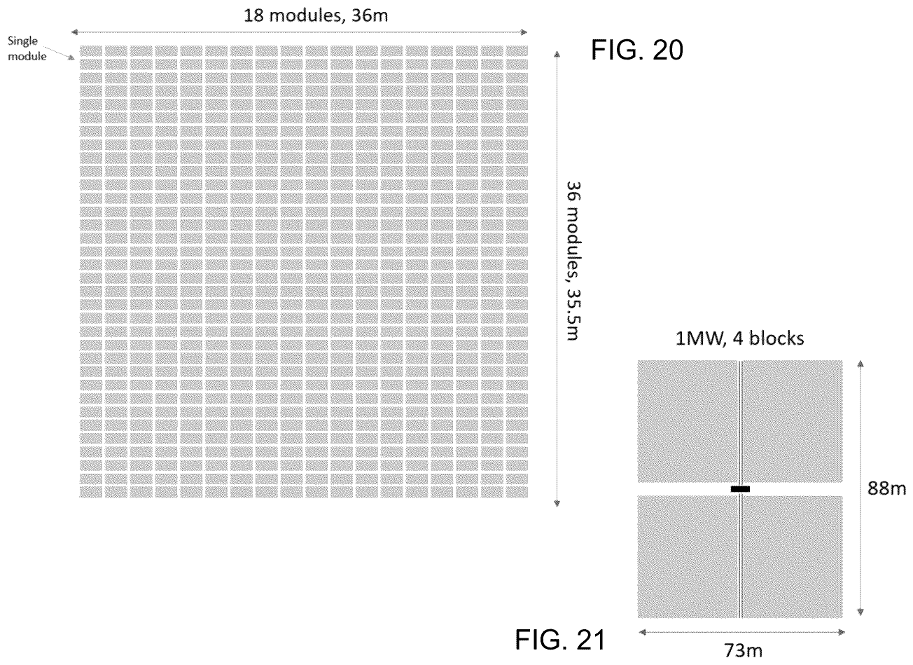

FIG. 20 shows a layout of blocks of solar modules in a connected orientation. FIG. 21 shows a plurality of blocks connected to a central inverter.

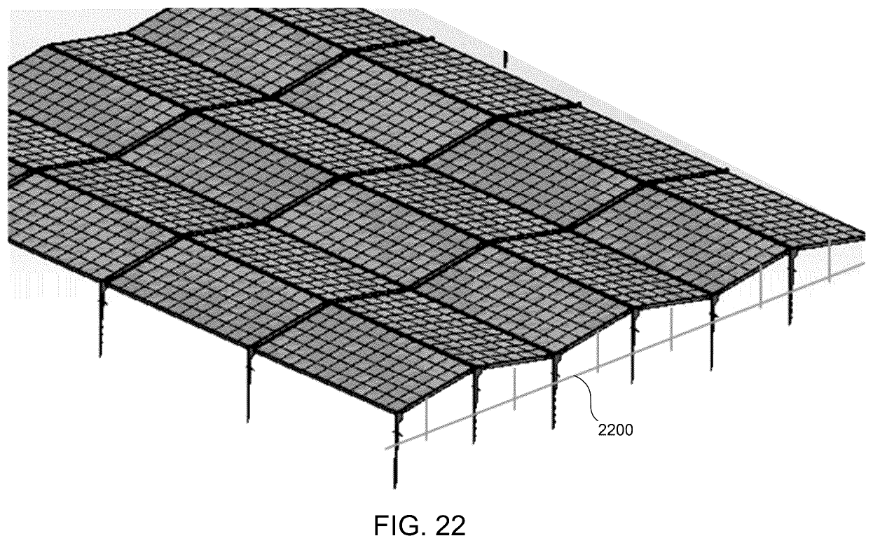

FIG. 22 is a perspective view of a portion of a block. The lines 2200 here show how the wires going from the module strings to the inverter (the ‘home runs’), can be mounted on the side of an array and clipped to the posts.

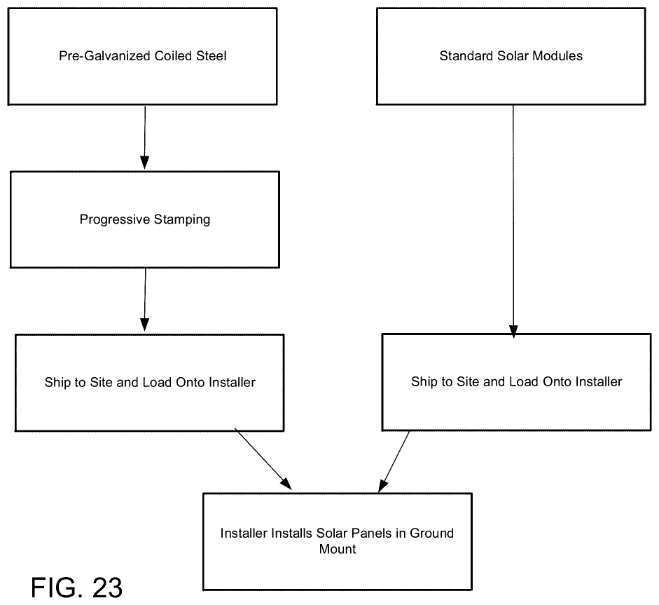

FIG. 23 is a simplified flow diagram illustrating a supply chain that is made available according to embodiments. The simplicity of this supply chain allows the posts, joints, and prefabricated solar modules to be shipped from the factories to a location for deployment. There, these components can be installed onto a machine that is configured for rapid and automatic installation of the ground mount system.

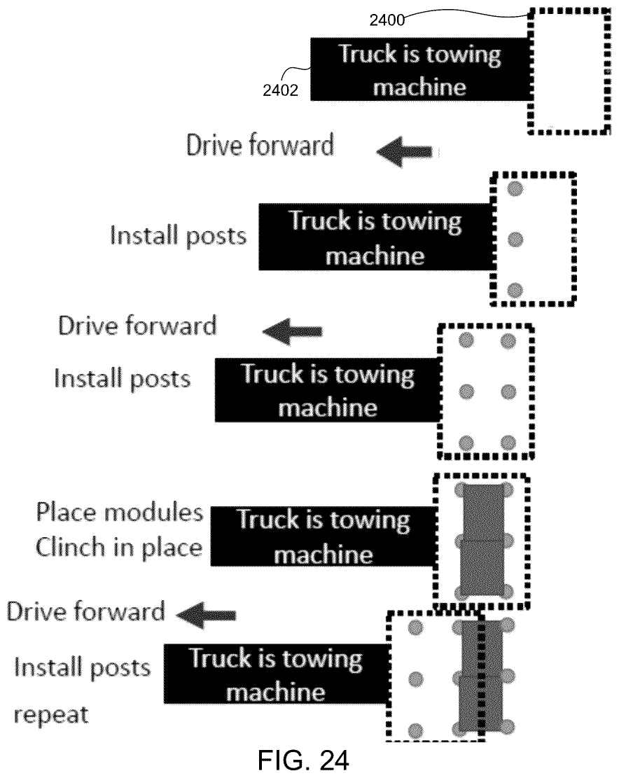

FIG. 24 is a simplified overhead view showing progress of one embodiment of an installation machine 2400 over a site. Here, the machine is towed by a truck 2402, in a right-to-left direction. After the posts are pushed into the ground, the modules can be attached. In this particular embodiment, the modules may have clips pre-installed in them.

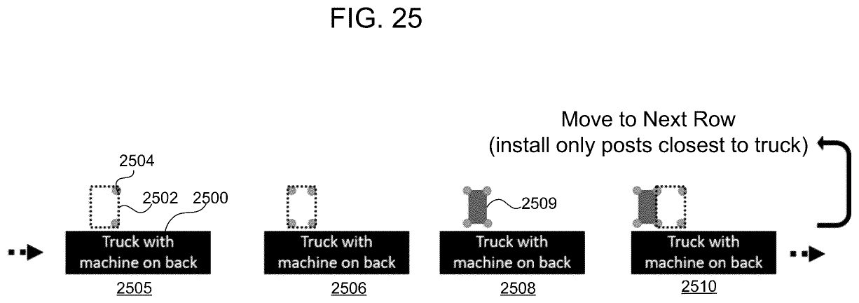

FIG. 25 is a simplified overhead view showing progress of an alternative embodiment of an installation machine 2500 over a site, from left-to-right. This particular embodiment utilizes a post tool jig 2502 that comprises a rectangle of fixed dimensions, in order to always index the next pair of posts 2504 off of the previous pair. Specifically, in a first phase 2505 two posts are pushed into the ground, with the jig used to position the posts relative to one another. In a second phase 2506, two more posts are pushed into the ground, again with the jig used to position the posts. In a third phase 2508, the module 2509 is placed directly after next pair of posts. The jig can grab features on clips on posts to both index and to hold the clips while pressing modules into them. A fourth phase 2510 places the next posts (e.g., using the jig to index from previous posts). The process may then be repeated.

In some cases, the path of the installation machine may be serpentine over the site. When the vehicle turns around and does the other side of the row (from right-to-left), everything is the same except only posts closest to the truck are implanted. The two specific installation machines presented in FIG. 24 and FIG. 25 are examples only, and alternative embodiments may be used.

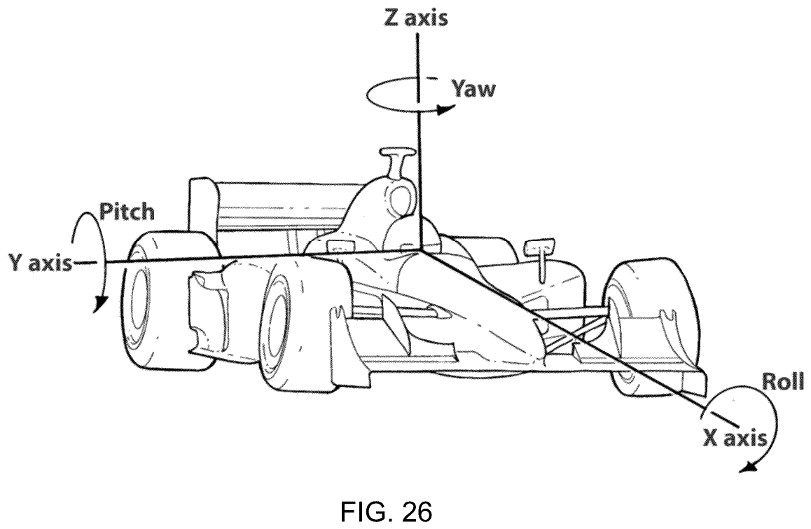

FIG. 26 provides a formal coordinate system for describing a moving vehicle. This coordinate system is now referenced to describe another exemplary embodiment of an apparatus configured to perform installation of ground mounted solar panels.

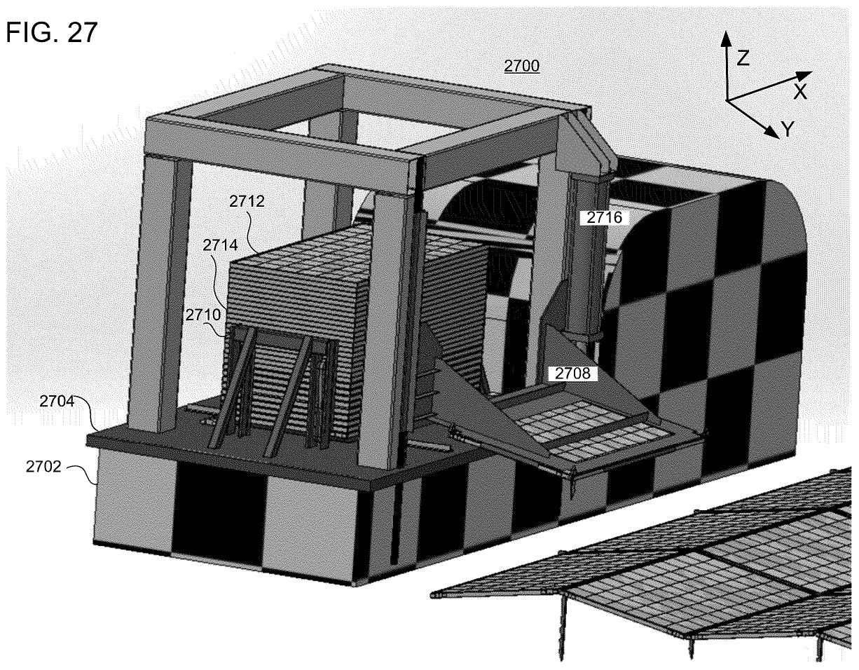

FIG. 27 shows a rear perspective view of one embodiment 2700 of the installation apparatus. The apparatus comprises various elements mounted to a moving vehicle 2702 (e.g., a pickup truck bed)—via a platform 2704. As described in detail below, this platform may be configured to move in one or more direction(s). Elements of the installation machinery may comprise a frame 2706 and a load head 2708. A vertical conveyor 2710 may be configured to receive a stack 2712 of individual pre-fabricated solar panels 2714. In some cases, the installation machinery may further comprise a hydraulic actuator 2716 for implanting posts into the ground by pushing (rather than hammering).

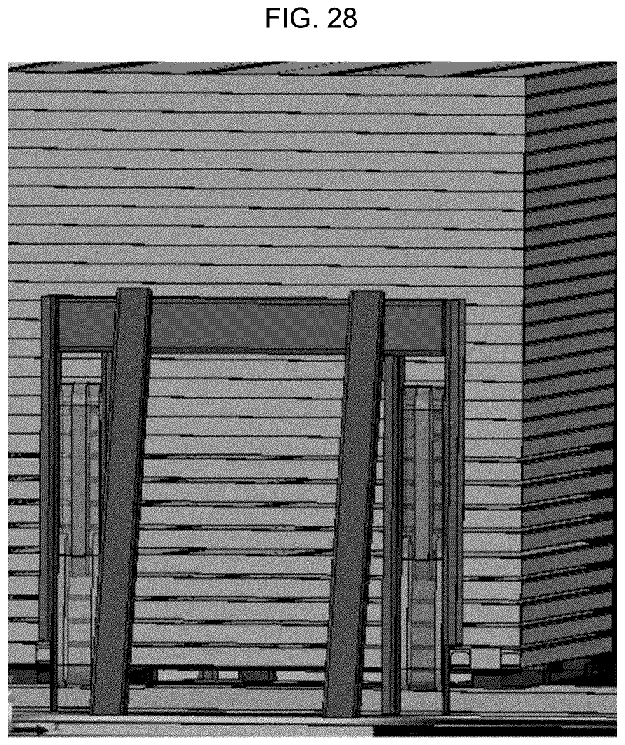

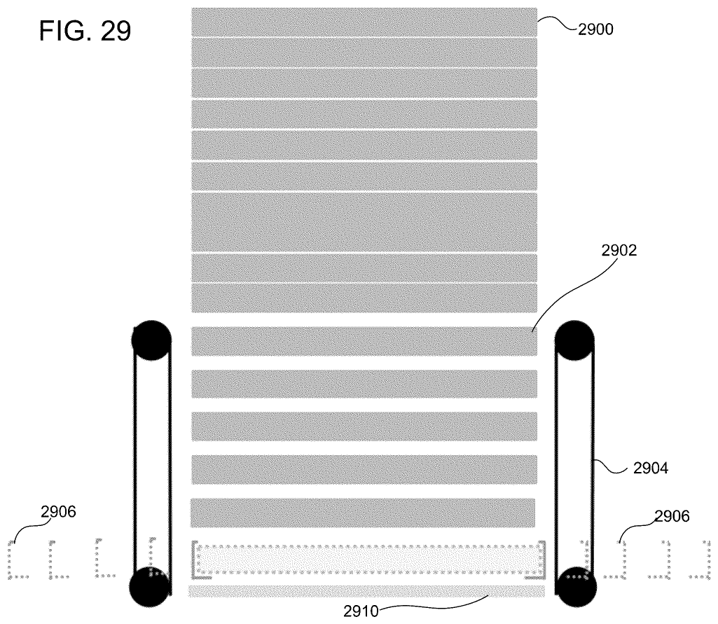

FIG. 28 shows a detail of the vertical conveyor element which can be used to lower modules one at a time. FIG. 29 is a schematic view showing how standard packaging of a stack 2900 of solar modules, can be loaded on to vertical conveyors 2904 and individual modules 2904 then lowered onto the sheet metal clips 2906. The modules can be lowered onto the sheet metal clips 2906. The resultant combination of the module and clips can be lowered onto a tray 2910, which can slide out from the bottom of this stack.

FIG. 30 shows a detail of a module including a frame 3000 that is being lowered onto a clip 3002. The joint's connection 3003 to its adjacent joint can be severed by the piece 3004 during this process.

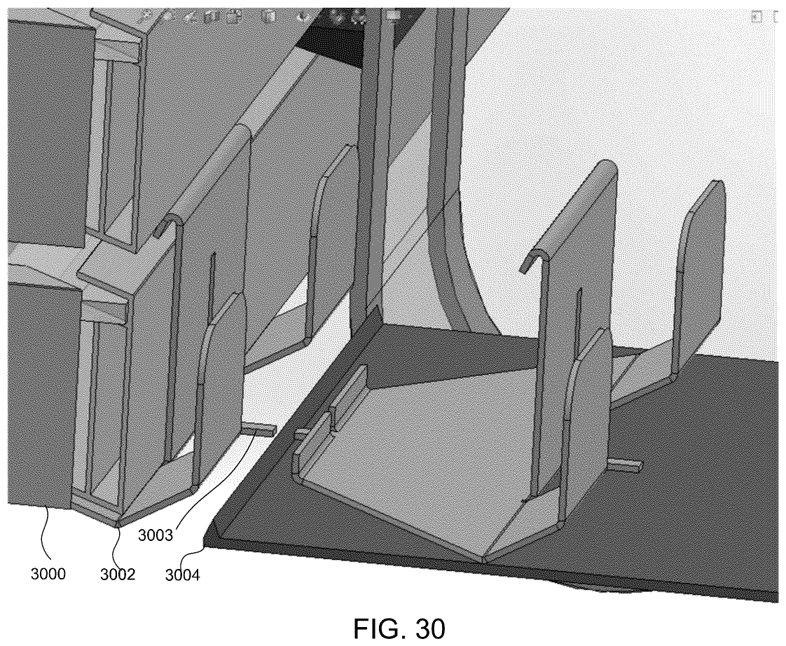

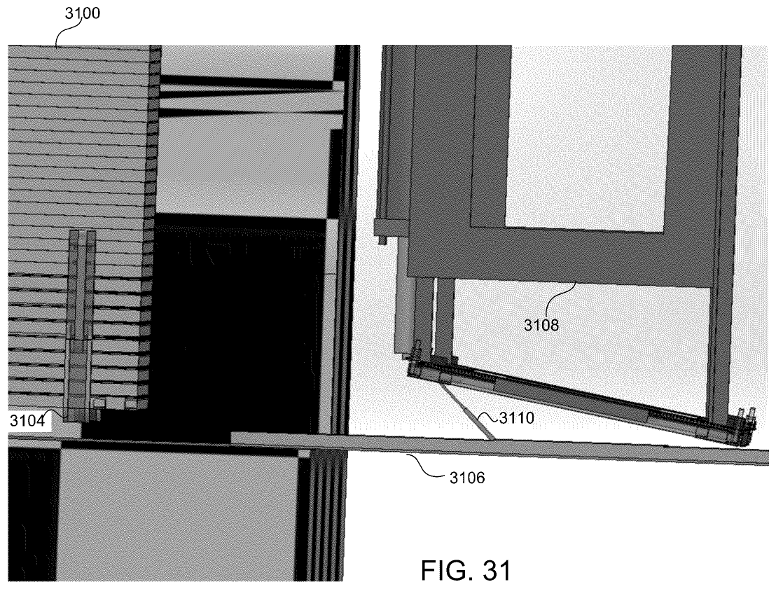

FIG. 31 shows a side view of a stack 3100 of solar modules on a vertical conveyor 3104. A horizontal rail 3106 can be used to slide the bottom module laterally onto the installation load head 3108. The module can be tilted by a small linear actuator 3110.

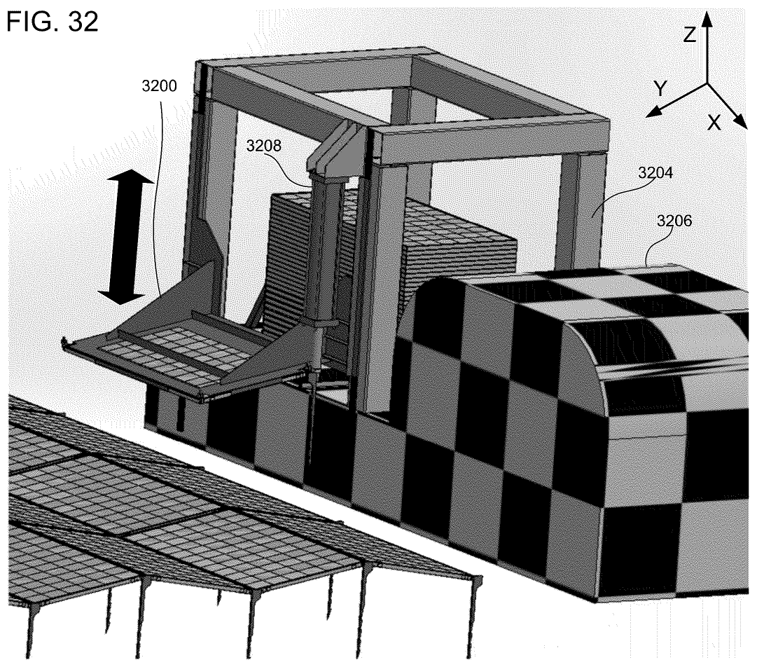

FIG. 32 shows a front perspective view of the installation apparatus according to an embodiment. The load head 3200 is shown in vertical sliding motion relative to the frame 3204 which is connected to the truck 3206. This motion can be actuated by a hydraulic actuator 3208 which is mounted to the frame.

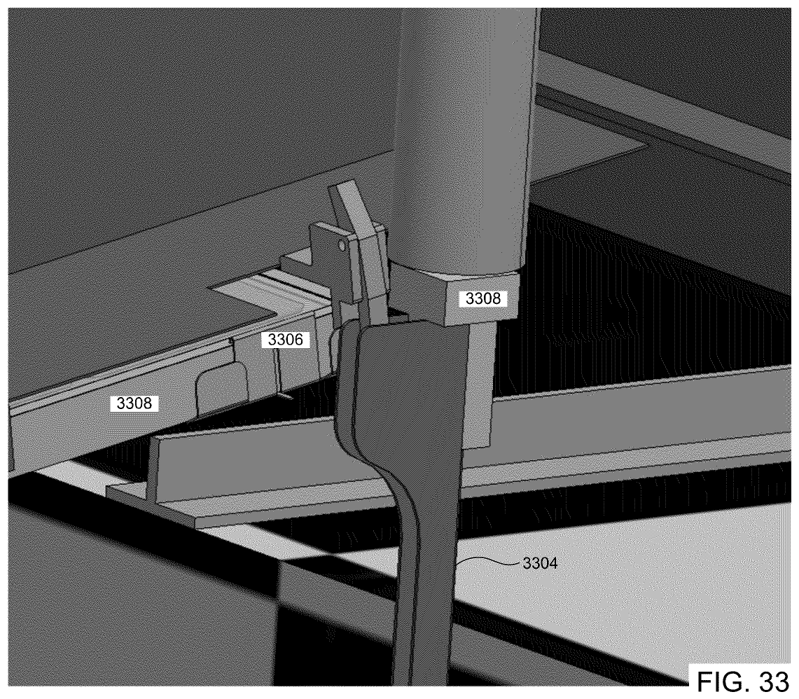

FIG. 33 shows a detailed view of the load head frame 3300 connected to the actuator tip 3302 that is used to (simultaneously) drive in the post 3304. A joint 3306 can be seen already attached to the solar module 3308 that is loaded into the load head. The tip 3308 of the actuator that is pushing directly on the post is also connected to the module load head. Thus, the module can be lowered into the correct place simultaneously as the post is driven into the ground. The connection between the actuator tip and the module load head can also have a flexure to reduce vibrations from being transferred to the module during installation.

In connection with the installation machine embodiment of FIGS. 27-33, one or more of the various elements (e.g., frame, load head, conveyor(s), others) can be mounted on the movable platform. That platform can be actuated in either: (i) x-axis, y axis, and yaw directions, or (ii) x-axis, y axis, vaw, pitch, and roll directions.

In some cases, a vertical actuator can control the Z axis motion. One method of controlling planar motion is via a two-way table. An additional drive can control the yaw direction.

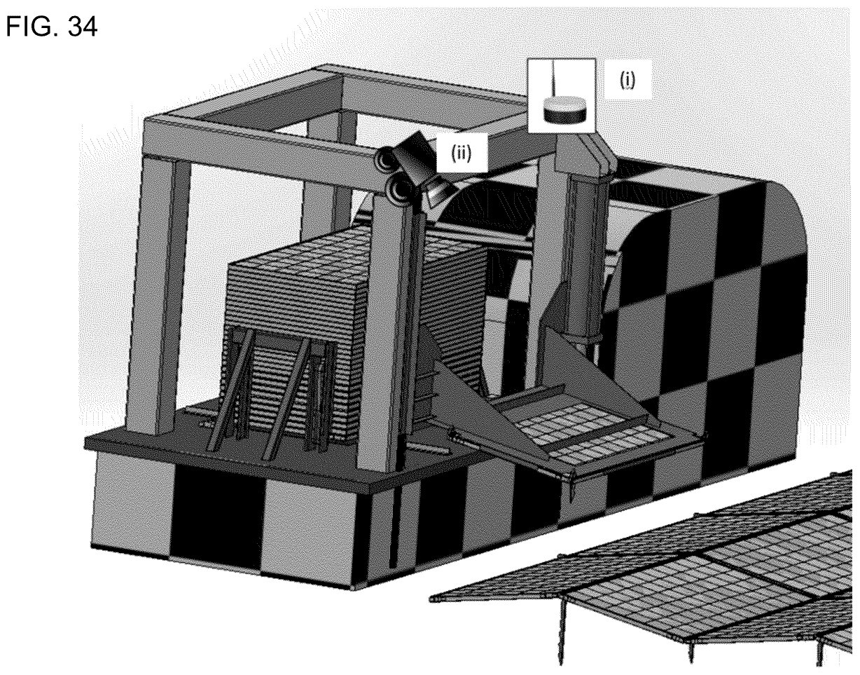

FIG. 34 further shows that the position of the moveable platform may be controlled (either separately or individually) by the use of: (i) a differential GPS system, (ii) cameras, (iii) lidar, and/or (iv) laser tracking. In some cases, a GPS and/or camera system may allow control over how to precisely place each module and post in the solar array. This functionality can provide control over the movable machinery on the red platform, and/or the position/driving of the entire installation apparatus (e.g., as disposed in a truck, within a trailer, or in the form of a specially-built vehicle).

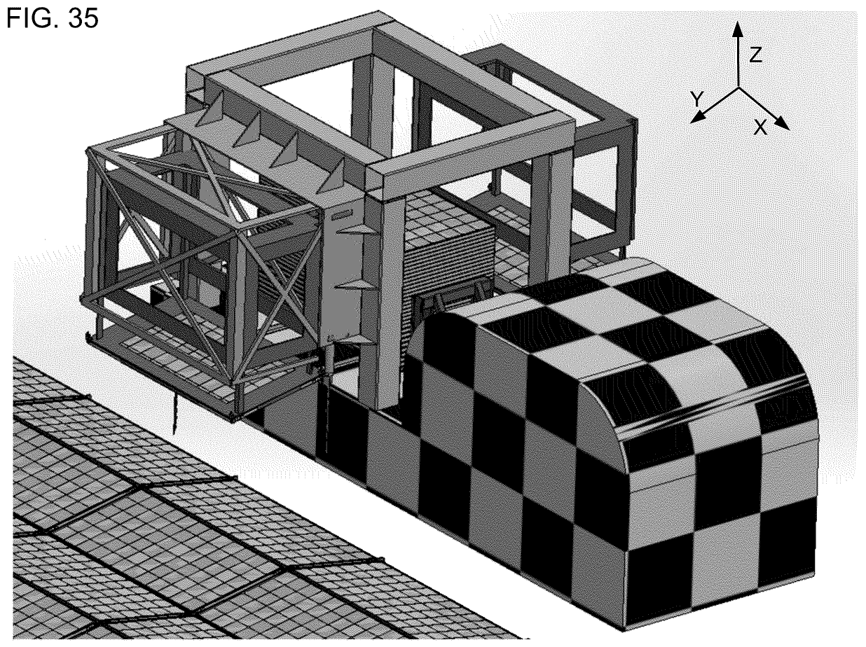

Embodiments are not limited to the specific installation apparatuses described above, and alternatives are possible. For example. FIG. 35 shows a front perspective view of an alternative embodiment of an installation machine.

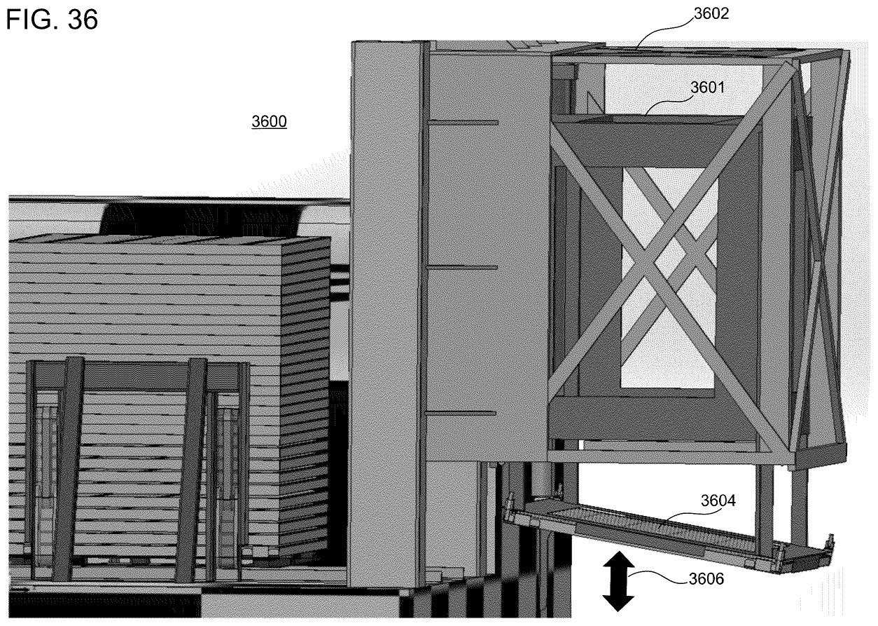

FIG. 36 shows an enlarged side view of the installation apparatus 3600 illustrated in FIG. 35. Here, the load head 3601 can slide inside a retained fixture 3602 to install a single solar module 3604 in a vertical linear motion. The load head may be captured inside of the rigid frame to constrain motion to only vertical (shown by the arrow: 3606).

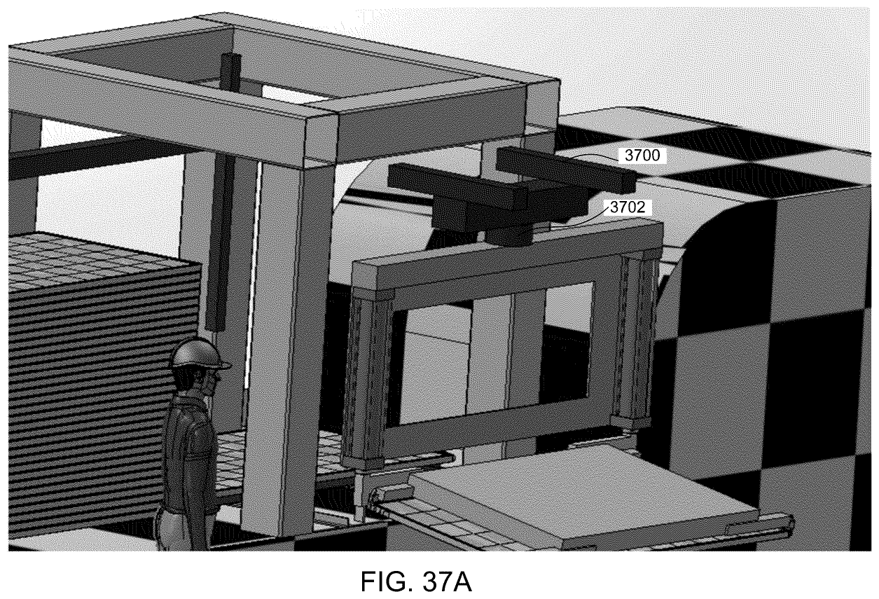

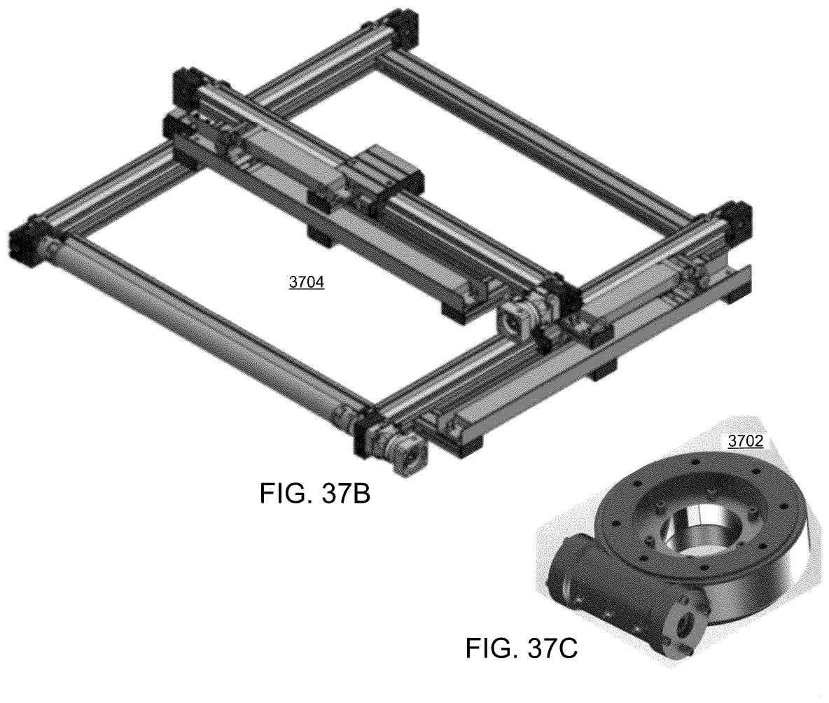

FIG. 34 shows one non-limiting example of a platform that can be used to facilitate solar module deployment and installation. In some embodiments, the position of the module and load head can be controlled using a mechanism such as the overhead part 3700 shown in FIG. 37A, which can be attached to a frame of the platform.

FIG. 37B shows the overhead part as taking the form of a gantry 3704 to control planar positioning. FIG. 37C shows an enlarged view of a rotational gear 3702 that may be mounted below. In some cases, other mechanisms such as a conveyor (e.g., a vertical conveyor or a horizontal conveyor) may be used to control positioning of the modules.

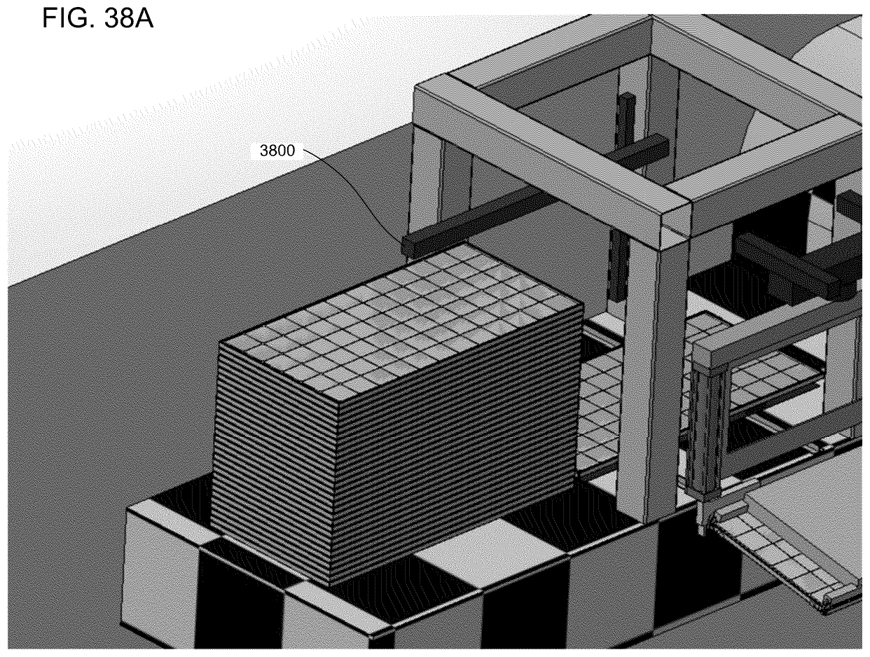

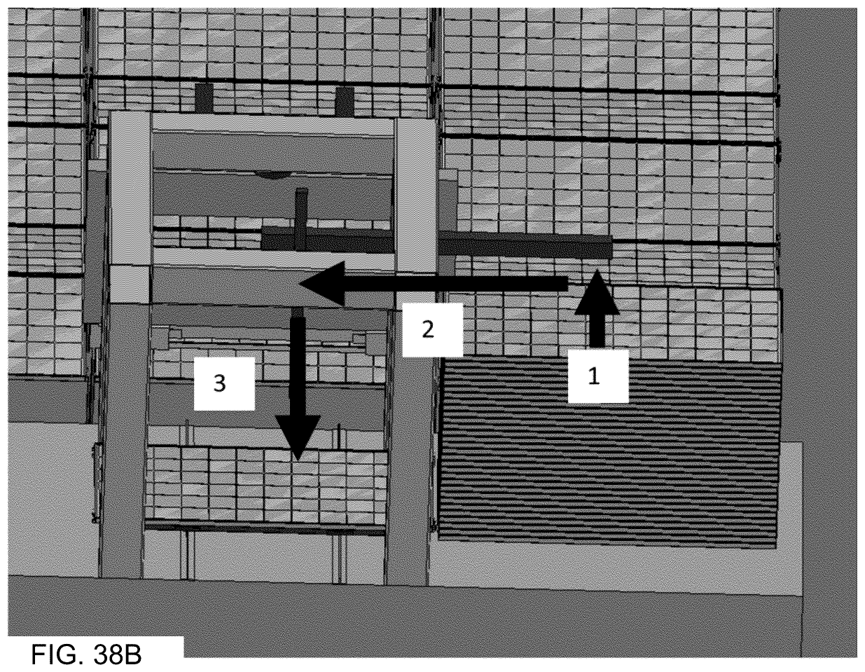

FIG. 38A shows a perspective view of an embodiment where modules are lifted off of their stack on a pallet by a gantry with a suction cup load head and translated over and put down onto the module slider (shown extended in FIG. 31). This gantry can press the modules down onto the four clips during the motion #3 shown in FIG. 38B to install the clips onto the module.

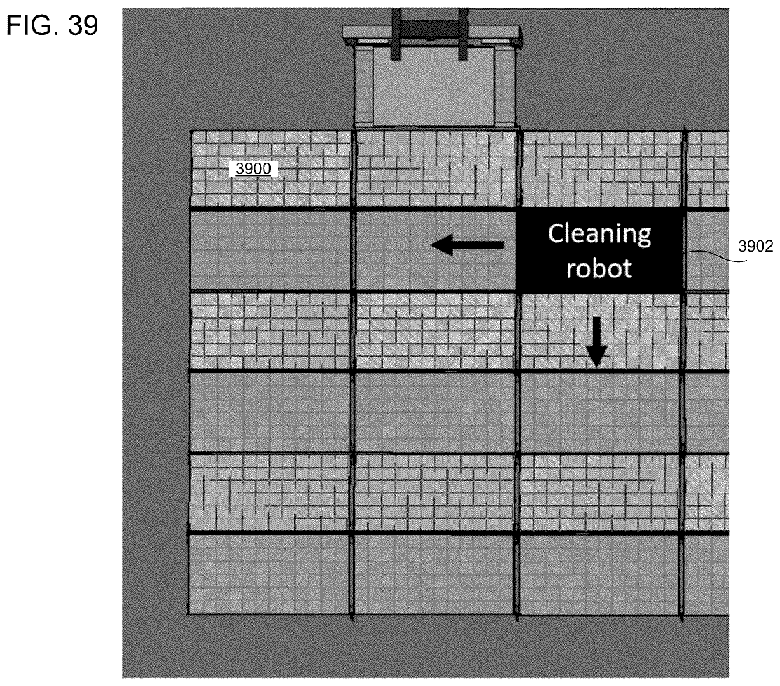

FIG. 39 shows an overhead view of an embodiment comprising a dual tilt (between ( ) and 20 degrees) array 3900 of ground mounted solar modules. This uninterrupted array of modules may provide a valuable opportunity to clean the array using a robot 3902. This cleaning robot can autonomously travel in any direction on the module plane.

FIG. 40 shows an overhead view of another alternative embodiment. Here, the array of solar modules may be installed with a stagger between the rows of modules. Such an implementation may add significant stiffness in the stagger direction due to the overlapping frames. Apart from consuming 50% more posts, such an embodiment could function in a manner similar to those described previously.

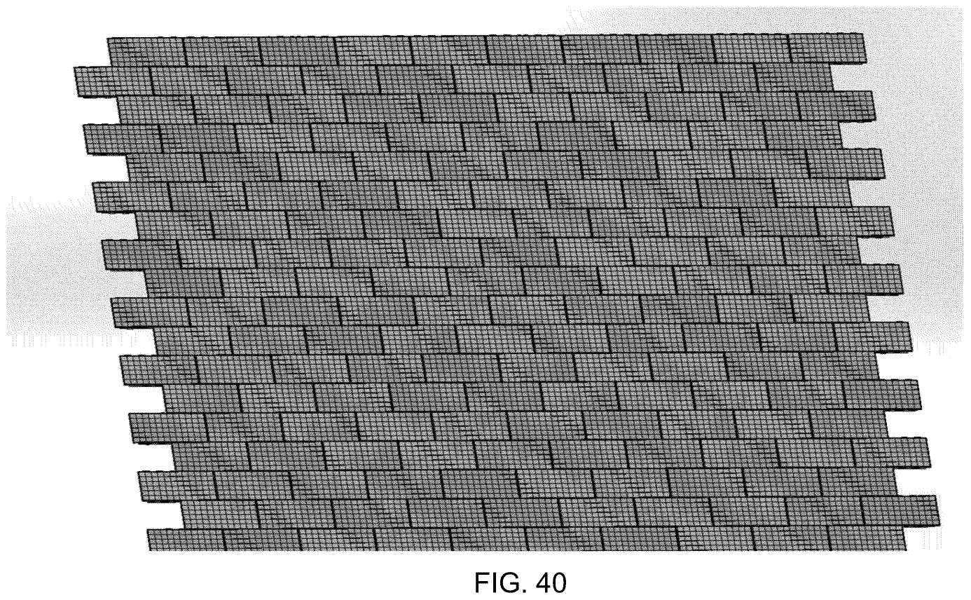

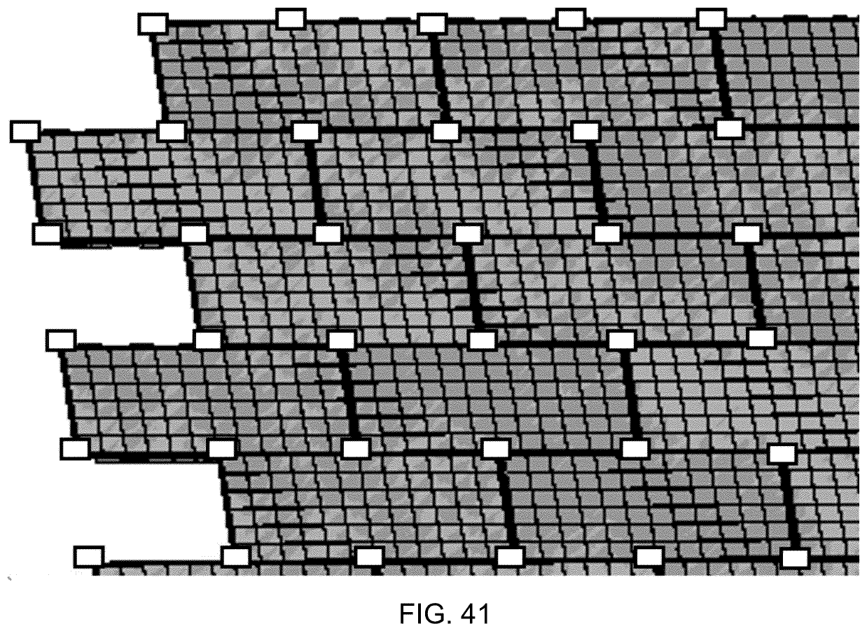

In the configuration where the modules are staggered, there may be 6 posts per module, and the clip can be modified to clamp on the corner of two modules and the middle edge of a third module. In FIG. 41, post locations are shown as a white square at the intersection of a module edge and two corners of adjacent modules.

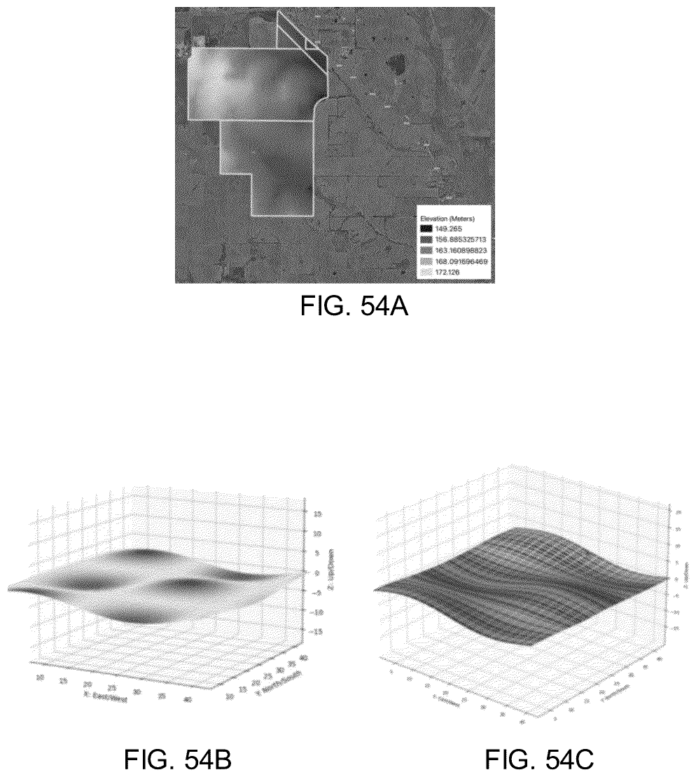

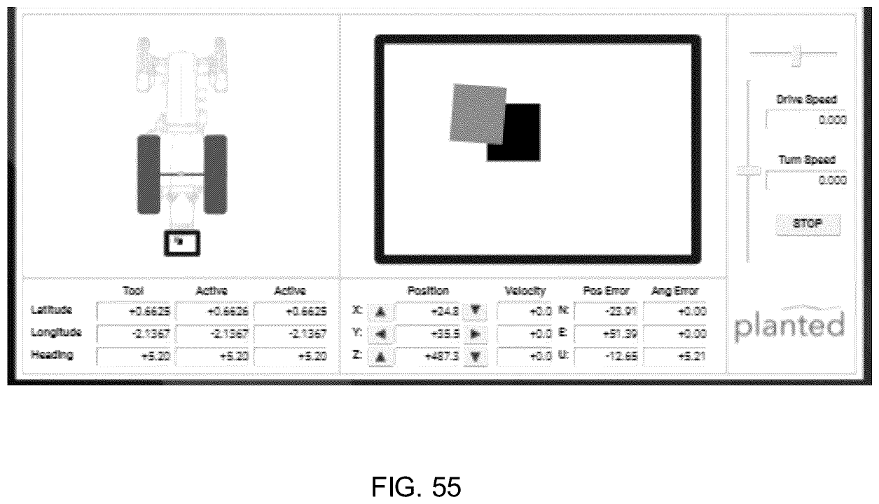

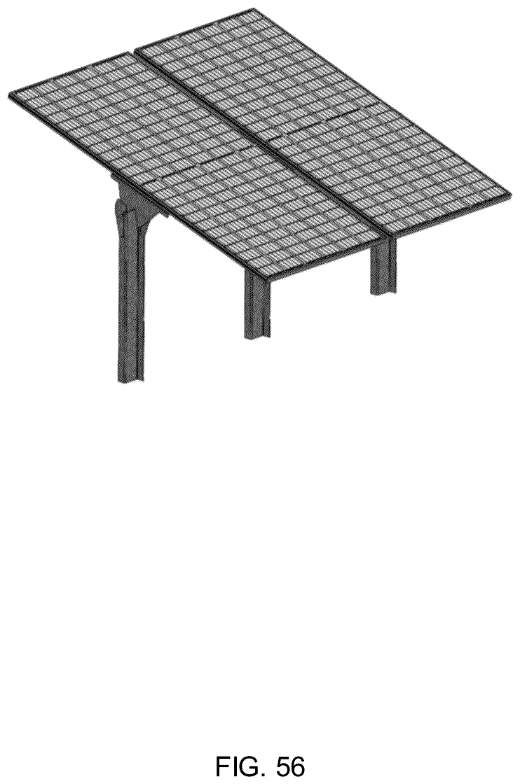

FIGS. 54A-54C illustrate a method for determining a landscape topology for positioning and assembling solar modules, in accordance with some embodiments. In some cases, the method may comprise analyzing a terrain topology and/or GIS data of a given terrain. In some cases, the method may comprise processing a curvature of the terrain topology or GIS data. In some cases, the method may comprise simulating posts and modules installed on the given terrain. In some cases, the method may comprise uploading the posts and the modules geolocation position and construction data for one or more machines for installing the posts and the modules. FIG. 55 illustrates an exemplary GUI for determining a landscape topology for positioning and assembling solar modules, in accordance with some embodiments.

In some cases, one or more algorithms, machine learning algorithms, or neural networks may be configured to process data of a terrain and determine an optimal layout, positioning, or installation location for one or more posts or solar modules. In some cases, the one or more algorithms, machine learning algorithms, or neural networks may be implemented to generate a virtual representation or simulation of a terrain and one or more candidate locations for installing posts or solar modules. In some cases, the one or more algorithms, machine learning algorithms, or neural networks may be configured to generate a blueprint or a set of instructions for controlling and moving a plurality of robots or mobile platforms to collectively deploy and install one or more posts or solar modules in a target environment. Such blueprint or set of instructions may be generated based on the virtual representation or simulation, or other data associated with the terrain or the landscape topology of the target environment. The virtual representation or simulation may comprise, for example, a 3D model or a point cloud representation of the terrain and the one or more candidate installation or deployment locations.

In some embodiments, when the robots or mobile platforms of the present disclosure run out of posts or solar modules for installation (or if the number of posts or solar modules immediately accessible to the robots or mobile platforms drops below a certain threshold), the robots or mobile platforms may undergo a restocking or replenishment operation. In some cases, the robots or mobile platforms may return to a facility or other central location for restocking or replenishing of posts and/or solar modules. In other cases, one or more other restocking vehicles or robots may carry or store an inventory of additional posts and/or solar modules, and can automatically travel to a robot or mobile platform that needs additional posts or solar modules. In some cases, the one or more other restocking vehicles or robots may travel or idle along a perimeter of the terrain, and travel to a particular robot or mobile platform when the robot or mobile platform requires additional posts or solar modules. This can avoid the need for the robot or mobile platforms to make an additional trip for restocking or replenishment purposes.

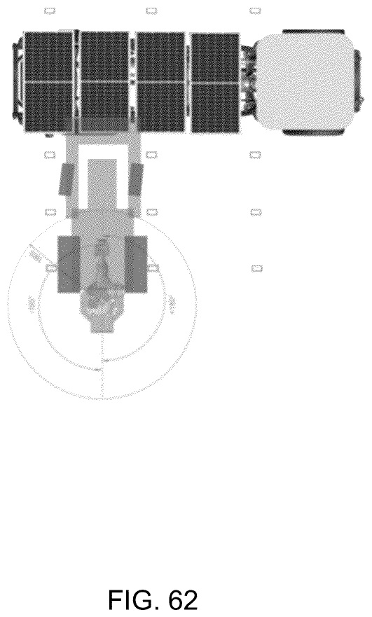

FIG. 62 illustrates an alternative embodiment of an exemplary vehicle that can be used or configured to handle, transport, install, or deploy one or more solar modules. The vehicle may acquire new stacks of modules autonomously, semi-autonomously, or with aid of human input or intervention. The vehicle may not or need not use or rely on a separate robot to acquire new stacks of modules. In some cases, the vehicle may comprise one or more front attachments that can be used to retrieve or obtain new solar modules from a stocking area or another vehicle.

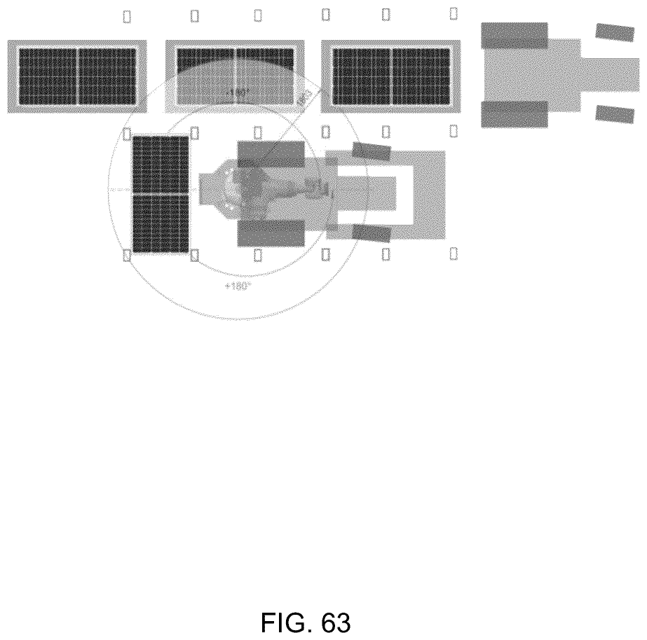

FIG. 63 illustrates another alternative embodiment of an exemplary vehicle that can be used or configured to handle, transport, install, or deploy one or more solar modules. In some embodiments, the vehicle may be configured to use a robot to move new solar modules off of a trailer of another vehicle.

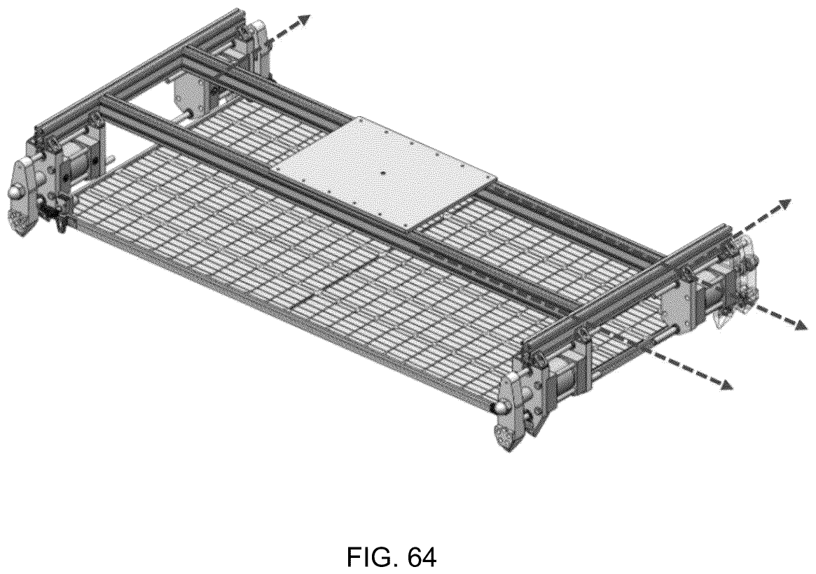

FIG. 64 illustrates an end-effector with clinch tools positioned at the corners of the end-effector. The end-effector in this case may not or need not use suction cups to pick up a solar module, and can instead grab the modules from the side by a squeezing or pinching action. The size of the frame of the end-effector may be adjustable such that the same end-effector can be configured to pick up modules of different shapes or sizes. As shown in FIG. 65, the bottom portion of the clinch tools can be tapered to help the clinch tools locate or engage with the module (e.g., a complementary feature disposed on the module).

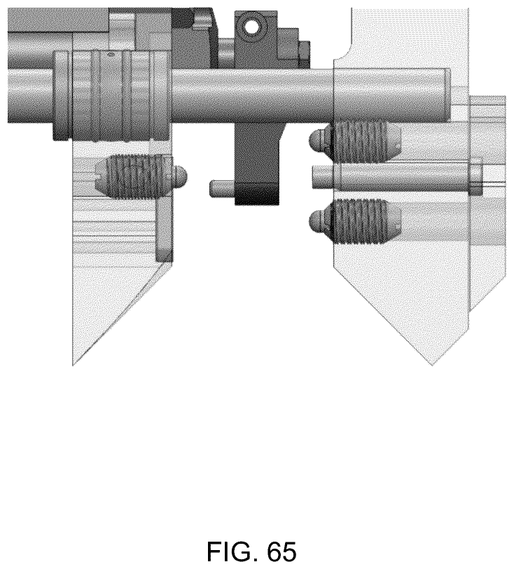

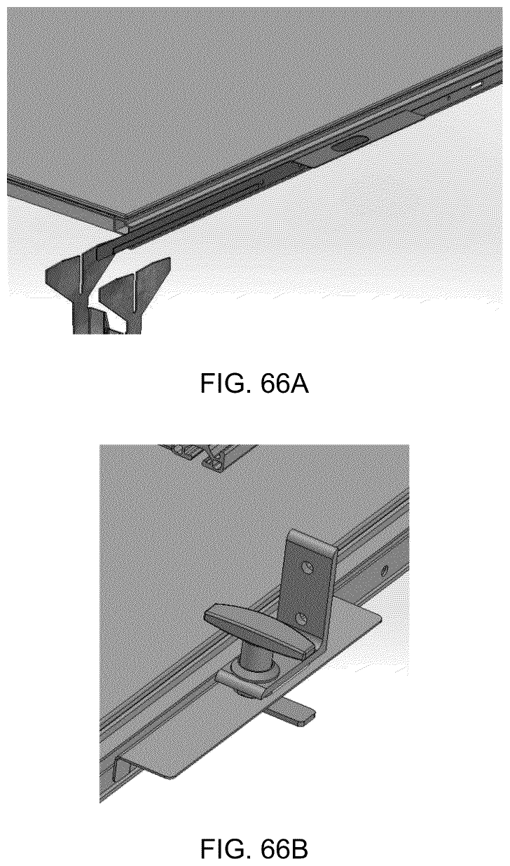

FIGS. 66A and 66B illustrate an alternate embodiment of a clip. The clip may comprise a hole or a slot that can interface with a latch that turns 90 degrees automatically which then engages the module and clip assembly with the load head on the module installer thus holding it in place. This is another embodiment of a way to pick up a solar module without using a suction cup.

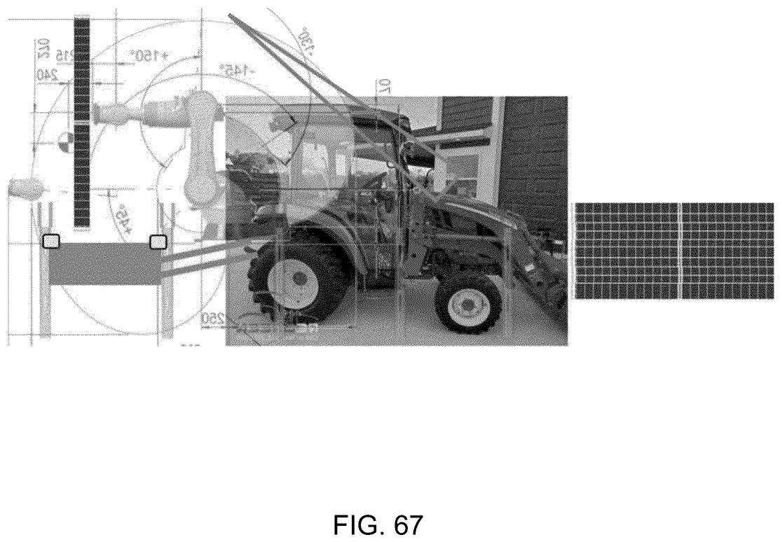

FIG. 67 illustrates an alternative embodiment of a module installer vehicle as described elsewhere herein. Here, the clinch tools (yellow) may not or need not be located on the same piece of automation that is moving the module (orange) but can instead be located on a separate piece of automation (blue) which is attached to the same mobile vehicle platform as the automation that moves the modules. The separate piece of automation (blue) may autonomously and releasably mate to previously installed posts. The module-moving automation (orange) can then move a module to the location where the posts are installed.

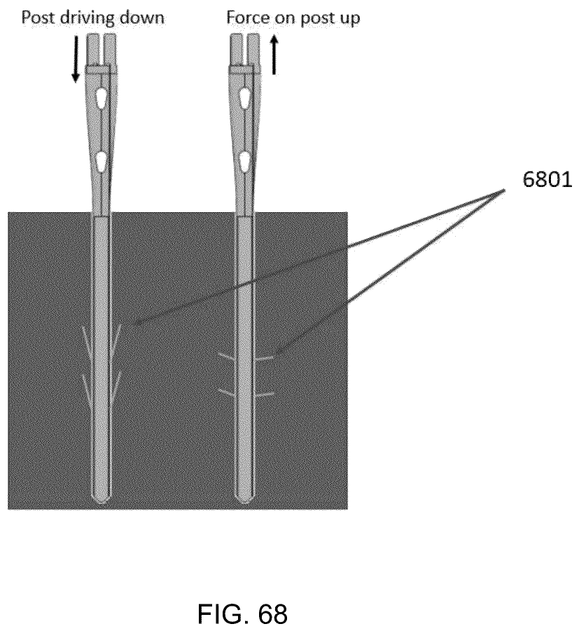

FIG. 68 illustrates an exemplary configuration for a post as described elsewhere herein. This embodiment shows cutout flanges 6801 that are bent out in a flared way such that they allow the post to enter the soil with low resistance (left), but then when the post is pulled up, they are engaged with the soil and bend out more, providing increased uplift resistance (right).

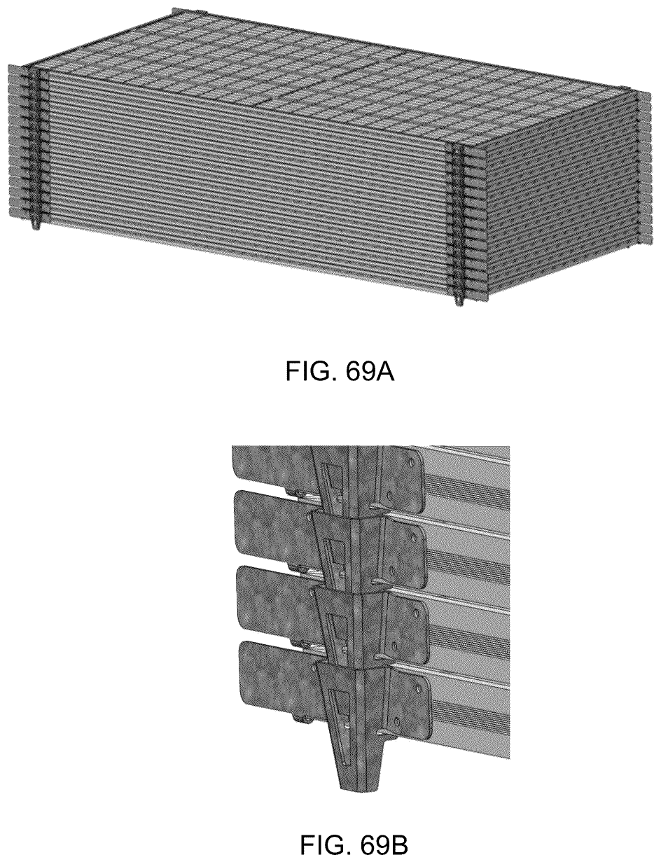

FIGS. 69A and 69B illustrate an alternative embodiment of the clips described elsewhere herein. In this embodiment, the clips may have bends and tabs such that they nest and stack so that the solar modules do not contact the other modules above or below them in the stack.

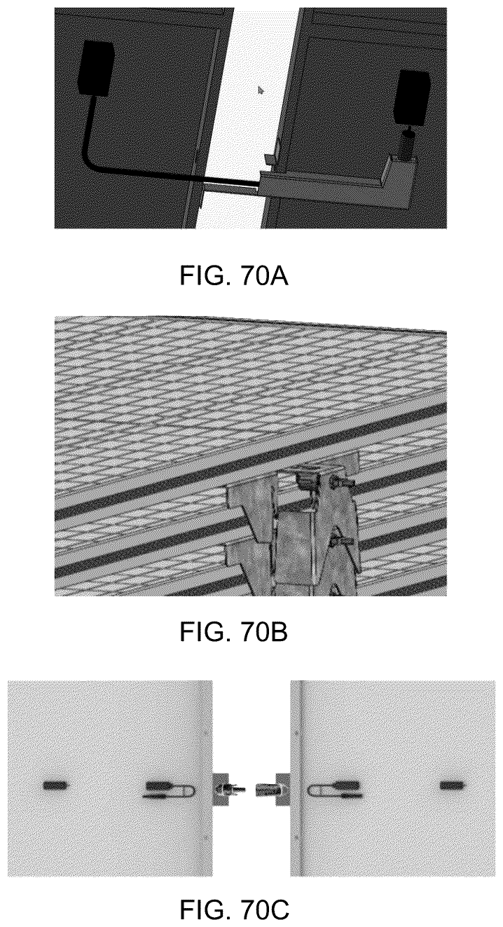

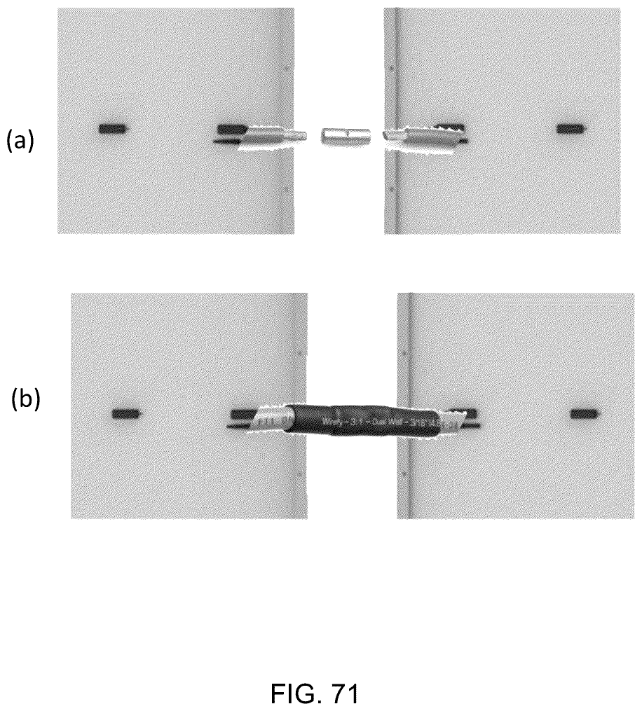

FIG. 70A illustrates an additional sheet metal feature that can be used to retain one or more lead wires or wire leads of a solar module and hold them fixed in a specific side of the module, for later handling or processing. FIG. 70B illustrates an embodiment of a clip where the module wire lead is connected to the clip that is also connected to the module and that will be connected to the post. FIG. 70C illustrates using an additional tool (blue squares) to autonomously take the solar module wire leads that are held in place by the clip and connect them to each other to form an electrical connection between the modules. FIG. 71 illustrates an embodiment of the tool and method in FIGS. 70A. 70B, and 70C, except in this embodiment, the tool does not push two connectors together, and instead it cuts (a), strips (a), and splices (b) the wires together in place without the use of a connector.

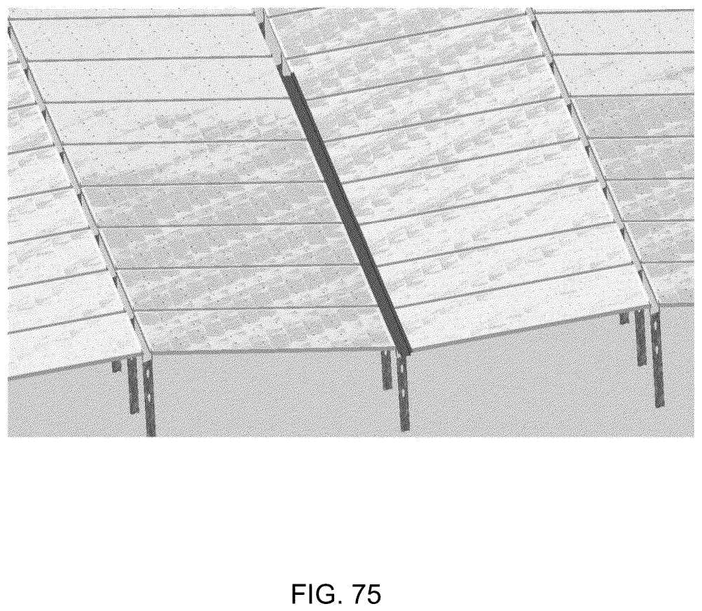

FIG. 75 illustrates a removable access trough that can be placed on top of posts in the valley or peaks of the module array. This trough can transfer its weight and load to the posts below it and not to the modules, and can be walked on top of in order to access modules in the interior regions of the array. In some cases, this trough can also be a rail that a robot can ride on (e.g., to clean, water, spray, or inspect).

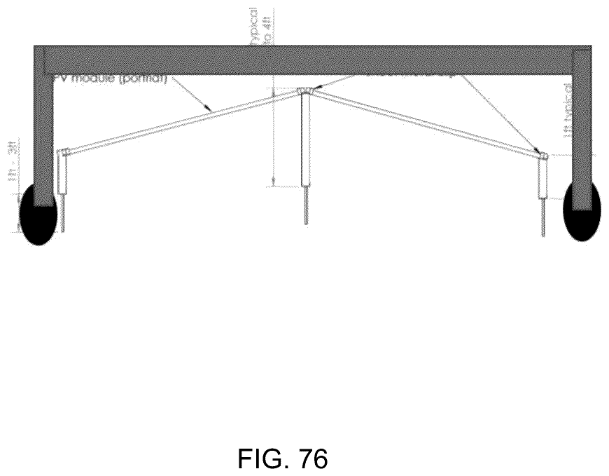

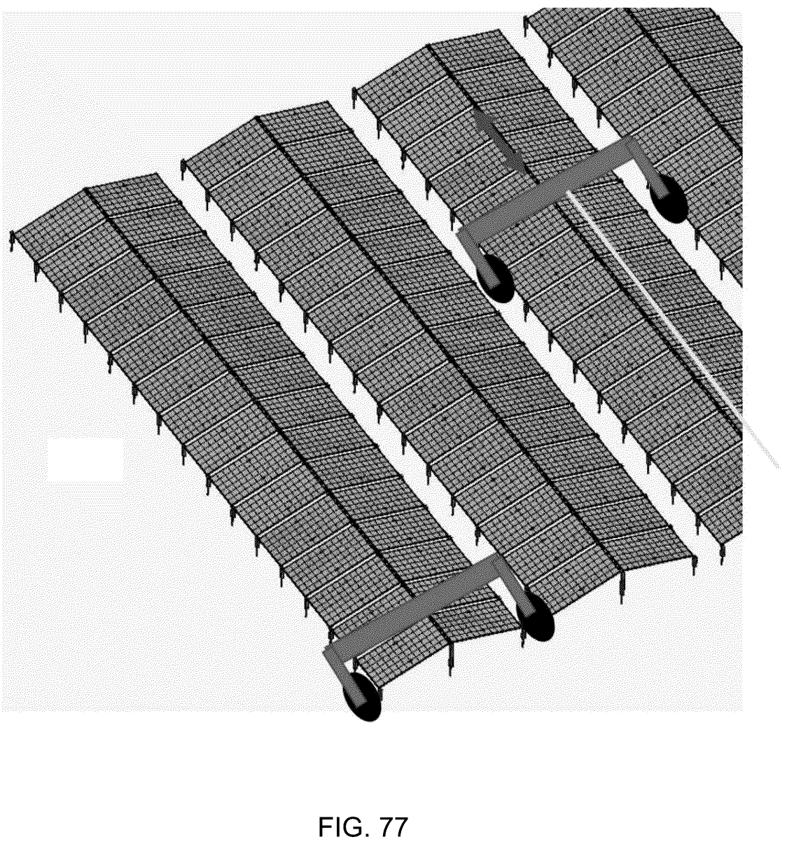

FIG. 76 and FIG. 77 illustrate a gantry (blue) on wheels (black) that can drive on the ground in the gaps between the array in certain configurations. This gantry can be outfitted with automation to clean the modules with water, or to mechanically wipe the solar modules in the array beneath the gantry. This gantry can also spray water or herbicide, or hydroseed, to manage vegetation underneath the array. The gantry can have a cord, a tube, or other hollow structure attached thereto to connect it to a source of water or other liquids at the end of a row of modules.

### Computer Systems

In an aspect, the present disclosure provides computer systems that are programmed or otherwise configured to implement methods of the disclosure, e.g., any of the subject methods for using at least one robot to fully autonomously position and assemble at least one solar module and its supporting structure.

In another aspect, the present disclosure provides computer systems that are programmed or otherwise configured to provide one or more mobile platforms that are configured to carry a plurality of posts and a plurality of solar modules. In some cases, the one or more mobile platforms are equipped with one or more sensors comprising a geolocation sensor. In some cases, the computer systems are further programmed or otherwise configured to use at least in part the readings or measurements obtained using one or more sensors to (i) autonomously move the one or more mobile platforms and (ii) autonomously position and assemble the plurality of posts and the plurality of solar modules over a terrain to construct an array of solar modules. Such autonomous movement or positioning may be performed using one or more signals or commands generated by a computing unit of the computer system.

In another aspect, the present disclosure provides computer systems that are programmed or otherwise configured to provide a plurality of posts and a plurality of solar modules. In some cases, the plurality of solar modules comprises a plurality of clips pre-attached thereon. In some cases, the computer systems are further programmed or otherwise configured to form a plurality of post-clip interfaces between a plurality of clips and the plurality of posts to construct an array of solar modules over a terrain without requiring one or more premade holes/features for one or more fasteners.

In another aspect, the present disclosure provides computer systems that are programmed or otherwise configured to use an algorithm to identify a location suitable for autonomous positioning and assembly of at least one solar module. In some cases, using the algorithm may be performed without requiring aid or involvement from a user in the autonomous positioning and assembly of the at least one solar module.

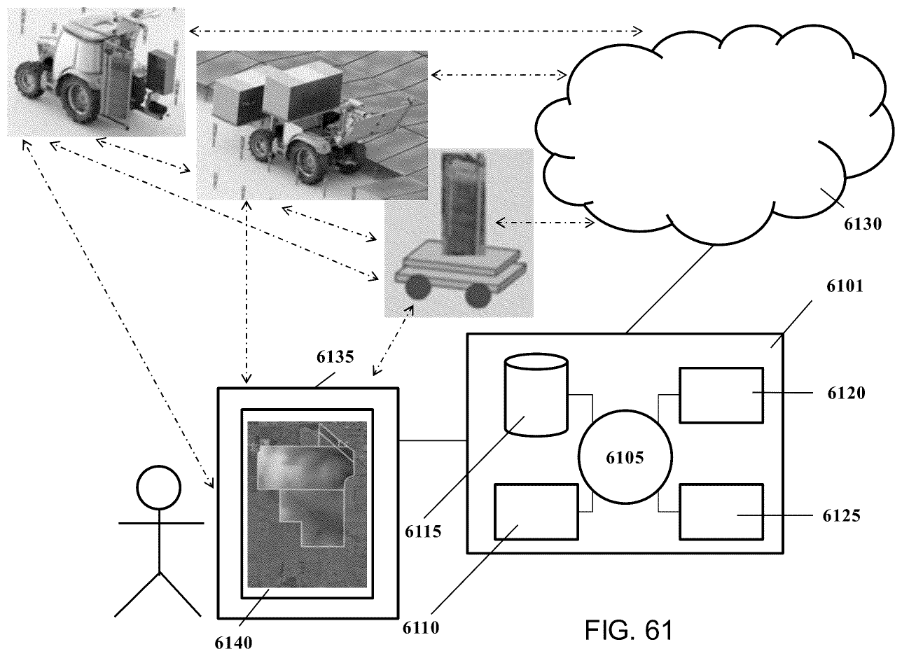

FIG. 61 shows a computer system 6101 that is programmed or otherwise configured to implement a method for fully autonomously positioning and assembling at least one solar module and its supporting structure. In some embodiments, the computer system 6101 may be configured to, for example, use an algorithm to identify a location suitable for autonomous positioning and assembly of at least one solar module, without requiring aid or involvement from a user in the autonomous positioning and assembly of the at least one solar module. The computer system 6101 can be an electronic device of a user or a computer system that is remotely located with respect to the electronic device. The electronic device can be a mobile electronic device.

The computer system 6101 may include a central processing unit (CPU, also “processor” and “computer processor” herein) 6105, which can be a single core or multi core processor, or a plurality of processors for parallel processing. The computer system 6101 also includes memory or memory location 6110 (e.g., random-access memory, read-only memory, flash memory), electronic storage unit 6115 (e.g., hard disk), communication interface 6120 (e.g., network adapter) for communicating with one or more other systems, and peripheral devices 6125, such as cache, other memory, data storage and/or electronic display adapters. The memory 6110, storage unit 6115, interface 6120 and peripheral devices 6125 are in communication with the CPU 6105 through a communication bus (solid lines), such as a motherboard. The storage unit 6115 can be a data storage unit (or data repository) for storing data. The computer system 6101 can be operatively coupled to a computer network (“network”) 6130 with the aid of the communication interface 6120. The network 6130 can be the Internet, an internet and/or extranet, or an intranet and/or extranet that is in communication with the Internet. The network 6130 in some cases is a telecommunication and/or data network. The network 6130 can include one or more computer servers, which can enable distributed computing, such as cloud computing. The network 6130, in some cases with the aid of the computer system 6101, can implement a peer-to-peer network, which may enable devices coupled to the computer system 6101 to behave as a client or a server.

The CPU 6105 can execute a sequence of machine-readable instructions, which can be embodied in a program or software. The instructions may be stored in a memory location, such as the memory 6110. The instructions can be directed to the CPU 6105, which can subsequently program or otherwise configure the CPU 6105 to implement methods of the present disclosure. Examples of operations performed by the CPU 6105 can include fetch, decode, execute, and writeback.

The CPU 6105 can be part of a circuit, such as an integrated circuit. One or more other components of the system 6101 can be included in the circuit. In some cases, the circuit is an application specific integrated circuit (ASIC).

The storage unit 6115 can store files, such as drivers, libraries and saved programs. The storage unit 6115 can store user data, e.g., user preferences and user programs. The computer system 6101 in some cases can include one or more additional data storage units that are located external to the computer system 6101 (e.g., on a remote server that is in communication with the computer system 6101 through an intranet or the Internet).

The computer system 6101 can communicate with one or more remote computer systems through the network 6130. For instance, the computer system 6101 can communicate with a remote computer system of a user (e.g., an end user or entity overseeing, supervising, monitoring, or managing an operation of the robots). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 6101 via the network 6130.

Methods as described herein can be implemented by way of machine (e.g., computer processor) executable code stored on an electronic storage location of the computer system 6101, such as, for example, on the memory 6110 or electronic storage unit 6115. The machine executable or machine readable code can be provided in the form of software. During use, the code can be executed by the processor 6105. In some cases, the code can be retrieved from the storage unit 6115 and stored on the memory 6110 for ready access by the processor 6105. In some situations, the electronic storage unit 6115 can be precluded, and machine-executable instructions are stored on memory 6110.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 6101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media including, for example, optical or magnetic disks, or any storage devices in any computer(s) or the like, may be used to implement the databases, etc. shown in the drawings. Volatile storage media include dynamic memory, such as main memory of such a computer platform. Tangible transmission media include coaxial cables: copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM. DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 6101 can include or be in communication with an electronic display 6135 that comprises a user interface (UI) 6140 for providing, for example, a portal for monitoring the installation of posts or solar modules. In some cases, the UI may permit inputs such as commands to “begin installation” or “halt all robots.” In some cases, the UI may provide a visualization or a blueprint for installing multiple solar modules of a solar module array. In some cases, the UI may provide a visualization tracking one or more robots in real-time. The portal may be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 6105. For example, the algorithm may be configured to determine one or more locations for installing one or more solar modules. In some cases, the algorithm may be configured to coordinate one or more robots during installation of one or more solar modules. In some cases, the algorithm may be configured to process force-testing data of one or more solar modules to determine if the one or more solar modules are installed securely. In some cases, the algorithm may be configured to provide instructions to the one or more robots to adjust the one or more solar modules or supporting structures thereof based at least in part on the force-testing data.

### High Throughput Post Installation

In one aspect, the present disclosure provides methods and systems for high throughput post installation.

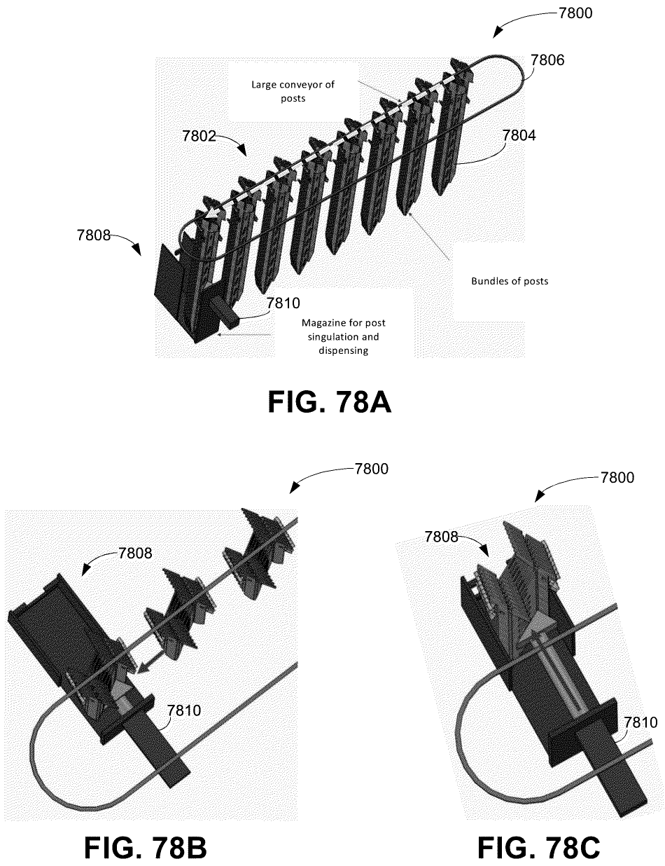

FIGS. 78A-78C illustrate an example configuration of a conveyer apparatus 7800 for a post installation machine, in accordance with some embodiments. According to some embodiments, the conveyer apparatus 7800 may be configured to store, transport, and convey posts on a conveyor. The conveyer apparatus 7800 may include a conveyance unit 7802 configured to support and transport a plurality of posts 7804. The plurality of posts 7804 may be bundled. The conveyance unit 7802 may include a conveyor line 7806. The conveyance unit 7802 may be configured to support the plurality of posts 7804 by securing the plurality of posts 7804 on the conveyor line 7806. In some embodiments, the conveyance unit 7802 may be configured to support the plurality of posts 7804 by hanging the plurality of posts 7804 on the conveyor line 7806. The conveyer apparatus 7800 may include a dispensing unit 7808. The dispensing unit 7808 may be configured to dispense one or more posts 7804 from the conveyance unit 7802, for installation onto a terrain. The dispensing unit 7808 may include an actuator 7810 that is configured to dispense the one or more posts by separating or releasing the one or more posts from the conveyance unit 7802. The actuator 7810 may be configured to separate or release the one or more posts from the conveyance unit 7802 by pushing, pulling and/or lifting the one or more posts off the conveyance unit 7802. The actuator 7810 may cause posts to enter a specific location at the conveyer to be pushed into an organized magazine arrangement such that they can be singulated one by one into a carrier of a post installation machine. The conveyance unit 7802 and the dispensing unit 7808 may be operably coupled to each other. In some embodiments, the dispensing unit 7808 may be located at a fixed position relative to the conveyance unit 7802. In some embodiments, the dispensing unit 7808 may be movable such that the dispensing unit 7808 is capable of being moved to one or more positions along or relative to the conveyance unit 7802. In some embodiments, the conveyance unit 7808, the dispensing unit 7808, and/or the plurality of posts may be provided in a post storage unit or at a post storage location. The post storage unit or post storage location may include a centralized place on a field, where a plurality of posts may be stored and subsequently distributed for planting over the terrain (e.g., a very large area).

As illustrated in FIGS. 78A and 78B, the plurality of posts 7804 may be provided as a plurality of bundles, with each bundle comprising two or more posts. In some embodiments, the two or more posts in a bundle may be held together by a strap, chain, or clip. According to some embodiments, a bundle may include about three to three hundred posts. Bundles of posts may be easier to manage at the start of a module installation process and may save time needed for transporting, separating, and/or planting, in comparison to grappling with a large number of individual separated posts. In some embodiments, after a bundle is extracted, the bundle can be fed to a post installation machine, whereby the bundle is then singulated into individual posts to be planted into the ground. In some embodiments, the dispensing unit may dispense one or more bundles of posts to a carrier. In some embodiments, the carrier may feed the one or more bundles of posts to a post installation machine.

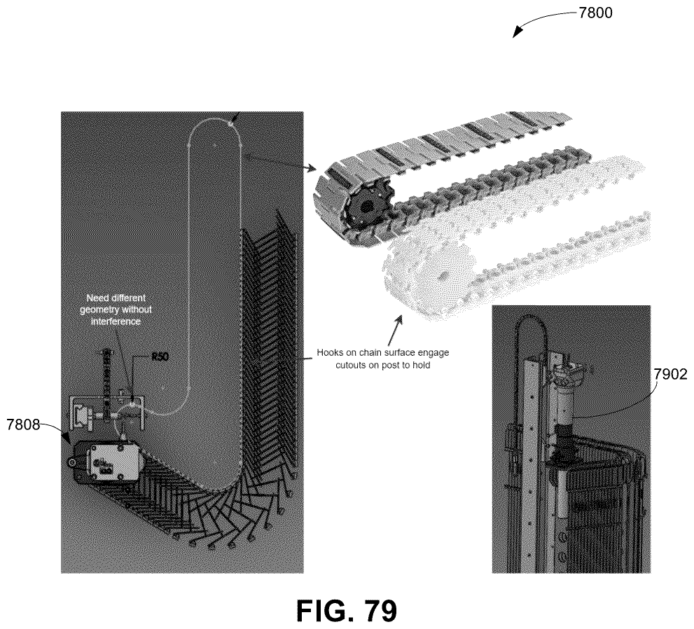

FIG. 79 illustrates another example configuration of the conveyer apparatus 7800, in accordance with some embodiments. The dispensing unit 7808 may be configured to feed one or more posts to a post installation machine. In some embodiments, the conveyor of posts may continue into a workspace of a hammer 7902 without the use of a magazine-like loading mechanism.

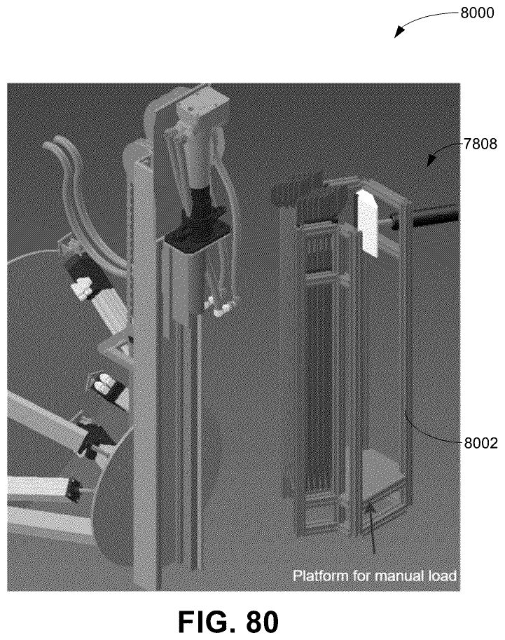

FIG. 80 illustrates an example feeding system 8000 for the post installation machine, in accordance with some embodiments. The dispensing unit 7808 may be configured to dispense one or more posts to a carrier that is configured to feed the one or more posts to the post installation machine. In some embodiments, the one or more posts may be fed into a carrier 8002. A post can be presented into a position within the carrier 8002 so that the post installation machine can drive to it and pick up the post. In some embodiments, the carrier 8002 can be transported to proximity of the post installation machine and the post installation machine can pick up the post from the carrier 8002.

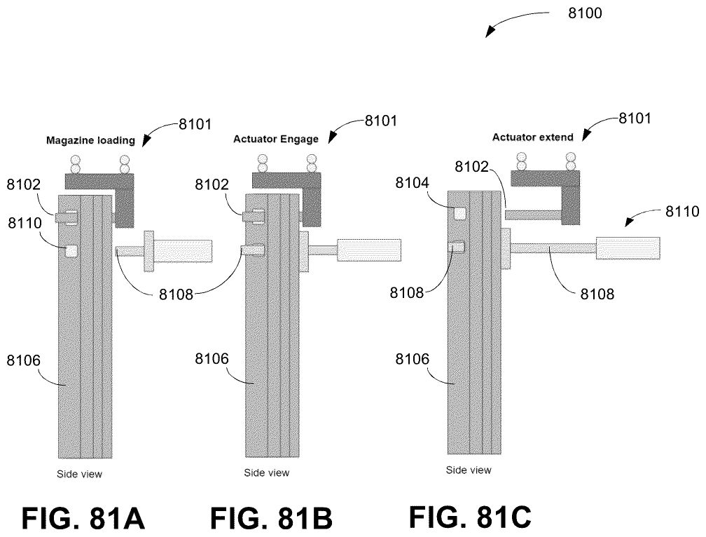

FIGS. 81A-81C illustrate an example mechanical arrangement 8100 to transition posts, in accordance with some embodiments. A carriage 8101 (e.g., a dispensing unit 7808) may include a supporting arm 8102 configured to extend through one or more first holes 8104 in the one or more posts 8106 to support the posts 8106. The supporting arm 8102 may be configured to push, pull and/or lift the post 8106 off the conveyance unit 7802. In some embodiments, a transfer arm 8108 may be configured to extend through one or more second holes 8110 in the posts 8106 to allow the posts 8106 to hang on it. An actuator 8110 then pushes the post 8106 off the supporting arm 8102, thereby transitioning the post 8106 from the carriage 8101 to the actuator 8110.

In some embodiments, the transfer arm 8108 may transfer the one or more bundles of posts to a carrier. In some embodiments, the carrier may feed the one or more bundles of posts to a post installation machine.

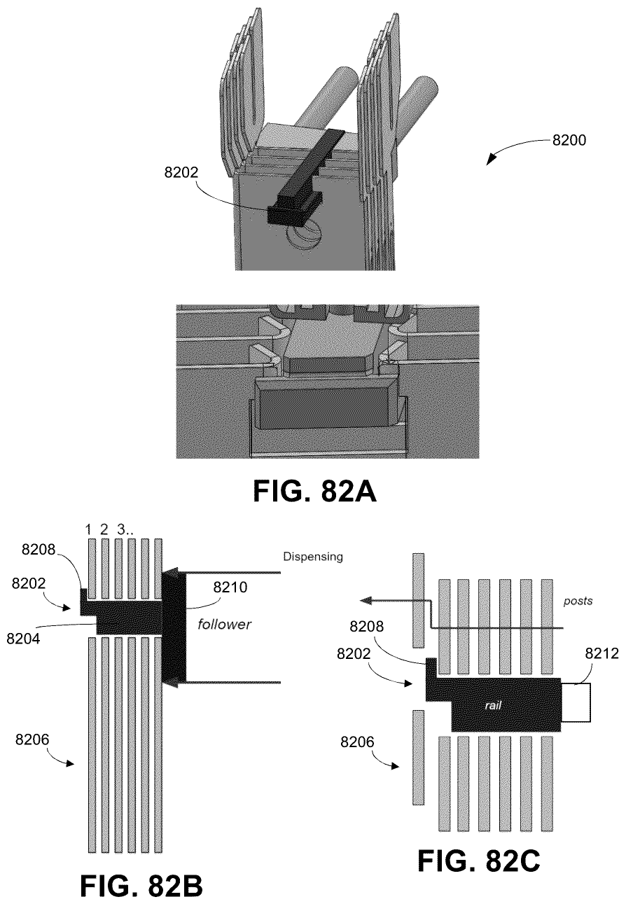

FIGS. 82A-82C illustrate an example of a magazine and rail system 8200 (e.g., of the example feeding system 8000 shown in FIG. 80) in accordance with some embodiments. A carrier 8202 may include a rail 8204. The rail 8204 may be configured to support a plurality of posts 8206. The rail 8204 may include a gate 8208 located at a distal portion of the rail 8204. The gate 8208 may be configured to prevent the plurality of posts 8206 from sliding off the rail 8204. The rail 8204 may have a fixed position for the posts to slide upon. The carrier 8202 may include a follower 8210 configured to move or press the plurality of posts 8206 along the rail 8204 towards or against the gate 8208. The posts may be pushed to the front of the rail 8204 by the follower 8210 and may be required to be lifted up and over the gate 8208 in order to be released. In some embodiments, the gate 8208 and the follower 8210 may be configured to enable each post of the plurality of posts 8206 to be sequentially removable from the distal portion of the rail 8204 for installation onto a terrain. The follower 8210 may include a spring. The plurality of posts may be sequentially removable from the rail 8204 by lifting the post above and over the gate 8208. The plurality of posts 8206 may be indexed by a distance relative to each other along the rail 8204 using one or both of (a) one or more tabs on each post of the plurality of posts 8206 and/or (b) a plurality of spacers between the plurality of posts 8206. The carrier 8202 may include a vibrating device 8212 operably coupled to the rail 8204. The vibrating device 8212 may be configured to generate vibrations in the rail 8204 for facilitating movement of the plurality of posts 8206 towards the gate 8208. The rail 8204 may be sloped or angled to facilitate movement of the plurality of posts 8206 towards the gate 8208 with aid of gravity.

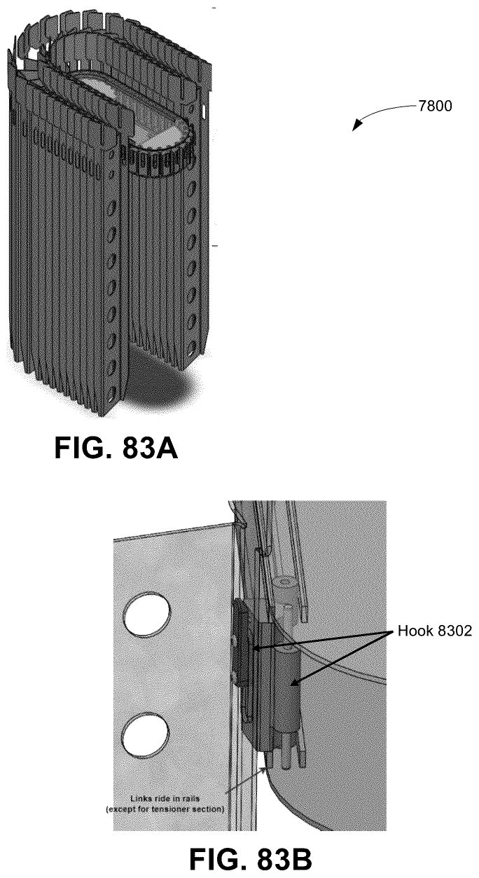

FIGS. 83A and 83B illustrate detail views of the conveyer apparatus 7800 shown in FIG. 79, in accordance with some embodiments. A conveyance unit (e.g., the conveyance unit 7808 in FIG. 78) may include a plurality of carriages that are linked to one another. In some embodiments, a number and spacing of the plurality of carriages may be adjustable to enable different turn radii of the conveyance unit during motion of the conveyance unit. In some embodiments, a carriage of the plurality of carriages may include one or more hooks 8302 that are used for securing (e.g., hanging) the plurality of posts.

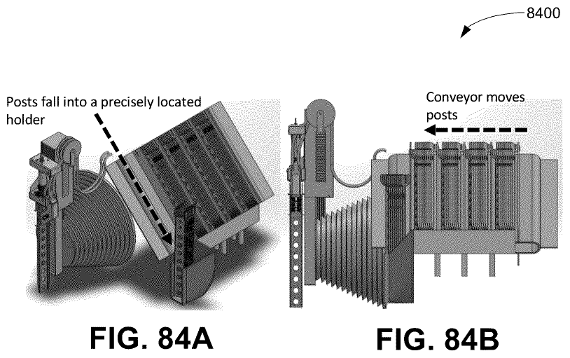

FIGS. 84A and 84B illustrate another example mechanical arrangement 8400 to store and transport posts, in accordance with some embodiments. A conveyance unit (e.g., the conveyance unit 7808 in FIG. 78) may be sloped or angled to facilitate the dispense of the one or more posts with aid of gravity. The conveyor belt may drive posts forward and the front stack may fall off into a tool (e.g., a carrier) that catches it in a specific vertical orientation.

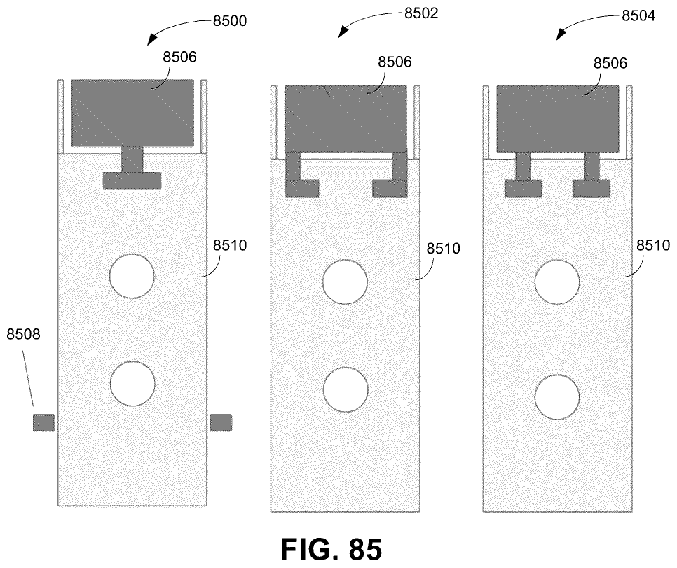

FIG. 85 illustrates different example rail configurations 8500, 8502, and 8504 for the rail system of the post installation machine, in accordance with some embodiments. In some embodiments, a rail 8506 may include a single rail (e.g., configuration 8500). In some embodiments, the rail 8506 may include two or more laterally spaced apart sub-rails (e.g., configurations 8502 and 8504). The two or more laterally spaced apart sub-rails may be configured to reduce swinging of the plurality of posts on the rail. The rail system may include one or more linear guides 8508 located beneath the rail 8506. The one or more linear guides 8508 may be configured to constrain and reduce swinging of the plurality of posts 8510 on the rail 8506. The rail 8506 may be sloped or angled to facilitate removal of each post 8510 from the rail 8506 with aid of gravity. For example, the posts 8510 may slowly slide down the rail 8506 using gravity after a post 8510 from the end of the rail 8506 has been removed.

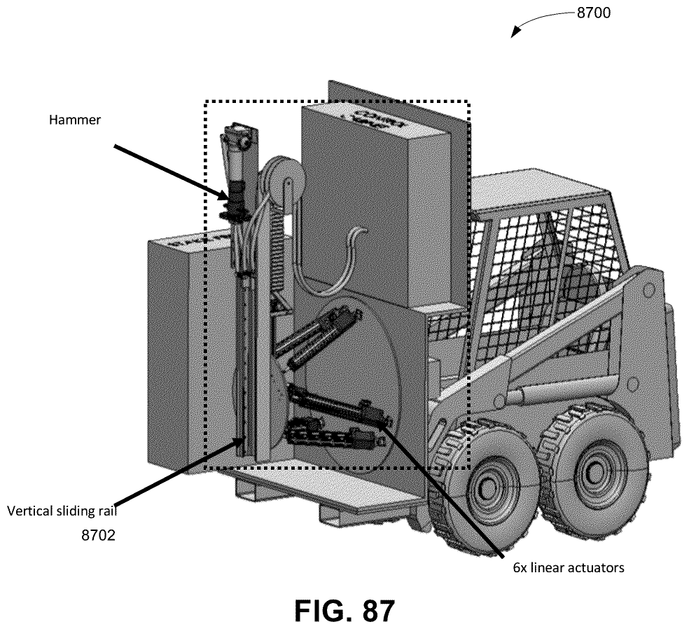

A system for post installation may comprise a carrier and a post installation machine. In some embodiments, the post installation machine may comprise an extraction device configured to remove the one or more posts from the carrier for installation onto the terrain. The extraction device may be configured to remove the one or more posts 8510 from the carrier by lifting the one or more posts 8510 off the rail 8506 to clear the gate (e.g., the gate 8208 in FIG. 82), so that the post 8510 can be loaded onto the post installation machine for preparation to plant into the ground. In some embodiments, the post installation machine may include a load driving mechanism (e.g., a hammer). The extraction device may be configured to bring the one or more posts 8510 in proximity of the load driving mechanism. For example, an extracted post 8510 may be positioned close to a hammer bit, which may be used to drive the post 8510 into the ground. The load driving mechanism may be configured to drive the one or more posts 8510 onto the terrain (e.g., planting the posts 8510 into the ground). A load driving mechanism may include a load head (e.g., a hammer bit) configured to drive one or more posts 8510 onto a terrain. The load driving mechanism may include a positioning device. The positioning device may be configured to control a location of the load head in three or more degrees of freedom relative to the one or more posts 8510 and an altitude of the terrain, prior to the one or more posts 8510 being driven onto the terrain. The positioning device may include a plurality of linear actuators. The positioning device may include a Stewart platform or a hexapod (see. e.g., FIG. 87). The positioning device may be configured to control the location of the load head in six degrees of freedom.

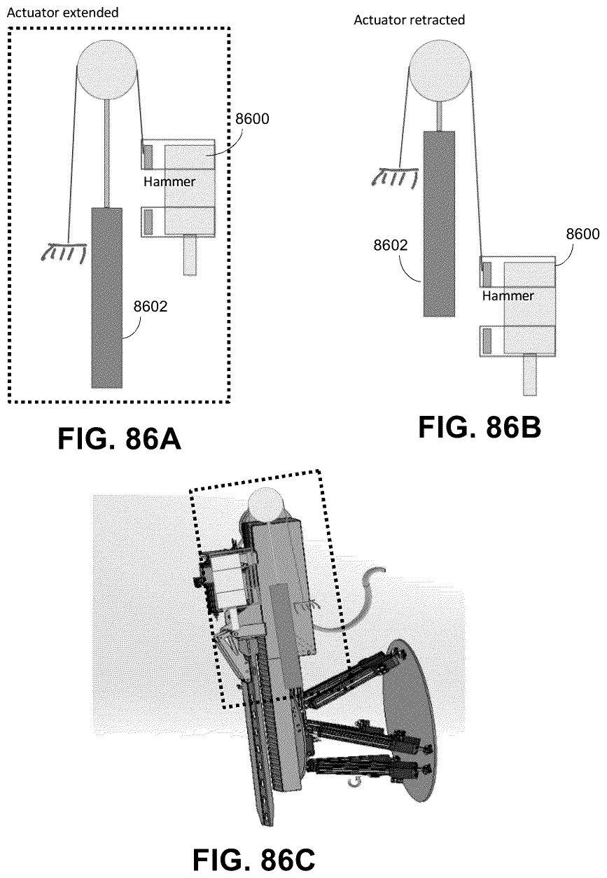

FIGS. 86A-86C illustrate different example configurations of a hammer 8600 and actuator 8602 of the post installation machine, in accordance with some embodiments. A load driving mechanism may include the actuator 8602 configured to control a vertical position of the load head along a Z-axis. The load driving mechanism may be a chain/wire and sheave for adjusting or controlling a ratio of (a) a linear extension of the actuator 8602 relative to (b) a travel distance of the load head. In some embodiments, the ratio may be from 1:6 to 6:1. In some embodiments, the ratio may be 1:2. In some embodiments, the ratio may be adjustable or controllable to reduce an upward reaction force when the load head is retracted after driving the one or more posts downwards onto the terrain. This configuration may prevent the load head from transmitting its reaction force vertically into the post installation machine because when the load head bounces up, it may slack the wire or chain.

FIG. 87 illustrates an example configuration of a post installation machine 8700 with a loader, in accordance with some embodiments. The post installation machine 8700) may include one or more vertical sliding rails 8702 for constraining the one or more posts as the one or more posts are being driven onto the terrain. The one or more vertical sliding rails 8702 may be configured to permit the one or more posts to slide along the one or more vertical rails 8702 as the one or more posts are being driven onto the terrain.

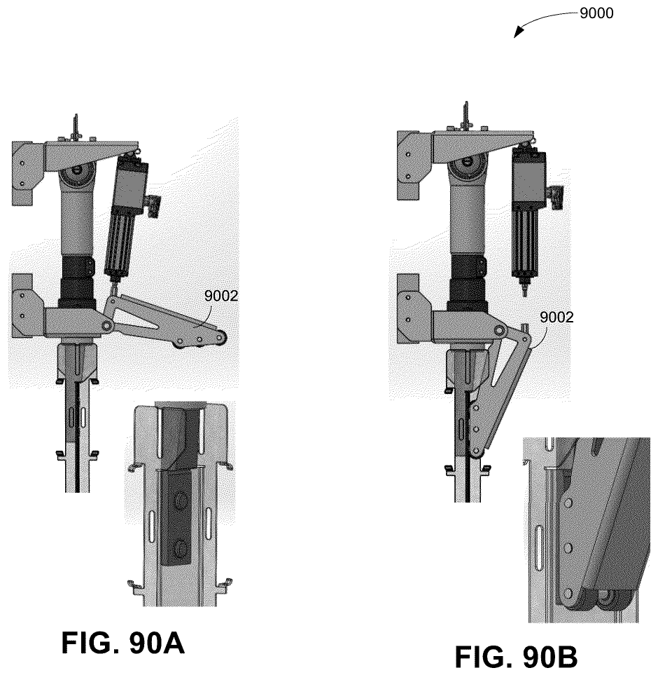

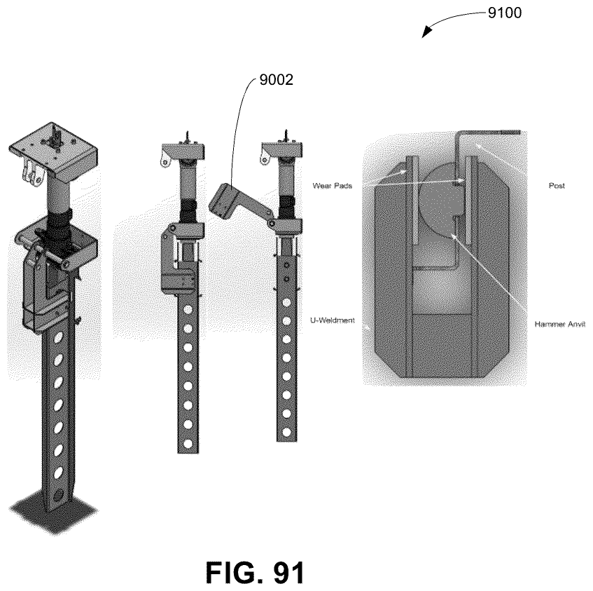

In some embodiments, the post installation machine may comprise a brace and an actuator configured to retain the one or more posts in position relative to the load head (e.g., a hammer bit). FIGS. 90A and 90B illustrate an example configuration 9000 of a hammer bit of the post installation machine, in accordance with some embodiments. A brace 9002 may be movable to switch between an open state (FIG. 90A) and a closed state (FIG. 90B). The open state may allow the one or more posts to be placed in position relative to the load head. The closed state may cause the brace 9002 to retain the one or more posts in position relative to the load head. The brace 9002 may be hinged to a holder that is configured to hold the one or more posts. FIG. 91 illustrates another example configuration 9100 of the hammer bit of the post installation machine. The brace 9002 may be in a C-shape or a horse-shoe bracket. The brace 9002 may self-react the post force in the direction parallel to the shear features on the hammer bit, which may lower the force transmitted to the actuator.

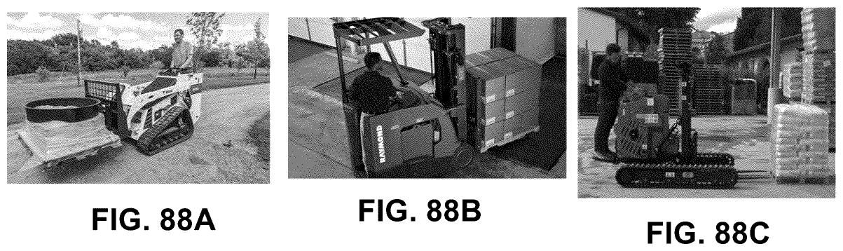

In some embodiments, the post installation machine may be integrated to a vehicle or machine. FIGS. 88A-88C illustrate example integrations of the post installation machine 8700 with a skid, in accordance with some embodiments. The skid may be able to attach to any suitable type of vehicles, for example, forklifts, skid steers, tractors, or a custom-built vehicle.

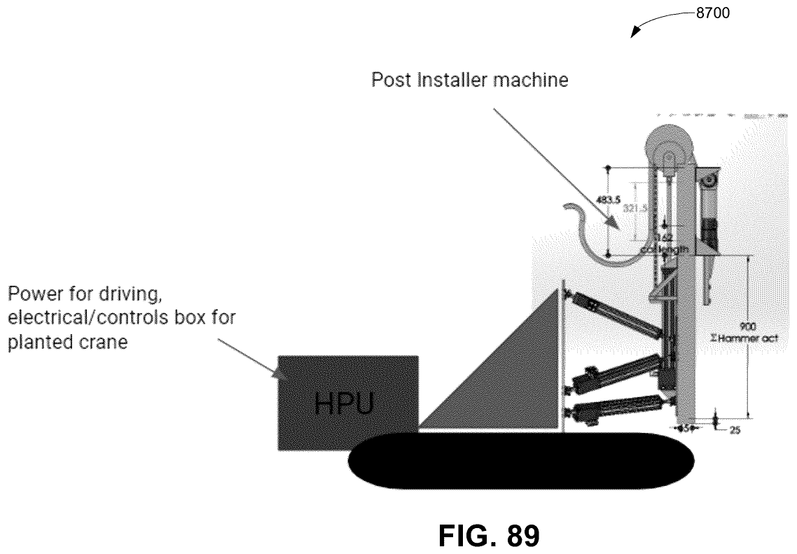

Alternatively, the post installation machine may be fitted with tracks or wheels at its base and a hydraulic or electric power source. The post installation machine may move like a vehicle by itself, without the need to mate with a vehicle. FIG. 89 illustrates an example configuration of the post installation machine 8700 fitted with tracks or wheels, in accordance with some embodiments.

Through the high throughput post installation method and system as disclosed herein, the posts may be quickly fed into the post installation machine automatically, without manual intervention. In some embodiments, the posts may be quickly fed into the post installation machine, at a speed from 0.2 to 60 second per post. In addition, the posts can be quickly installed. In some embodiments, the posts may be installed at a speed from 20 posts per hour to 750 posts per hour.

### Rapid Solar Module Assembly

In one aspect, the present disclosure provides methods and systems for rapid assembly of solar modules onto posts without a need of high precision alignment.

In some embodiments, the systems for solar module assembly may comprise a module installation machine. The module installation machine may comprise a compliant mechanism operably coupled to a distal portion of a movable arm. In some embodiments, the compliant mechanism may pick up one or more solar modules from a plurality of solar modules and place the one or more solar modules onto a plurality of posts that have been installed onto a terrain. In some embodiments, the compliant mechanism may rotate and/or flex relative to the movable arm during placement of the one or more solar modules onto the plurality of posts. The compliant mechanism may enable the one or more solar modules to be placed onto the plurality of posts, without requiring the one or more solar modules to be precisely positioned within a threshold tolerance relative to the plurality of posts during the placement.

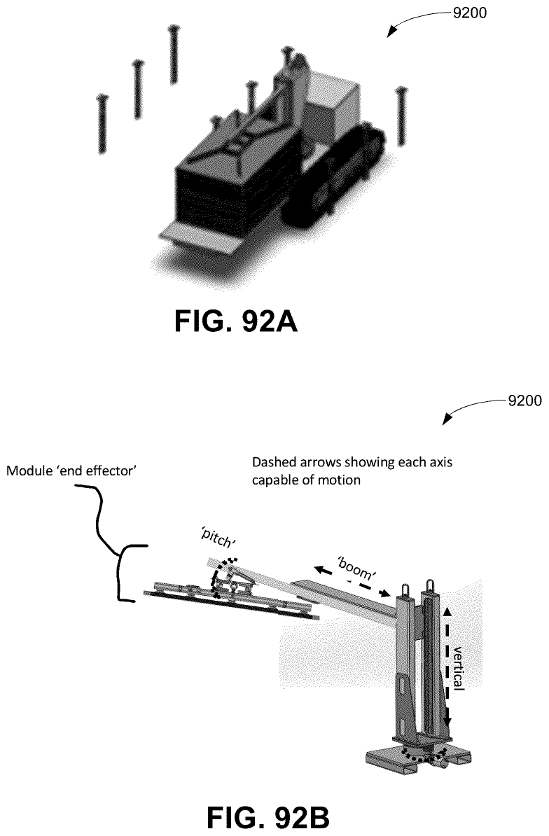

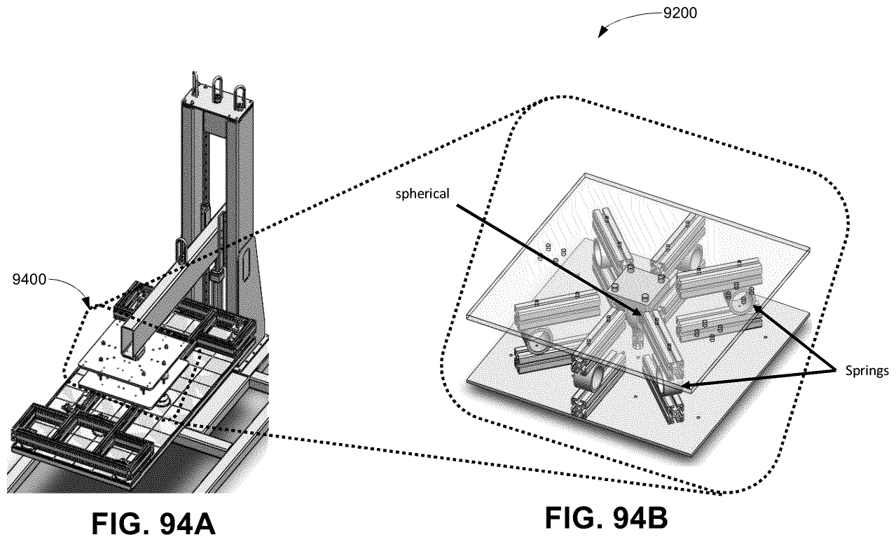

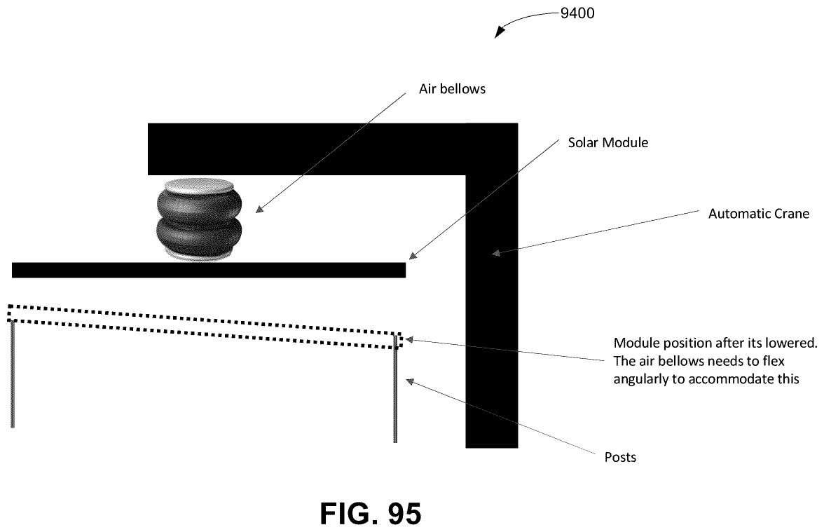

FIGS. 92A and 92B illustrate a range of motion of a module installation machine 9200, accordance with some embodiments. FIG. 92A shows that the module installation machine 9200 may pick up a solar module from a stack of solar modules and rotate to position the solar module over a plurality of posts. In some embodiments, the rotation may be 90 degrees. As shown in FIG. 92B, the module installation machine 9200 may comprise a vertical axis and a movable arm (e.g., a crane). In some embodiments, the movable arm may comprise a boom axis and a pitch axis. The vertical axis may be capable of moving up and down in the Z-axis to adjust the height of the module installation machine. The boom axis and pitch axis may be capable of extending or retracting, thereby moving the solar module away from or close to the posts. The movable arm may be capable of leveling the solar module. The module installer machine 9200 may comprise an end effector comprising a compliant mechanism (details to be illustrated in FIGS. 94A, 94B, and 95). In some embodiments, one or more actuators may be configured to control the movable arm to move in two or more degrees of freedom. The two or more degrees of freedom may include a translation along a vertical axis and a rotation about the vertical axis. The two or more degrees of freedom may include a translation and/or rotation along a lateral axis.

FIGS. 94A and 94B illustrate an example configuration of a compliant mechanism 9400 on an end of a movable arm (e.g., a crane) of the module installation machine 9200, in accordance with some embodiments. The compliant mechanism 9400 may be operably coupled to a distal portion of a movable arm. The compliant mechanism 9400 may be configured to (1) pick up one or more solar modules from a plurality of solar modules and (2) place the one or more solar modules onto a plurality of posts that have been installed onto a terrain. The compliant mechanism 9400 may be configured to rotate and/or flex relative to the movable arm during placement of the one or more solar modules onto the plurality of posts. The compliant mechanism 9400 may enable the one or more solar modules to be placed onto the plurality of posts, without requiring the one or more solar modules to be precisely positioned within a threshold tolerance relative to the plurality of posts during the placement. The threshold tolerance may be based at least on a horizontal accuracy and a vertical accuracy of a Global navigation satellite system (GNSS). The threshold tolerance may be based at least on a tilt of the plurality of the posts. The tilt may range from 0 degree to 25 degrees.

As shown in FIG. 94B, the compliant mechanism 9400 may include a pair of laterally spaced apart plates and a plurality of springs extending radially from a center between the pair of laterally spaced apart plates. The plurality of springs may extend radially from the center equidistant from each other. The plurality of springs may comprise 3 springs. 4 springs. 5 springs. 6 springs. 7 springs, or more. The angles between two neighboring springs may be even. Alternatively, the angles between two neighboring springs may not be even. In some embodiments, the compliant mechanism may include three springs that extend radially from the center at a 120 degree angle relative to each other. In some embodiments, the compliant mechanism may include four springs that extend radially from the center at a 90 degree angle relative to each other. In some embodiments, the compliant mechanism may include six springs that extend radially from the center at a 60 degree angle relative to each other. In some embodiments, the pair of laterally spaced apart plates may include (1) a first plate that is operably coupled to the distal portion of the movable arm, and (2) a second plate that is configured to pick up the one or more solar modules from the plurality of solar modules. In some embodiments, the compliant mechanism 9400 may include a spherical bearing located at a center between the pair of laterally spaced apart plates. The pair of laterally spaced apart plates may be operably coupled to each other via the spherical bearing and the plurality of springs. The spherical bearing may be configured to permit the pair of laterally spaced apart plates to rotate relative to each other. The spherical bearing may include an additional spring that is configured to allow lateral movement of the plates relative to each other. The plurality of springs may be configured to permit the pair of laterally spaced apart plates to flex relative to each other such that pair of plates are non-parallel to each other. The plurality of springs may be made of any suitable materials, for example, metal, alloy, carbon fiber, rubber, or reinforced materials. The plurality of springs may be configured with having a torsional spring force such that the compliant mechanism returns to a default position after the placement of the one or more solar modules onto the plurality of posts.

In some embodiments, the compliant mechanism 9400 may include one or more clinching tools operably coupled to the compliant mechanism. The one or more clinching tools may be configured to attach the one or more solar modules to the plurality of posts via a dimpling process (see. e.g., description on clinching tools and dimpling process in connection with FIG. 7A. FIG. 7B, and/or FIG. 15).

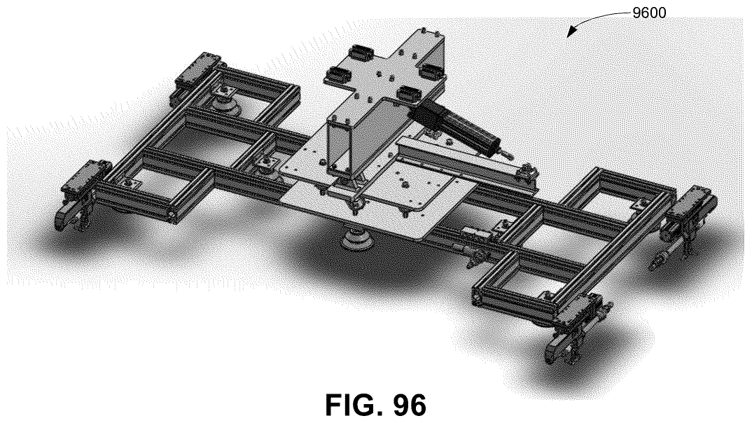

FIG. 95 illustrates another example configuration of the compliant mechanism 9400 on the end of the crane of the module installation machine 9200, in accordance with some embodiments. FIG. 96 illustrates an example configuration of an end effector 9600 of the crane of the module installation machine 9200, in accordance with some embodiments.

As shown in FIG. 95, the compliant mechanism 9400 may include one or more bellows. The one or more bellows may be provided in a rubber casing. The one or more bellows may be inflatable or deflatable with a fluid for controlling a spring constant of the one or more bellows. The fluid may include a gas or a liquid. The compliant mechanism 9400 may include and/or be attached to a movable arm. The compliant mechanism 9400 may include one or more actuators (e.g., motors) operably coupled to the movable arm.

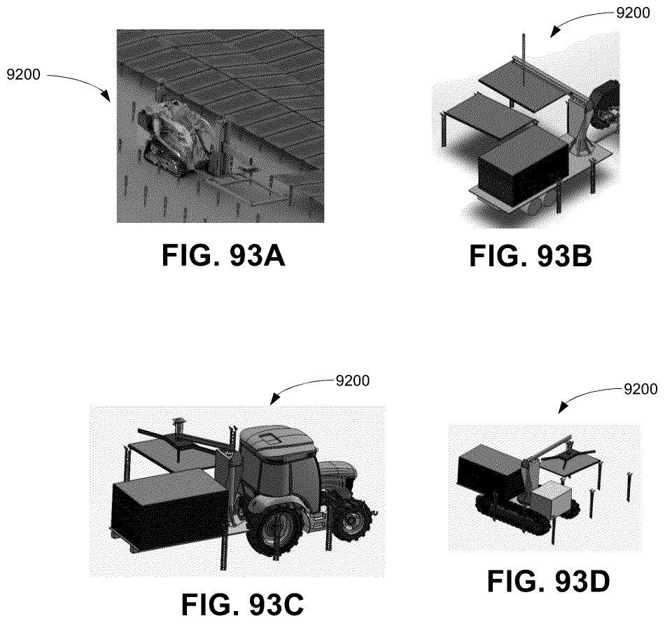

In some embodiments, the module installation machine may be integrated or loaded to a vehicle or machine. FIGS. 93A-93D illustrate different example configurations of the module installation machine 9200, in accordance with some embodiments. The module installation machine 9200 can be on a standard skid and towed on a skid steer (FIG. 93A), a trailer (FIG. 93B), or a tractor (FIG. 93C). In some embodiments, the skid can be fitted with a hydraulic or electric power unit and wheels or tracks to drive itself and not need to be mated to any other vehicle (FIG. 93D). FIGS. 93B and 93C illustrate that module installation machine 9200 may include a skid for supporting a plurality of solar modules in a stacked format.

Using the module installation machine as provided herein, solar modules may be positioned and assembled onto a plurality of posts in a rapid way. The compliant mechanism may enable the one or more solar modules to be placed onto the plurality of posts, without requiring the one or more solar modules to be precisely positioned within a threshold tolerance relative to the plurality of posts during the placement. The time needed for the positioning and assembly of solar modules may be reduced by at least 10%, at least 15%, at least 20%, at least 25%, at least 30%, at least 35%, at least 40%, at least 45%, at least 50%, or more.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein may be employed in practicing the disclosure. It is therefore contemplated that the disclosure shall also cover any such alternatives, modifications, variations or equivalents. It is intended that the following claims define the scope of the disclosure and that methods and structures within the scope of these claims and their equivalents be covered thereby.

1-137. (canceled)

138. A system comprising:
a platform configured to carry and transport a plurality of posts over a terrain;
a post feeder configured to singulate one or more posts from the plurality of posts;
a robotic arm configured to grip the one or more posts from the post feeder; and
a load driving mechanism configured to install the one or more posts on a ground of the terrain, wherein the one or more posts installed onto the terrain are configured to support one or more solar modules.

139. The system of claim 138, wherein the plurality of posts comprises one or more bundles, and wherein each bundle of the one or more bundles comprises a number of posts ranging from about three posts to about three hundred posts.

140. The system of claim 138, wherein the post feeder comprises a rotating shaft and a plurality of fins coupled to the rotating shaft.

141. The system of claim 140, wherein each fin of the plurality of fins comprises an opening, and wherein the platform is configured to release the one or more posts to the opening of the fin when the shaft rotates the plurality of fins to a position that has the opening located underneath the platform.

142. The system of claim 141, wherein the post feeder further comprises a post holder configured to hold the one or more posts, and wherein the rotating shaft is configured to rotate the plurality of fins to release the one or more posts from the opening of the fin to the post holder.

143. The system of claim 138, wherein the robotic arm comprises a grabbing mechanism at a distal end of the robotic arm.

144. The system of claim 143, wherein the robotic arm further comprises an actuator configured to actuate the grabbing mechanism to grip the one or more posts.

145. The system of claim 138, further comprising a vertical rail, wherein the robotic arm is configured to move up or down the rail to a lateral position of the post feeder.

146. The system of claim 138, wherein the robotic arm is extendible.

147. The system of claim 138, wherein the load driving mechanism comprises a hammer.

148. The system of claim 138, wherein the load driving mechanism is configured to apply a driving force to a distal end of the one or more posts.

149. The system of claim 138, wherein the load driving mechanism has a driving force length that is less than a full longitudinal length of the one or more posts.

150. The system of claim 138, further comprising a post retention mechanism configured to prevent the one or more posts from displacing or decoupling from the robotic arm when the one or more posts are being installed on the ground.

151. The system of claim 150, wherein the robotic arm is configured to (i) rotate to a horizontal position to grip the one or more posts and (ii) rotate from the horizontal position to a vertical position to couple the one or more posts to the post retention mechanism.

152. The system of claim 150, wherein the post retention mechanism comprises one or more rollers configured to retain the one or more posts close to the ground.

153. The system of claim 138, further comprising one or more sensors configured to identify one or more locations on the ground of the terrain at which the one or more posts are to be installed.

154. The system of claim 153, wherein the one or more sensors comprise at least one of (i) a differential global positioning system (GPS) system, (ii) a camera, (iii) lidar, or (iv) a laser tracking system.

155. The system of claim 138, wherein the robotic arm and the load driving mechanism are configured to be mounted on a vehicle, wherein the vehicle is configured to move between the post feeder and one or more locations at which the one or more posts are to be installed.

156. The system of claim 138, further comprising a testing tool configured to perform a force test after the one or more posts have been installed on the ground.

157. The system of claim 156, wherein the testing tool is configured to apply a pull force on the one or more posts in at least one of a lateral direction or a vertical direction.
